(19) United States
(12) Patent Application Publication
(10) Pub. No.: US 2009/0106801 A1
(43) Pub. Date: Apr. 23, 2009

(54) CONTENT PROCESSING DEVICE AND CONTENT PROCESSING METHOD

(75) Inventor: Yuki HORII, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/252,680

(22) Filed: Oct. 16, 2008

Related U.S. Application Data
(60) Provisional application No. 60/980,923, filed on Oct. 18, 2007.

(51) Int. Cl. H04N 7/173

(52) U.S. Cl. 725/91

(57) ABSTRACT

Even when the content recording and transmitting device receives requests from content receiving and reproducing devices, the content processing device including a device contention resolving manager for resolving a device contention can resolve a contention between the content receiving and reproducing devices for the devices required for the processing to be executed according to the requests. The device contention resolving manager includes: a priority level setting unit holding base priority levels of the content receiving and reproducing devices; a priority level revision processing unit deriving the priority levels corresponding to the requests; and a device contention resolving processing unit which one of the requests to be a request to be accepted, according to a priority order of the requests assigned with the priority levels, and reproduces or transmits a content according to the determined request by using the device.

### CROSS REFERENCE TO RELATED APPLICATION

This application claims the benefit of U.S. Provisional Application No. 60/980923, filed Oct. 18, 2007, the contents of which are herein incorporated by reference in its entirety.

### BACKGROUND OF THE INVENTION

(1) Field of the Invention

The present invention relates to content processing devices and content processing methods. Examples of such content processing devices include a recording device which accumulates mainly multimedia contents, and a reproducing device which receives the accumulated contents to be transmitted from the recording device and reproduces the received contents. In particular, the present invention relates to a technique for allowing a plurality of devices connected via a network to share functions of the devices.

(2) Description of the Related Art

A broadcast wave transmitted from a broadcast station contains a wide variety of contents. Such contents may contain data in addition to video and audio used for general programs. Data transmitting methods include a plurality of schemes which are roughly classified into a scheme for transmitting data in time series and a scheme for repeatedly transmitting data at a constant interval. In the former, that is the scheme for transmitting data in time series, for example, the consecutive data is sequentially transmitted as time elapses. This scheme is suitable for the case of transmitting a large amount of data for a long time, but entails a drawback of not being able to re-receive the data in the case where the data was not received at a given transmission timing. On the other hand, in the latter, that is the scheme for repeatedly transmitting data at a constant interval, the same data is repeatedly transmitted so many times during a given time period. This scheme entails an advantage of not limiting a data reception timing because it is only necessary to receive any one of the repeatedly transmitted data during the time period in which the same data is repeatedly transmitted. For example, this scheme is used for data broadcasting represented by BML (broadcast Markup Language) and file transmission by a DSMCC (Digital Storage Media Command and Control) data carousel. Especially in broadcasting, it is impossible to know when a receiver starts receiving a broadcast wave by selecting a broadcast station. In the time-series transmission scheme, if data cannot be obtained because such data reception is started after a given data transmission timing, the data cannot be obtained any more. Thus, when it is desired to transmit data such as an application program together with video and audio in a broadcast wave, the scheme for repeatedly transmitting such data at a certain interval is preferred.

Currently, specifications according to the aforementioned scheme have been developed and applied. The specifications are for receiving a broadcast wave including video, audio and an application program and executing the application program in synchronization with video and audio. This makes it possible to not only allow viewing of general video with audio, but also achieve various additional functions by allowing a terminal to receive an input of a transmitted application program and to execute the application program. This method for receiving and inputting a transmitted application program to a terminal is called download. For example, in Europe, DVB-MHP (Digital Video Broadcasting-Multimedia Home Platform) ETSI ES 201 812 V1. 1. 1 (2003-12) Specifications have been developed, and application in conformity with the Specifications has already been started. Further, in the United States, Open Cable Application Platform (OCAP) OC-SP-OCAP1.0-116-050803 Specifications have been developed, and practical application is to be started. In these Specifications, application programs are described in Java language (registered trademark). Various Application Programming Interfaces (APIs) for tuning and graphics display are prepared on a terminal. A Java application program can control the functions by calling these APIs.

Furthermore, in North America, OCAP DVR OC-SP-OCAP-DVR-I03-070509 Specifications for adding content recording and reproducing function to the OCAP Specifications are being developed. These are intended for recording, as contents, a Java application program which is executed in synchronization with video and audio to be transmitted as a cable television broadcast, and further reproducing the recorded contents in the same manner as in the case of reproducing the contents directly from a broadcast wave. The application program is reproduced in synchronization with the video and audio as in the case of reproducing the contents directly from the broadcast. OCAP DVR defines a service as a set of video, audio and an application program which is executed in synchronization with the video and audio. When a broadcast receiving terminal reproduces the service, the corresponding application is executed in synchronization with reproduction of the video and audio.

In addition, OCAP DVR makes it possible to achieve special playback of recorded broadcast contents by recording the broadcast contents in a recording medium such as a hard disc or a semiconductor memory which allows a fast random access. Here, special playback is a function for reproducing contents at an arbitrary speed or starting reproduction of the contents at an arbitrary position. Such special playback includes fast-forward, rewind, slow, pause, skip, and so on. In OCAP DVR, an application program inputted from a broadcast wave to a terminal can control recording and special playback of contents. In other words, APIs for recording and special playback are prepared on a terminal, and a Java application program can control these functions by calling the APIs.

Recently, terminals which receive and record multimedia contents as mentioned above have been widespread, and there is a user's demand that the user wishes to share the received and recorded multimedia contents between the terminals connected via a home network.

More specifically, in North America, there is a user demand for streaming playback control for allowing a user to transfer a service or contents to another terminal and view the service or the contents. Here, the service has been received by using a broadcast receiving function of OCAP and so on, and the contents have been recorded in a terminal by using a recording function such as OCAP DVR. In other words, two terminals of a terminal A and a terminal B are connected via a network such as Ethernet, the terminal A records a service and transfers the recorded service to the terminal B, and the terminal B reproduces the service. This allows the user to view the contents by using the terminal B even when the user cannot use the terminal A. The number of terminals is not limited to two because the same mechanism works irrespective of the number, allowing any of the terminals to perform such reproduction.

In addition, there is a user demand for remote reservation recording for setting recording reservation to another terminal via a network. More specifically, two terminals of a terminal C and a terminal D are connected via a network, and a recording reservation from the terminal D is set to the terminal C. Here, recording reservation includes a service to be recorded and a recording time period indicating a recording starting time and a recording ending time. Hence, the terminal C records the service corresponding to the specified recording time period according to the recording reservation which has been set from the terminal D by using the recording function such as DVR. In this way, the user can cause the terminal C to record a service by using its recording function and devices by using the terminal D even when the terminal D does not mount or cannot use the recording function such as DVR or devices such as a tuner and a hard disc used for the recording. The number of terminals is not limited to two because the same mechanism works irrespective of the number of terminals, allowing any of the terminals to perform remote reservation recording.

This mechanism is called multi-room DVR because it allows the terminals placed in any rooms to share a received service or contents recorded by using DVR.

Further, as in OCAP DVR, it is conceivable that a downloaded Java application program controls service reproduction by the multi-room DVR function by using an API. More specifically, the terminal A mounts an API for recording control, and downloads and executes a Java application program for recording control. The Java application program for recording control allows a user to receive a broadcast service specified by the user and record it in a hard disc for DVR by using the API for recording control. On the other hand, the terminal B mounts an API for reproduction control, and downloads and executes a Java application program for reproduction control. The Java application program for reproduction control sends an instruction for searching for a service recorded on the terminal A and an instruction causing the terminal B to reproduce the service recorded on the terminal A by using the API for reproduction control. The terminal B which has received these instructions requests the terminal A to transfer the recorded service via the network, and receives and reproduces the service.

In addition, it is conceivable that the downloaded Java application program performs remote reservation recording by the multi-room DVR function by using an API. More specifically, the terminal D mounts a remote reservation recording API, and downloads and executes a Java application program for controlling recording reservation. This Java application program for recording reservation sends, by using a recording reservation API, an instruction causing the terminal C to receive a broadcast service specified by the user during a recording time period specified by the user and to set recording reservation for recording the broadcast service onto a hard disc for DVR.

Functions necessary for achieving multi-room DVR such as search and transmission of services are defined by the DLNA Specifications. DLNA is an abbreviation for Digital Living Network Alliance, and is the common specifications of network functions for home appliances. In DLNA, the devices connected via a network and the contents on the devices are searched for by using the UPnP (Universal Plug and Play) Specifications. In addition, the contents on the network is transferred by using the http protocol or the rtp protocol.

In addition, the multi-room DVR function allows a Java application program to specify a reproduction speed or a reproduction position of a service to be reproduced. In this case, the terminal A and the terminal B mutually adjust the transfer speed and the transfer position of the recorded service so as to reproduce the service at the specified reproduction speed and reproduction position.

Such specifications for achieving a function for allowing a Java application program to control a multi-room DVR through a Java API include OC-SP-OCAP-HNEXT1.0-I01-050519 of the OCAP Home Network Extension Specifications. These Specifications define an API for reproduction control which can call a Java application program and the operations of the same.

An API for remote reservation recording and the operations of the same are assumed to be developed in the future based on the aforementioned user demand.

As described above, the multi-room DVR function allows a plurality of terminals connected via a network to request a terminal to execute processing of streaming playback, remote reservation recording, or the like (the streaming playback is a processing for sending recorded contents in a stream to another terminal where the contents are reproduced). More specifically, applications to be executed on terminals E and F can request another terminal G to execute: streaming playback of contents recorded by the terminal G via a network; live streaming playback of a service received from a broadcast wave via a network (the live streaming playback is a processing for transmitting the received on-air service in a stream to another terminal where the service is reproduced); remote reservation recording of the service received from the broadcast wave; and the like. Further, the terminals E and F can request the terminal G to allow viewing or execute recording reservation of the received service by directly operating the terminal G by means that the application on the terminal G directly uses an OCAP function or an OCAP DVR function. Hence, these processing requests can be executed simultaneously from a plurality of terminals.

However, on the other hand, a network band is required during live streaming playback and streaming playback of recorded contents; the use of a tuner is required during reproduction of a service (reproduction on a terminal which has received the service), live streaming playback, and the recording time period in remote reservation recording; and the use of a hard disc is required during the recording time period of recording reservation and remote reservation recording, and during streaming playback of recorded contents. However, network bands, tuners, hard discs and the like necessary for the processing are limited devices.

Thus, in the case where a plurality of terminals request a terminal to perform remote reservation recording, and live streaming reproduction, and in the case where a processing requests such as a service reproduction request is made directly from the terminal itself, all the requests may not be accepted because the number of devices is less than required. In such case, there is a need to resolve contention between a plurality of terminals which are the request sources and determine the terminal to which devices are allocated so that the requested processing is executed.
[Patent Reference 1] Japanese Laid-open Patent Application Publication No. 2007-194974
[Non-patent Reference 1] “OCAP Specifications OC-SP-OCAP 1.0-I16-050803”
[Non-patent Reference 2] “OCAP-DVR Specifications OC-SP-OCAP-DVR-I03-070509”
[Non-patent Reference 3] “OCAP Home Network Extension Specifications OC-SP-OCAP-HNEXT 1.0-I01-050519”

### SUMMARY OF THE INVENTION

Problems that Invention is to Solve

In the environment where a plurality of terminals share devices on the terminals and execute processing as in the aforementioned multi-room DVR, in the case where the number of devices to be used for the processing is less than required, there is a need to determine device allocation by resolving the contention between the plurality of terminals.

The OCAP Specifications define a mechanism for resolving device contention between download applications to be executed on terminals, based on priority levels which have been set to the download applications. Here, in OCAP, the priority levels of the download applications are the priority levels described in AIT or XAIT contained in a broadcast wave to be transmitted from a broadcast station side system. AIT or XAIT is control information of a download application. For details, see the OCAP Specifications.

In general, the broadcast station side system multiplexes the same AIT and XAIT to a broadcast wave and transmits the broadcast wave to all the terminal devices to be connected through a cable. In general, AITs are transmitted on a service-by-service basis, and an XAIT is transmitted independently from the services. Thus, for example, the same XAIT is obtained by the terminal A and the terminal B. Therefore, the application to be executed by the terminal A according to the XAIT has the same priority level as the priority level of the application to be executed by the terminal B according to the XAIT. In addition, in the case where the terminal A and the terminal B are reproducing the same service 1, AIT, that is the AIT of the service 1, to be obtained by the terminal A and the terminal B is the same. Therefore, the application to be executed by the terminal A according to the AIT has the same priority level as the priority level of the application to be executed by the terminal B according to the AIT.

In this way, in the OCAP Specifications, the range of a priority level which has been set to the application is within an individual terminal, and thus it is impossible to compare the priority levels of applications on different terminals. For example, it is assumed that the priority level of an application 1 on the terminal A is 150, the priority level of an application 2 on the terminal A is 200, and the priority level of an application 3 on a different terminal B is 200. In this case, it can be judged that the priority level of the application 2 on the terminal A is higher than the priority level of the application 1 on the same terminal. However, it is impossible to judge that the priority level of the application 3 on the terminal B is higher than the priority level of the application 1 on the different terminal A. Let alone, it is assumed that the application 2 on the terminal A and the application 3 on the terminal B are the same application downloaded on different terminals. Therefore, it is no use to compare priority levels of the download applications on the different terminals from the first.

Therefore, it is impossible to resolve contention between a plurality of terminals by comparing the priority levels of the applications on the plurality of terminals.

In addition, as a method for resolving device contention between a plurality of terminals, Japanese Laid-open Patent Application Publication No. 2007-194974 “IMAGE DISPLAY DEVICE, IMAGE RECORDING DEVICE, AND IMAGE distribution CONTROL SYSTEM” registers “in advance” the order of priority for each of terminals connected to a network, and determines one of the terminals to which a device use right is assigned according to the registered order of priority when device contention occurs.

However, in Japanese Laid-open Patent Application No. 2007-194974, the priority levels are values which are statically set in advance, and thus it is impossible to allocate devices according to the states of the respective request source terminals and the types of requests for processing which requires devices. Such states include On, Off, standby, during content reproduction, and the like, and the states dynamically change. Such processing includes stream reproduction, remote reservation recording, live stream reproduction, and the like.

The present invention has an object to make it possible to set priority levels of a plurality of terminals based on, for example, contract information by a broadcast station side or download applications in the environment where the plurality of terminals share devices on terminals and execute processing, and to resolve device contention between the plurality of terminals based on the priority levels which “dynamically” change according to the dynamically-changing states of the respective terminals and the types of requested processing.

### Means to Solve the Problems

In order to achieve the above object, the content processing device according to the present invention executes processing on a content in response to a request from one of requesting devices, the content processing device including: a reproducing unit configured to reproduce a content; a transfer unit configured to transfer a content to at least one of the requesting devices; and a device contention resolving unit configured to resolve a contention between the requesting devices for use of a resource device required for reproduction by the reproducing unit and transferring by the transfer unit, the contention occurring in the case where each of the requesting devices requests the reproducing unit to reproduce the content or requests the transfer unit to transfer the content, wherein the device contention resolving unit includes: a priority level holding unit configured to hold base priority level data indicating, as base priority levels, priority levels in the use of the resource device, the priority levels being assigned to the respective requesting devices; a priority level deriving unit configured to execute deriving processing of deriving priority levels of the requests made by the respective requesting devices, based on: either states of the respective requesting devices or request types of the requests made by the respective requesting devices; and the base priority levels of the respective requesting devices indicated by the base priority level data; and a resolving processing unit configured to determine one of the requests to be a request for which the use of the resource device is allowed, according to a priority order of the requests assigned with the priority levels derived in the deriving processing executed by the priority level deriving unit, and wherein, depending on the request determined by the resolving processing unit, the reproducing unit reproduces the content by using the resource device, or the transfer unit transfers the content by using the resource device.

For example, when the content processing device (which is, for example, a terminal device such as a content recording and transmitting device) receives requests made by requesting devices (which are, for example, terminal devices such as content receiving and reproducing devices) connected via a network, a contention occurs for a device required for the processing according to these requests. More specifically, the device is a tuner, a hard disk, a buffer, or a network band. In this case, the present invention allows to derive the priority levels of the requests, based on the states of the requesting devices and the request types of the requests. Specific examples of the states of the requesting devices include a state where the transferred content is being reproduced, a state where the content received by the requesting device is being reproduced, or contract details for viewing the content, the contract details being set for the requesting device. Specific examples of the request types of the requests include reservation recording, reproduction, content transfer, buffering, device rental, or buffer data transfer. Accordingly, it is possible to dynamically derive proper priority levels according to the states of the requesting devices which change according to time and the request types of the requests, in response to the requests made by the requesting devices. Further, the present invention makes it possible to derive the priority levels of the requests made by the respective requesting devices, based on base priority levels which have been set for the respective requesting devices. Accordingly, for example, it is possible to derive proper priority levels by eliminating the possibility that the same priority level is derived in response to the requests made by the respective requesting devices, and thus to properly resolve a contention between the requesting devices. In addition, here is an example case where a broadcast station side which distributes a content or an application program sets the base priority levels directly or by using an application program which has been distributed from the broadcast station side and downloaded, based on contract details regarding viewing of the content. In this case, the broadcast station side can positively adjust the priority levels to be derived for the respective requests. In this way, the present invention makes it possible to derive priority levels which are proper and dynamically changed in response to the requests made by the requesting devices, and thereby resolving the contention between the requesting devices for use of a resource device properly and dynamically.

In addition, the device contention resolving unit may further include a standard data holding unit configured to hold standard data indicating priority level standards for each of the states of the respective requesting devices or for each of the request types of the requests, and the priority level deriving unit executes, as the deriving processing, a process of identifying provisional priority levels of the requests made by the respective requesting devices, based on the priority level standards indicated by the standard data, and a process of revising the provisional priority levels according to the base priority levels of the respective requesting devices indicated by the base priority level data.

In this way, the provisional priority levels are determined based on the states of requesting devices and the request types of the requests, and the provisional priority levels are revised based on the base priority levels so as to derive final priority levels. Therefore, it is possible to derive proper priority levels based on the base priority levels, the states of the requesting devices, and the request types of the requests by adding a weight to the states of the requesting devices or the request types of the requests. Examples of priority level standards include “Highest” and “Lowest”. Such standards corresponding to the respective requests are applied so that the provisional priority levels are determined. Here, application of different standards to the respective requests determines different provisional priority levels which are derived as final priority levels. In contrast, application of the same standard to the respective requests determines the same provisional priority levels which are subjected to revision based on the base priority levels so as to derive different final priority levels for the respective requests.

In addition, the priority level deriving unit may execute, as the deriving processing, a process of passing, to a handler of a lo downloaded application program, arguments indicating the base priority levels of the respective requesting devices indicated by the base priority level data, and either arguments indicating the states of the respective requesting devices, or arguments indicating the request types of the requests made by the respective requesting devices, and a process of obtaining the priority levels of the respective requesting devices derived by the handler.

In this way, the priority levels of the respective requests are derived by the handler. Thus, it is possible to simplify the hardware structure of the content processing device for deriving the priority levels.

It is to be noted that the present invention can be implemented as a content processing method, a content processing program, and a recording medium on which the content processing program is stored, in addition to as the content processing apparatus like this.

### Effects of the Invention

Even in the case where the content processing device according to the present invention receives requests from a plurality of requesting devices, the content processing device can provide an advantageous effect of deriving priority levels which are proper and dynamically changed according to the received requests, and properly and dynamically resolving a contention between the requesting devices for devices required for the processing to be executed according to the requests.

### BRIEF DESCRIPTION OF THE DRAWINGS

These and other objects, advantages and features of the invention will become apparent from the following description thereof taken in conjunction with the accompanying drawings that illustrate a specific embodiment of the invention.

FIG. 1 is a structural diagram showing an example of a broadcasting system according to the present invention.

FIG. 2 is a diagram showing an example of usage of frequency bands used for communication between a broadcast station side system and terminal devices in a cable television system according to the present invention.

FIG. 3 is a diagram showing an example of usage of frequency bands used for communication between a broadcast station side system and terminal devices in a cable television system according to the present invention.

FIG. 4 is a diagram showing an example of usage of frequency bands used for communication between a broadcast station side system and terminal devices in a cable television system according to the present invention.

FIG. 5 is a structural diagram showing an example of a TS packet defined in the MPEG-2 Specifications.

FIG. 6 is a schematic diagram of an MPEG-2 transport stream.

FIG. 7 is a diagram showing a division example where a PES packet defined in the MPEG-2 Specifications is segmented into TS packets to be transmitted.

FIG. 8 is a diagram showing a division example where an MPEG-2 section defined in the MPEG-2 Specifications is segmented into TS packets to be transmitted.

FIG. 9 is a structural diagram showing an MPEG-2 section defined in the MPEG-2 Specifications.

FIG. 10 is a diagram showing an example of use of MPEG-2 sections defined in the MPEG-2 Specifications.

FIG. 11 is a diagram showing an example of use of a PMT defined in the MPEG-2 Specifications.

FIG. 12 is a diagram showing an example of use of a PAT defined in the MPEG-2 Specifications.

FIG. 13 is a diagram showing an example of a hardware structure of the recording device according to the present invention.

FIG. 14 is a diagram showing an example of a front panel as an input unit 1310 in each of the hardware structures of the recording device and the reproducing device according to the present invention.

FIG. 15 is a diagram showing an example of device connection at the time of recording by the recording device according to the present invention.

FIG. 16 is a diagram showing an example of device connection at the time of reproduction by the recording device according to the present invention.

FIG. 17 is a diagram showing an example of a software structure of the recording device according to the present invention.

FIG. 18 is a diagram showing an example of an EPG executed by the recording device according to the present invention.

FIG. 19 is a diagram showing an example of an EPG executed by the recording device according to the present invention.

FIG. 20 is a diagram showing an example of information recorded in the second memory unit according to the present invention.

FIG. 21 is a diagram showing an example of a record information management table according to the present invention.

FIG. 22A is a schematic diagram representing the details of an AIT, which is defined in the DVB-MHP Standards, according to the present invention.

FIG. 22B is a schematic diagram representing the file system, which is transmitted by using the DSMCC scheme, according to the present invention.

FIG. 23 is a structural diagram of software recorded in the recording device according to the present invention.

FIG. 24 is a structural diagram of software recorded in the recording device according to the present invention.

FIG. 25 is a structural diagram of hardware of the reproducing device according to the present invention.

FIG. 26 is a diagram showing an example of device connection at the time of reproduction by the reproducing device according to the present invention.

FIG. 27 is a diagram showing an example of device connection at the time of reproduction by the reproducing device via a network according to the present invention.

FIG. 28 is a diagram showing an example of a software structure of the reproducing device according to the present invention.

FIG. 29 is a diagram showing an example of a software structure of the recording device according to the present invention.

FIG. 30 is a diagram showing an example of a display screen structure of the reproduction specification Java program according to the present invention.

FIG. 31 is a diagram showing an example of a device connection at the time when the recording device according to the present invention outputs a recorded service to the network.

FIG. 32 is a diagram showing an example of the inter-terminal network system according to the present invention.

FIG. 33 is a diagram showing an example of the inter-terminal network system according to the present invention.

FIG. 34 is a flowchart for illustrating exclusive device use processing based on the OCAP Specification prescription.

FIG. 35 is a diagram for illustrating exclusive device use processing based on the OCAP Specification prescription.

FIG. 36 is a flowchart for illustrating exclusive device use processing based on the OCAP Specification prescription.

FIG. 37 is a flowchart for illustrating exclusive device use processing based on the OCAP Specification prescription.

FIG. 38 is a flowchart for illustrating exclusive device use processing based on the OCAP Specification prescription.

FIG. 39 is a flowchart for illustrating exclusive device use processing based on the OCAP Specification prescription.

FIG. 40 is a flowchart for illustrating exclusive device use processing based on the OCAP Specification prescription.

FIG. 41 is a structural diagram of an example of software recorded in the recording device according to the present invention.

FIG. 42 is a structural diagram of an example of software recorded in the recording device according to the present invention.

FIG. 43 is a diagram showing examples of processing request types according to the present invention.

FIG. 44 is a structural diagram showing an example of the inter-terminal network system according to the present invention.

FIG. 45A is a diagram showing examples of the priority levels, of the respective terminals, which have been set by the priority level setting unit according to the present invention.

FIG. 45B is a diagram showing an example of an API which the device contention resolving manager provides to a Java program.

FIG. 45B is a diagram showing an example of an API which the device contention resolving manager provides to a Java program.

FIG. 46A shows examples of the revision standards for the respective request types which have been set by the priority level revision standard setting unit according to the present invention.

FIG. 46B is a diagram showing an example of an API which the device contention resolving manager provides to a Java program.

FIG. 46B is a diagram showing an example of an API which the device contention resolving manager provides to a Java program.

FIG. 47A is a diagram showing examples of the revision standards for the states, of the respective request-source terminals, which have been set by the priority level revision standard setting unit according to the present invention.

FIG. 47B is a diagram showing an example of an API which the device contention resolving manager provides to a Java program.

FIG. 48 is a diagram showing examples of the “device allocation requests” recorded by the device contention resolving processing unit according to the present invention.

FIG. 49 is a simple flowchart of the processing for revising priority levels according to the “revision standards for respective requests types” according to the present invention.

FIG. 50A is a diagram showing an example of the priority levels of the “device allocation requests” which the priority level revision processing unit have revised based on the “base priority levels” and the “revision standards for the respective types” according to the present invention.

FIG. 50B is a diagram showing devices allocated according to the priority levels of the “device allocation requests”.

FIG. 51 is a simple flowchart of the processing for revising priority levels according to the “revision standards for the states of the respective request-source terminals” according to the present invention.

FIG. 52A is an example of the priority levels of the “device allocation requests” which the priority level revision processing unit have revised based on the “base priority levels” and the “revision standards for the respective types” according to the present invention.

FIG. 52B is a diagram showing devices allocated according to the priority levels of the “device allocation requests”.

FIG. 53 is a structural diagram of software recorded in the recording device according to Embodiment 2 of the present invention.

FIG. 54A is a diagram showing an example of an API which the device contention resolving manager according to the present invention provides to a Java program.

FIG. 54B is a diagram for illustrating the API.

FIG. 54C is a diagram for illustrating the API.

FIG. 54D is a diagram showing an example of an API which the device contention resolving manager according to the present invention provides to a Java program.

FIG. 54D is a diagram showing an example of an API which the device contention resolving manager according to the present invention provides to a Java program.

FIG. 55A is an example of an API which the device contention resolving manager 1706 according to the present invention provides to a Java program.

FIG. 55B is a diagram for illustrating the API.

FIG. 56 is a simple flowchart of the processing for performing “revision for each request type” by an inquiry to a handler according to the present invention.

FIG. 57 is a simple flowchart of the processing for performing “revision for the state of each request-source terminal” by an inquiry to a handler according to the present invention.

FIG. 58 is a diagram showing the result of priority level revisions made on the “request-source terminals” based on the “revision standards for the states of the respective request-source terminals” according to the present invention.

FIG. 59 is a structural diagram showing an example of the inter-terminal network system in the case where the device contention resolving manager according to the present invention is mounted on a terminal other than the recording device (content recording and transmitting device.

### NUMERICAL REFERENCES

101 Broadcast station side system
111 Terminal device A
112 Terminal device B
113 Terminal device C
1706 Device confliction resolving manager
3201 Content recording and transmitting device
3202 Content receiving and reproducing device (A)
3203 Terminal
3204 Network
3304 Massage transmitting and receiving unit
4101 Priority level setting unit
4102 Priority level revision standard setting unit
4103 Priority level revision processing unit
4104 State inquiry unit
4404 Content receiving and reproducing device (B)
4405 Content receiving and reproducing device (C)

### DESCRIPTION OF THE PREFERRED EMBODIMENT(S)

### Embodiment 1

Descriptions are given of a device and a method according to a first embodiment of the present invention with reference to the drawings hereinafter. The present invention relates to recording and reproducing contents to be transmitted and received by using an arbitrary medium. This embodiment describes an example in a cable television broadcasting system. In the cable television broadcasting system, a content processing device according to the present invention is generally called a multi-media data receiving device, or simply, terminal device. The terminal device is one of a recording device, a reproducing device, or a broadcast recording and reproducing device having, within the body, both functions of a recording device and a reproducing device. In this embodiment, the terminal device is especially called “recording device”, “reproducing device”, or “broadcast recording and reproducing device” when having the function(s) is important.

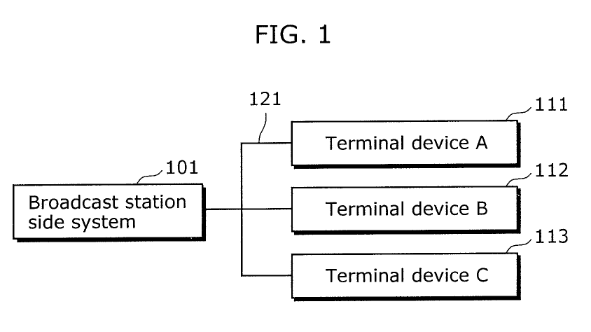

FIG. 1 is a block diagram showing the relationship of devices which configure a broadcasting system. The broadcasting system is configured with a broadcast station side system 101, and three terminals of a terminal device A111, a terminal device B112, and a terminal device C113. Each of the terminal devices (content processing devices) is one of a recording device, a reproducing device, or a broadcast recording and reproducing device having, within the body, both functions of a recording device and a reproducing device. A connection 121 between the broadcast station side system and the respective terminal devices in the cable system is a wired connection with a co-axis cable, an optical fiber or the like. In this embodiment, it is assumed that the connection is made by using a co-axis cable in order to perform inter-terminal network communication by using later-described MOCA (which is the abbreviation of Multimedia over Coax Alliance, and the Standard for achieving an IP network on an RF co-axis cable). In FIG. 1, three terminal devices are connected to a single broadcast station side system, but the number of terminal devices may be any. In FIG. 1, the respective terminal devices are connected to the broadcast station side system 101 through the co-axis cable, and the respective terminal devices are also connected to each other through the co-axis cable. In other words, the terminal device A111, the terminal device B112, the terminal device C113 are connected to each other through the co-axis cable. In general, in the case where a plurality of terminals is arranged in a household, the terminals are arranged in rooms one-by-one. In this case, the terminal devices arranged in the rooms are connected to each other through the co-axis cable. Such connection can be easily achieved by using a co-axis cable allotter.

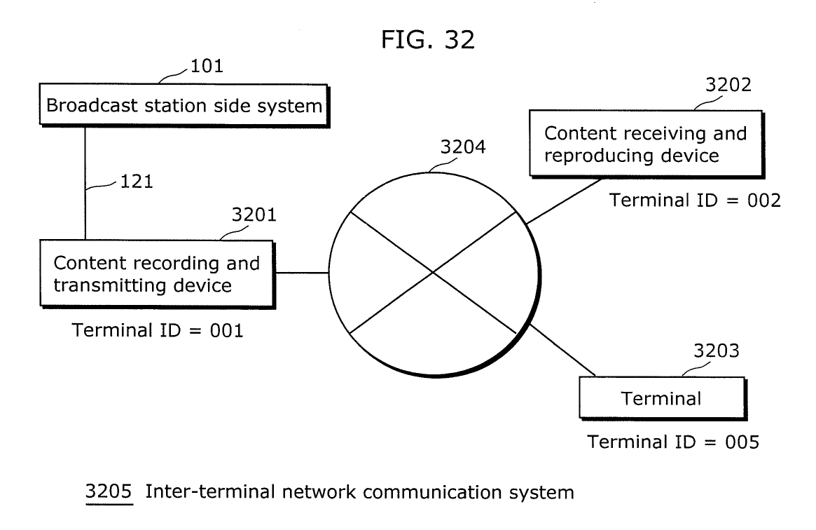

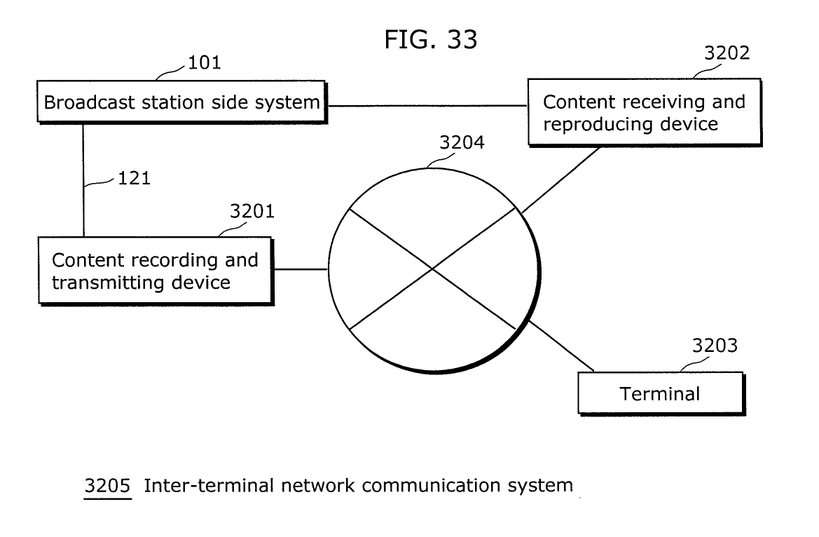

The broadcast station side system 101 integrates, into a broadcast signal, information such as video, audio and data for data broadcast, and transmits the broadcast signal to the plurality of terminal devices. The broadcast signal is transmitted by using frequency in an established frequency band specified by operation specifications of a broadcasting system and/or by a law of a country and/or the area where the broadcasting system is operated. A structural example of inter-terminal network communication is described with reference to FIG. 32 and FIG. 33.

In the cable system in this embodiment, a frequency band used for broadcast signal transmission is divided into frequency bands each of which is allocated to a corresponding one of data contents and transmission directions (upward, downward).

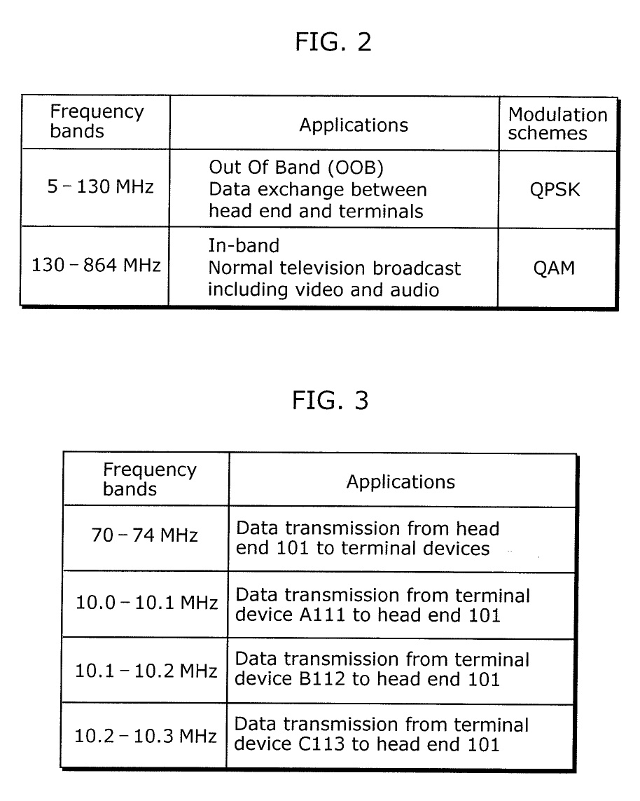

FIG. 2 is a chart showing an example of the division of the frequency band. The frequency band is roughly divided into two types, that is, Out Of Band (abbreviated as OOB) and In-Band. 5 to 130 MHz is assigned as OOB, and is mainly used for data exchange performed between the broadcast station side system 101, the terminal device A111, the terminal device B112, the terminal device C113 in both the up and down directions. 130 MHz to 864 MHz is assigned as In-Band, and is mainly used for broadcast channels including video and audio in down direction only. QPSK modulation scheme is used with OOB, and the QAM 64 or QAM 256 modulation scheme is used with In-Band. Modulation scheme technology is generally known and of little concern to the present invention, and therefore detailed descriptions are omitted.

FIG. 3 is an example of a more detailed use of the OOB frequency band. 70 MHz to 74 MHz is used for the downward data transmission from the broadcast station side system 101, and all of the terminal A111, terminal B112, terminal C113 are to receive identical data from the broadcast station side system 101. On the other hand, 10.0 MHz to 10.1 MHz is used for the upward data transmission from the terminal device All to the broadcast station side system 101, 10.1 MHz to 10.2 MHz is used for the upward data transmission from the terminal device B112 to the broadcast station side system 101, and 10.2 MHz to 10.3 MHz is used for the upward data transmission from the terminal device C113 to the broadcast station side system 101. In this way, it is possible to independently transmit data unique to the respective terminal devices from the terminal device A111, the terminal device B112, and the terminal device C113 to the broadcast station side system 101.

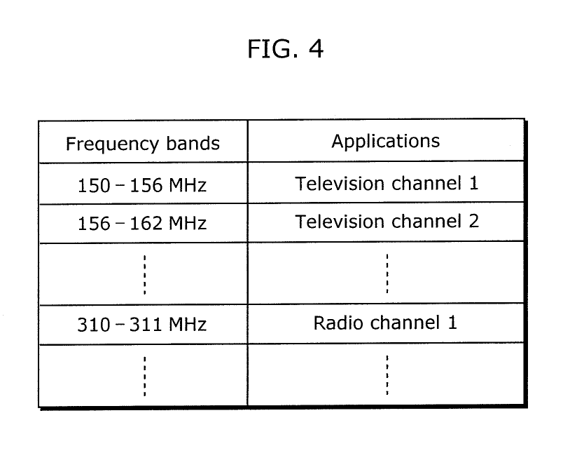

FIG. 4 is an example of use of an In-Band frequency band. 150 to 156 MHz and 156 to 162 MHz are allocated to a television channel 1 and a television channel 2 respectively, and the subsequent frequency is allocated to television channels at a 6 MHz interval. Radio channels are allocated in 1 MHz units from 310 MHz on. Each of these channels may be used as analog broadcast or as digital broadcast. In the case of digital broadcast, such data is transmitted in form of TS packets based on the MPEG-2 Specifications, and it is possible to transmit various data for broadcast and program editing information for making an EPG in addition to audio and video.

The broadcast station side system 101 includes a QPSK modulation unit and a QAM modulation unit for transmitting proper broadcast signals to terminal devices by using the aforementioned frequency bands. In addition, the head end 101 has a QPSK demodulator for receiving data from the terminal devices. In addition, it is assumed that the broadcast station side system 101 includes various devices related to these modulation units and demodulation unit. However, the present invention relates mainly to the terminal devices, and therefore detailed descriptions are omitted.

On the other hand, the terminal device A111, the terminal device B112, and the terminal device C113 include QAM demodulation units and QPSK demodulation units for receiving broadcast signals from the broadcast station side system 101 and reproducing the broadcast signals. These terminals further include QPSK modulation units for transmitting, to the broadcast station side system 101, data unique to the respective terminal devices. In the present invention, these terminal devices (content processing devices) are recording devices or reproducing devices, and the structures are described in detail later on.

The broadcast station side system 101 modulates an MPEG-2 transport stream (which may be abbreviated as TS), integrates it into a broadcast signal, and transmits it. These terminal devices receive the broadcast signal, demodulate it to reconstruct the MPEG-2 transport stream, extract necessary information from it, and use the information. In order to describe the functions and the connection structure of the devices which are present in the terminal devices, brief descriptions are firstly given of the structure of an MPEG-2 transport stream.

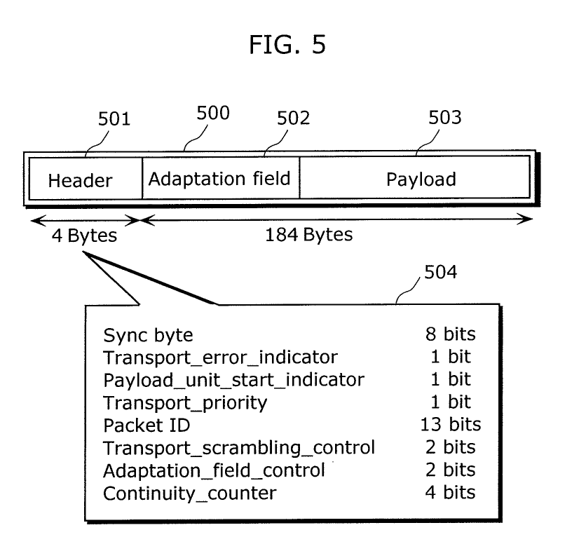

FIG. 5 is a diagram showing the structure of a TS packet. A TS packet 500 has a length of 188 bytes, and is structured with a header 501, an adaptation field 502, and a payload 503. The header 501 holds control information of the TS packet. The header 501 has a length of 4 bytes, and is structured as indicated by 504. A field described as “Packet ID (PID hereinafter)” is held inside of this, and the TS packet is identified based on this PID value. The adaptation field 502 holds additional information such as time information. The adaptation field 502 is not necessarily required, and there may be a case where no adaptation field 502 exists. A payload 503 holds information to be transmitted in the TS packet. Such information includes video, audio, and data for data broadcast.

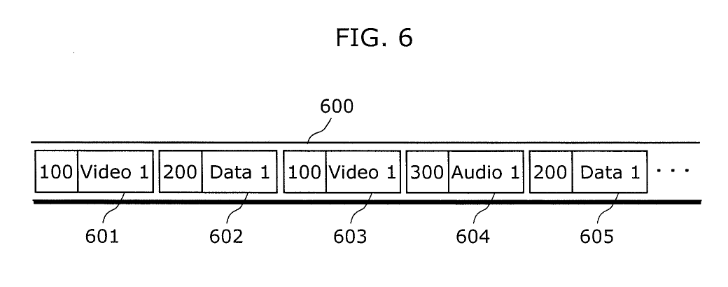

FIG. 6 is a schematic diagram of an MPEG-2 transport stream. The TS packet holds, in the payload, various information such as video, audio, and data for data broadcast. The TS packet 601 and the TS packet 603 hold PID 100 in the headers, and hold information related to a video 1 in the payloads. The TS packet 602 and the TS packet 605 hold PID 200 in the headers, and hold information related to data 1 in the payloads. The TS packet 604 holds PID 300 in the header, and holds information related to an audio 1 in the payload. Integrating TS packets which hold various types of data in their payloads into a sequence and transmitting the sequence is called multiplexing. The MPEG-2 transport stream 600 is an example of a structure including multiplexed TS packets 601 to 605.

TS packets having an identical PID hold the same type of information. Therefore, the terminal devices can reconstruct video and audio and reconstruct data such as program editing information by receiving multiplexed TS packets and extracting the information held by the respective TS packets on a PID-by-PID basis. In FIG. 6, both the TS packet 601 and the TS packet 603 transmit information related to the video 1, and both the TS packet 602 and the TS packet 605 transmit information related to the data 1.

Here, descriptions are given of the formats of various data contained in the payloads.

Video and audio are represented in form of PES (Packetized Elementary Stream) packets. PES packets include video information or audio information corresponding to a certain time zone. When recording devices or reproducing devices receive these PES packets, they can output the video and audio information included in these PES packets to a display screen or speakers. As long as a broadcast station transmits PES packets continuously, the recording devices or reproducing devices can reproduce the video and audio continuously. In the case where a PES packet is greater in size than the payload of a single TS packet, the PES packet is divided and stored in a plurality of TS packets in the transmission of the PES packets.

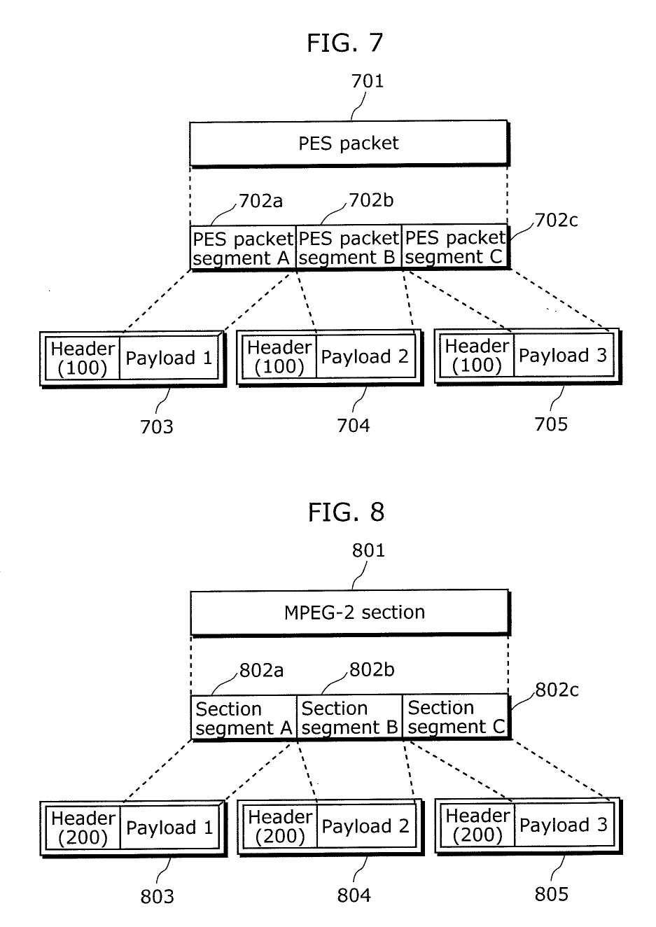

FIG. 7 shows an example of how such PES packet is divided in the transmission. A PES packet 701 is too big to be stored in the payload of a single TS packet so as to be transmitted. Thus, it is divided into a PES packet segment A702a, a PES packet segment B702b, a PES packet segment C702c, and is transmitted by three TS packets 703 to 705 which have an identical PID. In reality, such video and audio can be obtained as elementary streams (ES) obtainable by combining data included in the payloads of a plurality of PES packets. These elementary streams have digital video and audio formats defined in the MPEG-2 Video Standards or the MPEG-1 and -2 Audio Standards.

On the other hand, information such as program editing information and data for data broadcasting are represented by using a format called MPEG-2 section. In the case where an MPEG-2 section is greater in size than the payload of a single TS packet, the MPEG-2 section is divided and stored in a plurality of TS packets in the transmission of the MPEG-2 section.

FIG. 8 shows an example of how such MPEG-2 section is divided in the transmission. An MPEG-2 section 801 is too big to be stored in the payload of a single TS packet so as to be transmitted. Thus, it is divided into a section segment A802a, a section segment B802b, and a section segment C802c, and is transmitted by three TS packets 803 to 805 which have an identical PID.

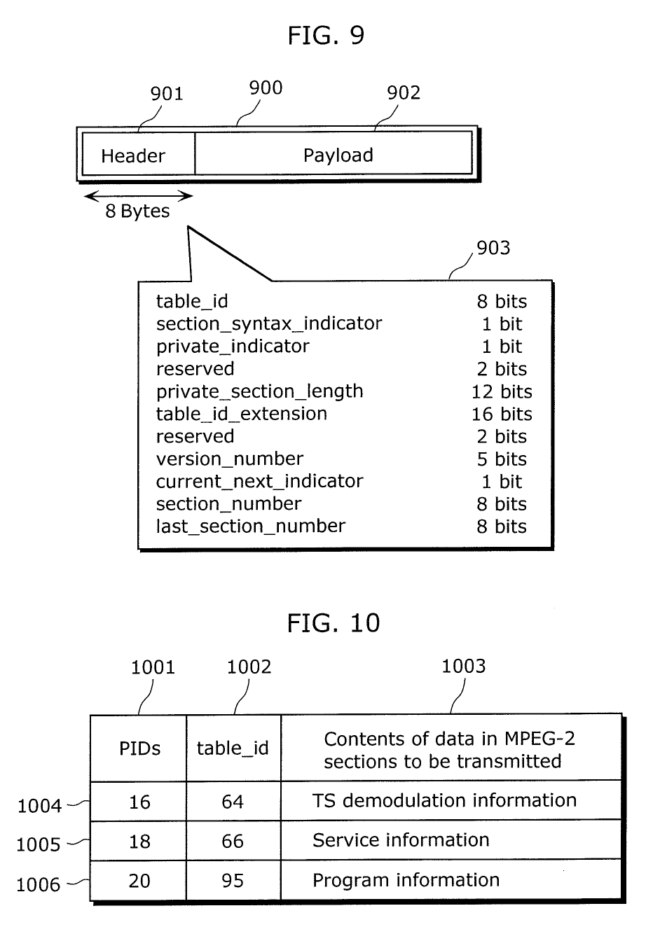

FIG. 9 represents the structure of an MPEG-2 section. An MPEG-2 section 900 is structured with a header 901 and a payload 902. The header 901 holds control information of the MPEG-2 section. The structure is represented by the header structure 903. The payload 902 holds data to be transmitted in the MPEG-2 section 900. The header structure 903 contains table_id which represents the type of an MPEG-2 section, and further table_id_extension which is an extension identifier used for distinguishing MPEG-2 sections having an identical table_id.

As a use example of such MPEG-2 sections, FIG. 10 shows a case of transmitting program editing information. In this case, as described in a line 1004, information necessary for demodulating a broadcast signal is described in an MPEG-2 section which has 64 as a table_id in the header structure 903, and further, the MPEG-2 section is transmitted by a TS packet assigned with PID 16.

In the case of MPEG-2 sections, no PES formats exist. Thus, a combination of the payloads of the TS packets which are identified, based on an identical PID, in an MPEG-2 transport stream is regarded as an elementary stream (ES). For example, in FIG. 8, all the TS packets 803 to 805 which transmit a divided MPEG-2 section 801 are identified based on PID 200. It can be said that they are ESs which transmit the MPEG-2 section 801.

The MPEG-2 transport streams further involve a concept of a program. A program is represented as a set of ESs, and is used in the case where a plurality of ESs is desired to be handled all together. The use of a program makes it possible to handle video and audio, and data for data broadcasting attached thereto and the like all together. For example, in the case of handling video and audio desired to be reproduced simultaneously, combining a video ES and an audio ES as a program allows a recording device or a reproducing device to recognize that these two ESs should be reproduced simultaneously as a single program.

In MPEG-2, two tables called PMT (Program Map Table) and PAT (Program Association Table) are used to represent a program. Detailed descriptions can be found in the ISO/IEC13818-1 “MPEG-2 Systems”. The following are brief descriptions of PMTs and PATs.

PMTs are tables included in an MPEG-2 transport stream, and the number of PMTs equals to the number of programs. PMTs are structured as MPEG-2 sections, and their table_id is 2. PMT holds a program number used for identifying the program, additional information of the program, and further information related to the ESs which belong to the program.

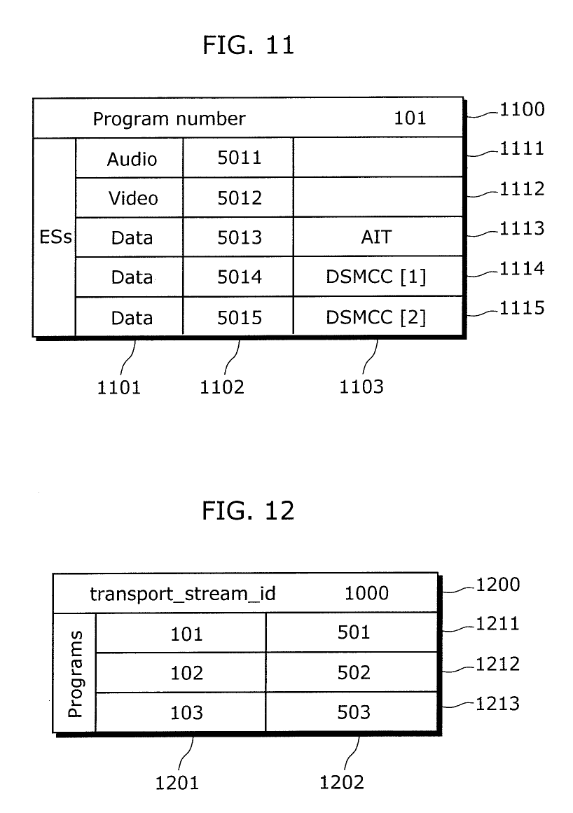

FIG. 11 shows an example of a PMT. 1100 denotes a program number. Program numbers are uniquely assigned to programs in the same transport stream, and are used for identification. Lines 1111 to 1115 represent information related to the individual ESs. A column 1101 specifies the types of ESs such as “video”, “audio”, and “data”. A column 1102 describes PIDs of the TS packets which structure the ESs. A column 1103 describes additional information related to the ESs. For example, an Es represented in the line 1111 is an audio ES, and is transmitted by a TS packet assigned with PID 5011.

A PAT is a table which is uniquely present in an MPEG-2 transport stream. A PAT is structured as an MPEG-2 section, and is transmitted in a TS packet assigned with table_id 0 and PID 0. A PAT holds information related to transport_stream_id used for identifying an MPEG-2 transport stream and all PMTs which represent programs present in the MPEG-2 transport stream.

FIG. 12 shows an example of a PAT. 1200 denotes transport_stream_id. The transport_stream_id is used for identifying an MPEG-2 transport stream. Lines 1211 to 1213 represent information related to programs. A column 1201 describes program numbers. A column 1202 describes the PIDs of TS packets which transmit PMTs corresponding to the programs. For example, the PMT of the program described in the line 1211 has a program number of 101, and thus the corresponding PMT is transmitted in the TS packet assigned with PID 501.

In the case where a terminal device reproduces a program, video and audio which structure the program are reproduced by specifying them by using the PAT and PMT. For example, in the case of reproducing the video and audio which belong to the program assigned with Program number 101 included in an MPEG-2 transport stream which transmits the PAT in FIG. 12 and PMT in FIG. 11, the following procedure is taken. First, The PAT to be transmitted as an MPEG-2 section assigned with table_id “0” is obtained from a TS packet assigned with PID “0”. A program with a program number of “101” is searched for based on its PAT, and the line 1211 is obtained. From the line 1211, the PID “501” of the TS packet which transmits the PMT of the program assigned with Program number “101” is obtained. Next, from the TS packet assigned with Program number “501”, a PMT to be transmitted as an MPEG-2 section assigned with table_id “2” is obtained. From the PMT, the line 1111 which is the ES information of audio and the line 1112 which is the ES information of video are obtained. From the line 1111, the PID “5011” of the TS packet which transmits the audio ES is obtained. From the line 1112, the PID “5012” of the TS packet which transmits the video ES is obtained. Next, a PES packet for audio is obtained from the TS packet assigned with PID “5011”, and a PES packet for video is obtained from the TS packet assigned with PID “5012”. In this way, it becomes possible to obtain the video and audio ES packets to be reproduced, and to reproduce the video and audio which structure the program assigned with the program number 101.

It is to be noted that an MPEG-2 transport stream received may be encrypted. This is a mechanism called limited viewing. For example, the execution of encryption processing on the PES packets which transmit certain video and audio information allows viewing only by the specified viewers who can decrypt the encryption. The viewers descramble the encryption by using a device called descrambler in order to view the video and audio. For example, an OCAP-compliant terminal device uses a card-shaped adaptor including a descrambler. An operator of a cable television distributes, to each viewer, an adaptor which has been preset to decrypt a specific program. The viewer inserts the adopter into his/her terminal device. Then, the adaptor descrambles the encryption of the specific program, based on descrambling information such as a descrambling key and contract information of the contractor. Descrambling schemes and methods for obtaining descrambling keys depend on adaptors, and the present invention can be implemented irrespective of these.

The following descriptions describe network communication between multi-media data receiving terminals in this embodiment of the present invention. FIG. 32 illustrates a multi-media content communication system 3205 in detail focusing on a network communication system which structures the broadcasting system shown in FIG. 1. A broadcast station 101 shown in FIG. 32 is the same as the broadcast station 101 shown in FIG. 1, and a content recording and transmitting device (content processing device) 3201 and a content receiving and reproducing device 3202 are the same in the terminal devices shown in FIG. 1.

Each of FIG. 32 and FIG. 33 is a schematic diagram showing an example of inter-terminal network communication system in this embodiment of the present invention. In FIG. 32, the content recording and transmitting device 3201 represents a recording device in the present invention, the content receiving and reproducing device 3202 represents a reproducing device in the present invention, and 3202 denotes a terminal which is a general client device as defined by DLNA or the like. 3204 denotes a network, and 3205 denotes a multimedia content communication system structured with these. The content recording and transmitting device 3201, the content receiving and reproducing device 3202, and the terminal 3203 are connected via a network 3204 (for example, a home network), and can mutually communicate with devices available via the network 3204 (such devices in this example are the content recording and transmitting device 3201, the content receiving and reproducing device 3202, and the terminal 3203 which are available in a household). In addition, 101 denotes a cable television broadcast station, 121 denotes a cable through which the content recording and transmitting device 3201 and the broadcast station 101 are connected. In addition, the devices connected through the network 3204 in this embodiment have terminal IDs. The terminal IDs are identification information for uniquely identifying terminals to be connected via the network 3204. In the inter-terminal network communication system illustrated in FIG. 32, the terminal ID of the content recording and transmitting device 3201 is “001”, the terminal ID of the content receiving and reproducing device 3202 is “002”, and the terminal ID of the terminal 3203 is “003”.

The content receiving and reproducing device 3201 in this embodiment is a CATV STB (Set Top Box) which includes a network interface and a memory area for recording multimedia data, and receives digital broadcast. The content recording and transmitting device 3201 is connected to the broadcast station 101 through the cable 121. Then the content receiving and reproducing device 3201 accumulates, in the memory area, the multimedia data of digital broadcast contents received from the broadcast station 101. Furthermore, the content receiving and reproducing device 3201 is connected to the network 3204 through a network interface. Then, it receives a request transmitted from the content receiving and reproducing device 3202 and the terminal 3203 via the network 3204. Then, it is intended for transmitting the contents of digital broadcast received in response to the request, or the information, attributes, and multimedia data of the respective accumulated contents to the content receiving and reproducing device 3202 and the terminal 3203 via the network 3204. Otherwise, it is intended for recording the contents of the digital broadcast received from the broadcast station 101 in response to the request from the content receiving and reproducing device 3202 and the terminal 3203. In this embodiment, it is to be noted that the content recording and transmitting device 3201 is assumed to use HTTP (Hypertext Transfer Protocol) specified as essential as a communication protocol which is used when multimedia data is transmitted via the network 3204, but the same effect can be obtained in the case of using another protocol.

In addition, the content recording and transmitting device 3201 accumulates the digital broadcast contents received from the broadcast 101 according to the request from the content receiving and reproducing device 3202 and the terminal 3203. It is assumed that these accumulated contents are provided to the content receiving and reproducing device 3202 and the terminal 3203 (remote reservation recording).

It is to be note that the content recording and transmitting device 3201 may provide all the multimedia contents accumulated in the memory area, and may also provide multimedia contents within the scope which has been set according to an application program (simply referred to as application hereinafter) downloaded from the broadcast station.

In response to a request from a user, the content receiving and reproducing device 3202 transmits, to the content recording and transmitting device 3201, a request for transmitting a list of contents which can be provided, and a request for transmitting multimedia data and the attributes of the contents. In addition, it receives data from the content recording and transmitting device 3201 as the response, and presents it to the user. In addition, in response to the request from the user, it transmits the request for recording reservation (remote reservation recording) to the content recording and transmitting device 3201.

In response to the request from the user, the terminal 3203 transmits, to the content recording and transmitting device 3201, a request for transmitting the list of available contents and a request for transmitting the multimedia data and the attributes of the contents. In addition, it receives data from the content recording and transmitting device 3201 as the response, and presents it to the user. The terminal 3203 is, for example, a device which is mounted according to the guidelines developed by DLNA. Since details of DLNA-compliant devices are described in the guidelines issued by DLNA, their descriptions are omitted.

The network 3204 is a home network established in the household, and is an IP network configured of Ethernet, wireless LAN, and so on.

The following describes communication between the content recording and transmitting device 3201, the content receiving and reproducing device 3202 and the terminal 3203 and their operations.

When connected via the network 3204, the content recording and transmitting device 3201, the content receiving and reproducing device 3202, and the terminal 3203 search for the other devices connected via the network 3204, and obtain information about the functions of the respective devices. This communication can be made according to the method defined by the UPnP DA (Device Architecture) as in the DLNA, and thus detailed descriptions are omitted.

The following describes communication between the content recording and transmitting device 3201 and the content receiving and reproducing device 3202 or the terminal 3203 in the obtainment of the content list information.

First, the content receiving and reproducing device 3202 or the terminal 3203 issues a request for transmitting a list of available contents to the content recording and transmitting device 3201. Then, the content recording and transmitting device 3201 receives the request, searches for the available contents, and transmits the list to the content receiving and reproducing device 3202. This communication can be made according to the Browse or Search in the UPnP AV CDS (UPnP AV Content Directory Service), and thus detailed descriptions are omitted.

The content receiving and reproducing device 3202 or the terminal 3203 which has received the available content list presents the list to the user. Then, it requests the content recording and transmitting device 3201 to transmit the data of the contents selected by the user. The content recording and transmitting device 3201 reads the requested content data from the memory area, and transmits it to the content receiving and reproducing device 3202 or the terminal 3203 which is the request source. The content receiving and reproducing device 3202 or the terminal 3203 which has received the content data presents it to the user. Since this sequence of operations can be carried out according to the method defined by DLNA, detailed descriptions are omitted.

The following describes communication between the content recording and transmitting device 3201 and the content receiving and reproducing device 3202 or the terminal 3203 in the remote reservation recording.

The content receiving and reproducing device 3202 or the terminal 3203 issues a remote reservation recording request to the content recording and transmitting device 3201. Then, the content recording and transmitting device 3201 records the received digital broadcast contents according to the request. This communication can be made according to the UPnP SRS (Scheduled Recording Service) CreateRecordSchedule( ) and the like, and thus detailed descriptions are omitted.

FIG. 32 illustrates the configuration of an inter-terminal network communication system where only the content recording and transmitting device 3201 is connected to the broadcast station 101, but it is to be noted that, as shown in FIG. 33, the present invention is applicable in the case of employing a system where the content receiving and reproducing device 3202 is connected to the broadcast station 101, a system where the terminal 3203 is connected to the broadcast station 101, and an inter-terminal network communication system where a plurality of devices which configure the system are connected to the broadcast station 101.

In addition, it is to be noted that FIG. 32 illustrates the configuration of the inter-terminal network communication system where the content recording and transmitting device 3201 and the content receiving and reproducing device 3202 are mounted on different terminals respectively, but the present invention is applicable in the case of a system where a single terminal has both the functions of the content recording and transmitting device 3201 and the functions of the content receiving and reproducing device 3202. More specifically, the present invention is applicable even in the case where the content recording and transmitting device 3201 is structured to have the functions of the content receiving and reproducing device 3202 in addition to the functions of the content recording and transmitting device 3201, and in the case where the content receiving and reproducing device 3202 is structured to have the functions of the content recording and transmitting device 3201 in addition to the functions of the content receiving and reproducing device 3202.

Brief descriptions of the MPEG-2 Specifications and the inter-terminal network communications have been given, and detailed definitions of terms are given here. In the present invention, two types of the term “program” exist. One is a “program” which appears in the MPEG-2 Specifications, and the other is a “program” referring to a set of codes executed by a CPU. As the former is synonymous with the term “service” used in the operation regulations, hereinafter, to avoid confusion, the former is called “service” and the latter is called simply “program”. Furthermore, concerning the latter, a “Program” particularly described in the lava language is called a “lava program”.

Brief descriptions about the MPEG-2 Specifications and the inter-terminal network communications according to the present invention have been given above. Hereinafter, detailed descriptions are given of the recording device and the reproducing device used in this embodiment.

First, the following are detailed descriptions of the structure and functions of the recording device used in this embodiment.

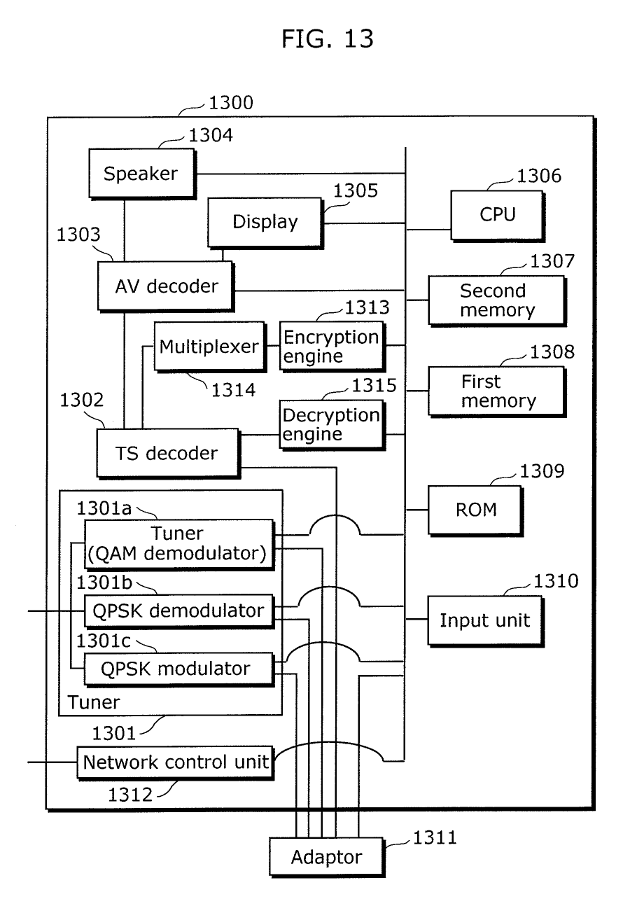

FIG. 13 is a block diagram showing a general hardware configuration of the recording device in this embodiment, in other words, a specific internal structure of each of the terminals 111, 112, and 113 in FIG. 1. 1300 denotes a recording device, which is structured with: a tuner 1301; a TS decoder (TS Demultiplexer) 1302; an AV decoder 1303; a speaker 1304; a display 1305; a CPU 1306; a second memory unit 1307; a first memory unit 1308; a ROM 1309; an input unit 1310; an adaptor 1311, a network control unit 1312, an encryption engine 1313, a multiplexer 1314, and a decryption engine 1315. It is to be note that this embodiment is obtained by expanding a broadcast recording and reproducing device implemented according to the OCAP-DVR Specifications and the OCAP Home Network Specifications, and the basic hardware configuration is based on the hardware configuration of the recording device required by the OCAP-DVR Specifications and the OCAP Home Network Specifications.

The tuner 1301 is a device which demodulates a broadcast signal modulated and transmitted from the broadcast station side system 101, in accordance with tuning information such as a frequency specified by the CPU 1306. The tuner 1301 includes: a QAM demodulator 1301a which demodulates In-band signals, a QPSK demodulator which demodulates Out-of-band signals, and a QPSK modulator 1301c which modulates the Out-of-band signals. An MPEG-2 transport stream obtained as the result that the QAM demodulator 1301a of the tuner 1301 has demodulated an In-band signal is transferred to the TS decoder 1302 through the adaptor 1311 having a descrambling function.

The decryption engine 1315 decrypts the encryption applied to an MPEG-2 transport stream by the encryption engine 1313, and outputs the decrypted MPEG-2 transport stream. The encryption method depends on the encryption scheme provided with the encryption engine 1313, and the decryption is performed by the same scheme as the encryption scheme that the encryption engine 1313 has used for the encryption. As described later, the MPEG-2 transport stream encrypted by the encryption engine at the time of recording is recorded in the second memory unit 1307, and inputted from the second memory unit 1307 to the encryption engine when it is reproduced from the second memory unit 1307. The decryption engine 1315 receives an input of decryption key and decrypts the MPEG-2 transport stream by using the decryption key. The MPEG-2 transport stream decrypted by the decryption engine 1315 is inputted to the TS decoder 1302.

The TS decoder 1302 is a device which has a function for selecting PES packets and MPEG-2 sections which meet the specified conditions from an MPEG-2 transport stream, based on the specifications such as PIDs specified by the CPU 1306 and section filter conditions. This selection function is called packet filtering. The TS decoder includes two filter devices which are a PID filter and a section filter. Filtering is described in detail later on. The TS decoder receives an input in form of an MPEG-2 transport stream. The MPEG-2 transport stream is supplied from the adaptor 1311 or the second memory unit 1307 through the decryption engine 1315. The TS decoder outputs PES packets obtained by performing packet filtering on the inputted MPEG-2 transport stream. The PES packets are supplied to the AV decoder 1303, the multiplexer 1314, or the first memory unit 1308. The video and audio PES packets selected by the TS decoder 1302 are outputted to the AV decoder 1303. In addition, the MPEG-2 sections selected by the TS decoder 1302 are transferred to the first memory unit 1308 by using DMA (Direct Memory Access), and are used by a program executed by the CPU 1306. The input source and the output destination of the TS decoder 1302 are controlled by the CPU 1306 in response to an instruction from software. This is described in detail in the descriptions of software.

The AV decoder 1303 is a device which has a function for decoding encoded video ESs and audio ESs. The AV decoder extracts these ESs from the PES packets which carry the audio and video information transmitted from the TS decoder and decodes these ESs. The decoded audio signal and the video signal obtained by the AV decoder 1303 are outputted to the speaker 1304 and the display 1305 when the service is reproduced, or are outputted to the AV encoder when the service is recorded. The CPU 1306 controls switching between these output paths in response to an instruction from software.

The speaker 1304 reproduces audio outputted from the AV decoder 1303.

The display 1305 reproduces the video outputted from the AV decoder 1303.

The CPU 1306 executes a program which is operated on the recording device. The CPU 1306 executes a program which is included in a ROM 1309. Otherwise, it also executes a program downloaded from a broadcast signal or via a network, and held in the first memory unit 1308. Otherwise, it also executes a program downloaded from a broadcast signal or via a network, and held in the second memory unit 1307. According to instructions of a program which is executed, it controls a tuner 1301, a TS decoder 1302, an AV decoder 1303, a speaker 1304, a display 1305, a second memory unit 1307, a first memory unit 1308, a ROM 1309, an input unit 1310, an adaptor 1311, an AV encoder, a multiplexer 1314, and a network control unit 1312. In addition, the CPU 1306 can communicate with not only the devices present in the terminal device 1300 but also the devices in the adaptor 1311, and can control the adaptor 1311.

The second memory unit 1307 is a memory device in which memory is not deleted even when a power source of the device is turned off. For example, it is configured with devices in which information is not deleted even when the power source of the terminal device 1300 is turned off and stores information according to an instruction from the CPU 1306. Such devices include: a non-volatile memory such as a FLASH-ROM; an HDD (Hard Disk Drive); and a rewritable media such as a CD-R or a DVD-R. For example, it can store an encryption key which is used by the encryption engine 1313 and a decryption key which is used by the decryption engine 1315 in the second memory unit 1307. In the case of recording an encryption key and a decryption key, the encryption key and the decryption key are further encrypted and recorded so as not to allow a third party to use these keys. This is described in detail in the descriptions of software. Further, in the case of recording an encryption key and a decryption key, a so-called secure memory for blocking access from outside so as to prevent the third party from reading these keys may be used. In the case of using such secure memory, read and write from and in the secure memory is executed only by the CPU 1306, which increases the confidentiality of information.

The first memory unit 1308 is a device which has a function for temporarily storing information according to an instruction of the CPU 1306 or a device which can perform DMA transfer, and is implemented as an RAM or the like.

A ROM 1309 is a non-rewritable memory device, and is implemented as, specifically, a ROM, a CD-ROM, a DVD or the like. The ROM 1309 stores a program executed by the CPU 1306.

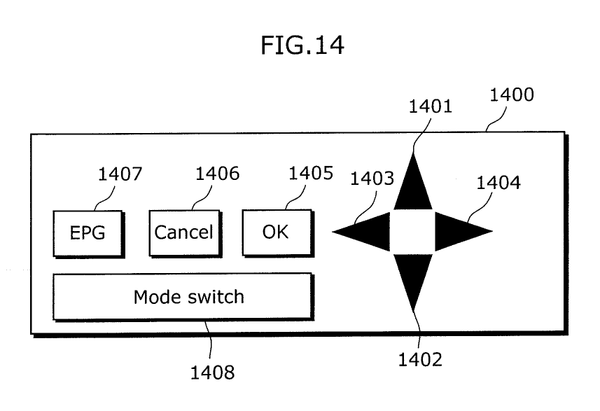

The input unit 1310 is implemented as, specifically, a front panel, a remote-control receiver, and receives an input from the user. FIG. 14 shows an example of the input unit 1310 in the case where it is implemented as a front panel. A front panel 1400 has seven buttons: an up cursor button 1401, a down cursor button 1402, a left cursor button 1403, a right cursor button 1404, an OK button 1405, a cancel button 1406, an EPG button 1407, and a mode switching button 1408. When the user presses a button, an identifier of the pressed button is notified to the CPU 1306.

The adaptor 1311 is a device for descrambling an encrypted MPEG-2 transport stream to be transmitted in the In-band frequency band, and includes one or more descramblers. The MPEG-2 transport stream outputted by the tuner 1301a is inputted into the adaptor 1311, and the encrypted TS packet assigned with the PID specified by the CPU 1306 is descrambled. The adaptor 1311 outputs the decrypted MPEG-2 transport stream to the TS decoder 1302.

Furthermore, the adaptor 1311 performs format conversion of data to be transmitted in the OOB frequency band. The information to be transmitted in the OOB frequency band may be modulated according to the QPSK modulation scheme. Regarding downstream transmission, the QPSK demodulator 1301b demodulates the downstream signal transmitted from the broadcast station side system 101, and inputs the generated bit stream into the adaptor 1311. The adaptor 1311 extracts information specified by the CPU 1306 from among various types of information included in the bit stream, converts the information to a format which can be interpreted by a program which is operated in the CPU 1306, and provides this to the CPU 1306. On the other hand, regarding upstream transmission, the CPU 1306 inputs information which is desired to be transmitted to the broadcast station side system 101, into the adaptor 1311. The adaptor 1311 converts the information inputted from the CPU 1306 to a format which can be interpreted by the broadcast station side system 101, and inputs this to the QPSK modulator 1301c. The QPSK modulator 1301c QPSK-modulates the information inputted from the adaptor 1311, and transmits this to the broadcast station side system 101.

A CableCARD, formerly called a POD (Point of Deployment), used in the United States cable system, can be provided as a specific example of the adaptor 1311.

The multiplexer 1314 is a device which has a function for multiplexing video and audio PES packets or private section data outputted by the TS decoder 1302 into an MPEG-2 transport stream. This is called multiplexer. The multiplexer 1313 can be implemented according to a known technique.

The encryption engine 1313 encrypts an MPEG-2 transport stream outputted from the multiplexer. The encryption engine 131 receives inputs of an MPEG-2 transport stream and an encryption key. Such encryption key is given in form of software. An arbitrary encryption scheme may be used, and for example, the AES scheme or 3DES scheme can be used. The encryption engine 1313 outputs an encrypted MPEG-2 transport stream. As for the encryption of such MPEG-2 transport stream, the whole MPEG-2 transport stream may be encrypted, or only the portion other than a portion corresponding to a header area may be encrypted. The decryption operation of the decryption engine 1315 is determined depending on the encryption scheme. The encrypted MPEG-2 transport stream outputted from the encryption engine 1313 is inputted and recorded in the second memory 1307.

The network control unit 1312 inputs and outputs arbitrary data to and from the network. The physical layer and logical layer of the network may be structured arbitrarily. As an example, MOCA is used as the physical layer in this embodiment. In addition, it is assumed that the HTTP and TCP/IP protocols are used in the logical layer, and that the logical layer is implemented in form of software. As described above, MOCA is the standard for implementing an IP network on an RF co-axis cable. The mechanism multiplexes and modulates a signal for the IP network, transmits the signal in a frequency band different from the QAM modulated wave and the QPSK modulated wave flowing on the co-axis cable, and receives the signal by demodulating the frequency, and is generally implemented as a modem device. What is multiplexed on the wave physically modulated according to MoCA are packets defined in the HTTP and TCP/IP protocols. Then, software processing is executed on the IP packets received via the network, and the resulting IP packets are outputted. For example, in this embodiment, an HTTP request is received in form of TCP/IP packets, and data as the result of the software processing is outputted as the HTTP response according to the request. Details of communication by the HTTP/TCP/IP protocols are described in the descriptions of software.

Descriptions are given of how the respective units of the recording device which have been described above are operated.

First, descriptions are given of the operation for recording a service in a broadcast wave in an encrypted MPEG-2 format in the second memory unit 1307, that is, the operation at the time of recording.

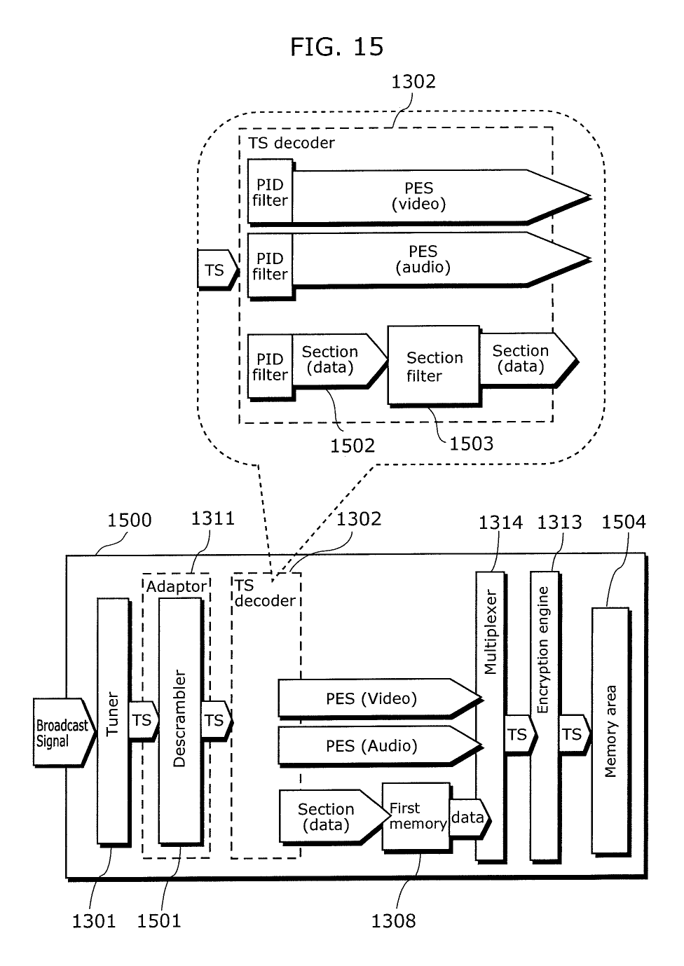

FIG. 15 shows a conceptual diagram representing the order of physical connections between the respective devices, the processing details of the devices, and the input and output data formats at the time when a service is recorded. 1500 denotes a recording device which includes: tuner 1301, an adaptor 1311, a descrambler 1501, a TS decoder 1302, a PID filter 1502, a section filter 1503, a multiplexer 1314, an encryption engine 1313, a first memory unit 1308, and a memory area 1504. The structural elements in FIG. 15 assigned with the same reference numerals as those assigned to the structural elements in FIG. 13 have equivalent functions, and thus descriptions of these are omitted.

First, the tuner 1301 tunes a broadcast wave according to a tuning instruction made by the CPU 1306. The tuner 1301 demodulates the broadcast wave, and inputs an MPEG-2 transport stream to the adaptor 1311.

The descrambler 1501 present in the adaptor 1311 descrambles a viewing-limiting encryption on the received MPEG-2 transport stream based on the limit-descrambling information for each viewer. The MPEG-2 transport stream on which the viewing-limiting encryption is descrambled is inputted to the TS decoder.

The TS decoder 1302 includes two types of devices which execute processing on the MPEG-2 transport stream, a PID filter 1502, and a section filter 1503.

The PID filter 1502 extracts TS packets which have PIDs specified by the CPU 1306 from the inputted MPEG-2 transport stream, and further extracts the PES packets and the MPEG-2 sections which are present in the payloads. For example, in the case where the MPEG-2 transport stream in FIG. 6 is inputted when the CPU 1306 directs PID filtering for extracting the TS packet assigned with PID 100, packets 601 and 603 are extracted and then connected to each other so as to reconstruct a PES packet of the video 1. Otherwise, in the case where the MPEG-2 transport stream in FIG. 6 is inputted when the CPU 1306 directs PID filtering for extracting the TS packet assigned with PID 200, packets 602 and 605 are extracted and then connected to each other so as to reconstruct an MPEG-2 section of the data 1.

The section filter 1503 extracts MPEG-2 sections which meet the section filter conditions specified by the CPU 1306 from among the inputted MPEG-2 sections, and DMA-transfers them to the first memory unit 1308. As such section filter conditions, PID values, and table_id values as supplemental conditions can be specified. For example, it is assumed that the CPU 1306 directs the section filter 1503 to execute PID filtering for extracting the TS packet assigned with PID 200 and section filtering for extracting a section which has a table_id of 64. As described earlier, after the MPEG-2 sections of the data 1 are reconstructed, the section filter 1503 extracts only the section which has the table_id 64 from among the MPEG-2 sections, and DMA-transfers it to the first memory unit 1308 which is a buffer.

The MPEG-2 sections inputted to the first memory unit 1308 are inputted to the multiplexer 1314.

The video PES packets and the audio PES packets extracted by the TS decoder 1302 are inputted to the multiplexer 1314.

The multiplexer 1314 multiplexes the inputted video PES packets and audio PES packets with the MPEG-2 sections inputted from the first memory 1308 to generate an MPEG-2 transport stream. The generated MPEG-2 transport stream is inputted to the encryption engine 1313.

The encryption engine 1313 encrypts the MPEG-2 transport stream by using an encryption key separately given from the CPU 1306, and outputs it.

The outputted encrypted MPEG-2 transport stream is recorded in the memory area 1504.

The memory area 1504 is structured with the whole or a part of the second memory unit 1307 or the other memory area, and stores the encrypted MPEG-2 transport stream including services.

By the aforementioned operations, arbitrary services included in the received broadcast signal are recorded in the memory area 1504, that is, are recorded.

The recording processing is executed according to a request for reservation recording from users who use the recording device and a request for reservation recording from outside the terminal via the network. Detailed descriptions of this are given later.

Next, descriptions are given of the operation for sequentially reading the encrypted MPEG-2 transport sections recorded in the second memory unit 1307 and reproducing the services on the recording device.

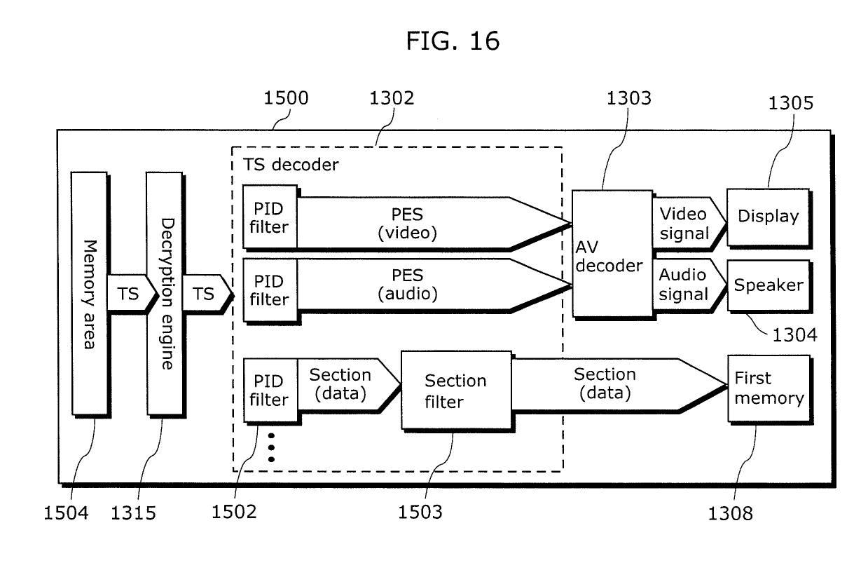

FIG. 16 shows a conceptual diagram representing the order of physical connections between the respective devices, the processing details of the devices, and the input and output data formats at the time when a service is reproduced in this case. 1500 denotes a terminal device which includes: a memory area 1504, a decryption engine 1315, a TS decoder 1302, a PID filter 1502, a section filter 1503, an AV decoder 1303, a speaker 1304, a display 1305, and a first memory unit 1308. The structural elements in FIG. 16 assigned with the same reference numerals as those assigned to the structural elements in FIG. 13 have equivalent functions, and thus descriptions of these are omitted.

The encrypted MPEG-2 transport stream recorded in the memory area 1504 according to the procedure illustrated in FIG. 15 is inputted to the decryption engine 1315. The decryption engine decrypts the encrypted MPEG-2 transport stream by using the encryption scheme used by the encryption engine 1313. A decryption key is given by the CPU 1306.

The decrypted MPEG-2 transport stream is inputted to the TS decoder 1302.

Next, the video PESs and audio PESs specified by the CPU 1306 are extracted by the PID filter 1502 in the TS decoder 1302. The extracted PES packets are inputted to the AV decoder 1303. Otherwise, the MPEG-2 sections which have PIDs and table_id specified by the CPU 1306 are extracted by the PID filter 1502 and the section filter 1503 in the TS decoder 1302. The extracted MPEG-2 sections are DMA-transferred to the first memory unit 1308.

The video PESs and audio PESs inputted to the AV decoder 1303 are decoded into an audio signal and a video signal to be outputted. Subsequently, the audio signal and video signal are inputted to the display 1305 and the speaker 1304 so that video and audio are reproduced.

The MPEG-2 sections inputted to the first memory 1308 are inputted to the CPU 1306 as needed, and used by software.

Next, descriptions are given of the operation for sequentially reading encrypted MPEG-2 transport streams recorded in the second memory 1307 and outputting the services to the network.

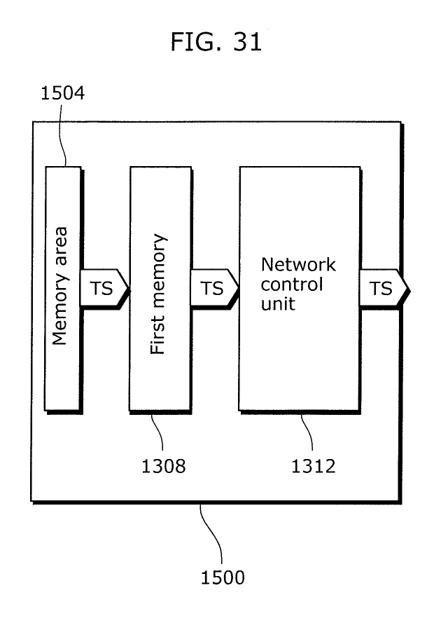

FIG. 31 shows a conceptual diagram representing the order of physical connections between the respective devices, the processing details of the devices, and the input and output data formats in this case. 1500 denotes the terminal device which includes the memory area 1504, the first memory unit 1308, and the network control unit 1312. The structural elements in FIG. 31 assigned with the same reference numerals as those assigned to the structural elements in FIG. 13 have equivalent functions, and thus descriptions of these are omitted.

When receiving an HTTP request from outside the terminal via the network, the CPU 1306 reads an encrypted MPEG-2 transport stream specified by the HTTP request from the memory area 1504. The read encrypted MPEG-2 transport stream is inputted to the first memory unit 1308.

The encrypted MPEG-2 transport stream inputted in the first memory unit 1308 is converted, by software, into packet form defined by the HTTP/TCP/IP protocols. The encrypted MPEG-2 transport stream converted into packet form is inputted to the network control unit 1312.

The network control unit 1312 outputs the MPEG-2 transport stream converted into packet form, based on the MOCA definitions. In this case, a co-axis cable is used for the network, and thus the packets are to be transmitted to the other connected terminals.

Descriptions have been given of examples of hardware configurations related to the recording device according to the present invention up to this point. The following describe principal functions of the recording device according to the present invention: recording control of services by a Java program, recording control of services via the network (remote reservation recording), reproduction control of recorded services, and output control of services via the network.

To record services in the recording device according to the present invention is to record video, audio, a Java program, synchronization information of the Java program included in a service onto an arbitrary recording medium such as hard disc, a BD (Blu-ray Disc), a DVD (Digital Versatile Disc), an SD (Secure Digital) memory card, and has the same meaning of recording the service. These recording media is described as the second memory unit 1307 in the structure of FIG. 13. To reproduce a recorded service is to reproduce or execute the video, audio, Java program recorded on a recording medium based on the synchronization information. The reproduction result of the recorded service is required to be approximately equivalent to the reproduction result obtainable by receiving a broadcast wave and directly reproducing the service. To output of a service via a network does not mean that the terminal itself reproduces a recorded service, but means that the terminal outputs the video, audio, Java program, synchronization information of the Java program and the like included in the service via the network so as to allow another terminal to reproduce the service.

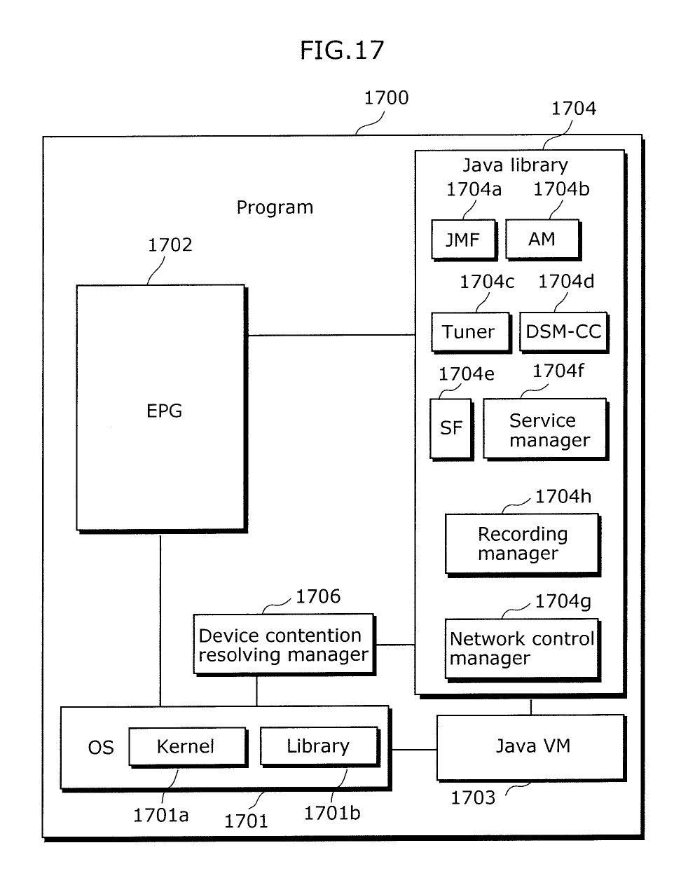

FIG. 17 is a diagram showing the structure of a program which is required for recording control of a service by the Java program, recording control of a service via the network (remote reservation recording), reproduction control of a recorded service, and output control of a service via the network, and the structure of a downloaded Java program which is described later on. This is software which is operated on the recording device in this embodiment. A program 1700 is software recorded in the ROM 1309.

The program 1700 is structured with an OS 1701, an EPG 1702, a Java VM 1703, and a Java library 1704 which are sub-programs.

The OS 1701 is an operating system, and examples of this include Linux, and Windows. The OS 1701 is structured with other sub-programs such as a kernel 1701a for executing the EPG 1702 and the Java VM 1703 and a library 1701b used for allowing the sub-programs to control the structural elements of a terminal device 1300. The kernel 1701a is a known technique, and thus detailed descriptions are omitted.

The library 1701b provides, for example, a tuning function for controlling a tuner. The library 1701b receives tuning information including a frequency from an other sub-program, and passes it to the tuner 1301. The tuner 1301 can execute demodulation processing based on the given tuning information, and pass the demodulated MPEG-2 transport stream to the TS decoder 1302. As the result of this, the other sub-program can control the tuner 1301 through the library 1701b.

In addition, the library 1701b provides channel information for uniquely identifying a channel. An example of channel information is shown in FIG. 20. Such channel information is transmitted by using OOB or In-band frequency band, converted into a table format by the adaptor 1311, and stored in a temporary memory unit accessible by the library. A column 2001 describes channel identifiers corresponding to, for example, source_ID which is defined by the SCTE 65 Service Information Delivered Out-Of-Band For Digital Cable Television. A column 2002 describes channel names corresponding to source_name in the SCTE 65 Standards. A column 2003 is tuning information which is information such as a frequency, a transfer rate, and a modulation scheme which are given to the tuner 1301. A column 2004 describes program numbers for specifying PMTs. For example, a line 2011 describes a set of a channel identifier “1”, a channel name “Channel 1”, frequency “150 Mhz, . . . ” as tuning information, and information of a service assigned with Program number “101”.

In addition, the library 1701b provides a network protocol stack such as the HTTP/TCP/IP. These protocols define formats at the time when data is packetized, message exchange and the timing at the time when the data is transferred. The network protocol stack is implemented as software describing its definitions. For example, a request according to the HTTP protocol is packetized into TCP packets, further into IP packets, and outputted to the network. A receiver side expands the received IP packets according to the IP protocol specifications and extracts the TCP packets, and further expands the TCP packets according to the TCP protocol specifications and extracts the HTTP request message. In addition, when receiving the HTTP request, it packetizes an HTTP response according to the network protocol in the same manner and transmits it.

In addition, the library 1701b provides a control function for reading and writing data from and to the second memory unit 1307. The respective software structural elements can read and write arbitrary data according to a file system of the second memory unit 1307 by using the library 1701b.

In addition, the library 1701b judges the state of the terminal itself. Here, examples of the states of the terminal include power off, standby, during viewing of a broadcast service, during VOD (Video on Demand) streaming viewing. It is to be noted that the states of the terminal are not limited to the above states.

The library 1701b can set parameters for control in addition to these for the hardware structural elements shown in FIG. 13. Functions of the individual elements are described later.

The Java VM 1703 is a Java virtual machine which sequentially analyzes and executes programs described in the Java™ language. Programs described in the Java language are compiled into intermediate codes known as byte codes which are not dependent on hardware. A Java virtual machine is an interpreter which executes such byte codes. The Java VM 1703 executes the Java library 1704 described in the Java language. Details of Java language and Java VM can be found in, for example, the following books, that is, “Java Language Specification (ISBN 0-201-63451-1)”, and “Java Virtual Machine Specification (ISBN 0-201-63451-X)”. In addition, it is possible to call an other sub-program which is not described in Java language or to be called by such sub-program through a JNI (Java Native Interface). As for JNI, see a book “Java Native Interface” and the like.

The Java library 1704 is a library which is described in Java language and which the Java program calls to control the functions of the recording device. It is to be noted that a sub-program such as the library 1701b of the OS 1701 which is described in non-Java language may be used as necessary. The Java program uses functions provided by the Java library 1704 by calling a Java API (Application Programming Interface) which the Java library 1704 has.

The tuner 1704c is a Java library for controlling the tuner 1301a for receiving In-band in the broadcast recording and reproducing device. When the Java program passes tuning information including a frequency to the tuner 1704c, the tuner 1704c calls the tuner function of the library 1701b by using the tuning information, and as the result, the tuner 1704c can control the operations of the tuner 1301a for receiving In-band in the broadcast recording and reproducing device.

The SF (Section Filter) 1704e is a Java library for controlling functions of the PID filter 1502 and the section filter 1503 of the broadcast recording and reproducing device. When the Java program passes, to the SF 1704e, filter conditions such as PIDs and table_id, the SF 1704e sets, for control, the filter conditions to the PID filter 1502 and the section filter 1503 by using the functions of the library 1701b, obtains the MPEG-2 sections which meet the desired filter conditions, and passes them to the Java program which has set the filter conditions.

A DSM-CC 1704d is a Java library for accessing the file system of a DSM-CC object carousel. This DSM-CC object carousel is included in the MPEG-2 sections obtained by the SF 1704e. The DSM-CC is defined by the ISO-IEC 13818-6 Standards, and is a mechanism for transmitting arbitrary files by using the MPEG-2 sections. The use of this makes it possible to transmit such files from a broadcast station to a terminal. The DSM-CC 1704d obtains MPEG-2 sections by using the SF 1704e, based on the DSMCC identifiers and file identifiers specified by the Java program or the like, extracts the files according to the ISO/IEC 13818-6 Standards, and outputs them to the first memory unit 1308 or the second memory unit 1307. Detailed descriptions for implementing the DSM-CC method are omitted because they are not related to the present invention.

The AM 1704b is an application manager for providing functions for managing execution and termination of the Java program included in a service. The AM 1704b extracts the Java program multiplexed on a specified channel on a specified MPEG-2 transport stream, and executes or terminates the extracted Java program according to the synchronization information which has been separately multiplexed. Java class files of the Java program are multiplexed on the MPEG-2 transport stream according to the aforementioned DSM-CC scheme. In addition, the synchronization information of the Java program has a format called AIT, and is multiplexed in the MPEG-2 transport stream. AIT is an abbreviation of Application Information Table which is defined in Chapter 10 of the DVB-MHP Standards (ETSI TS 101 812 DVB-MHP Specifications V1.0.2), and an MPEG-2 section which has a table_id of“0x74”. In the descriptions in this embodiment, AIT defined by the DVB-MHP Standards is modified for use.

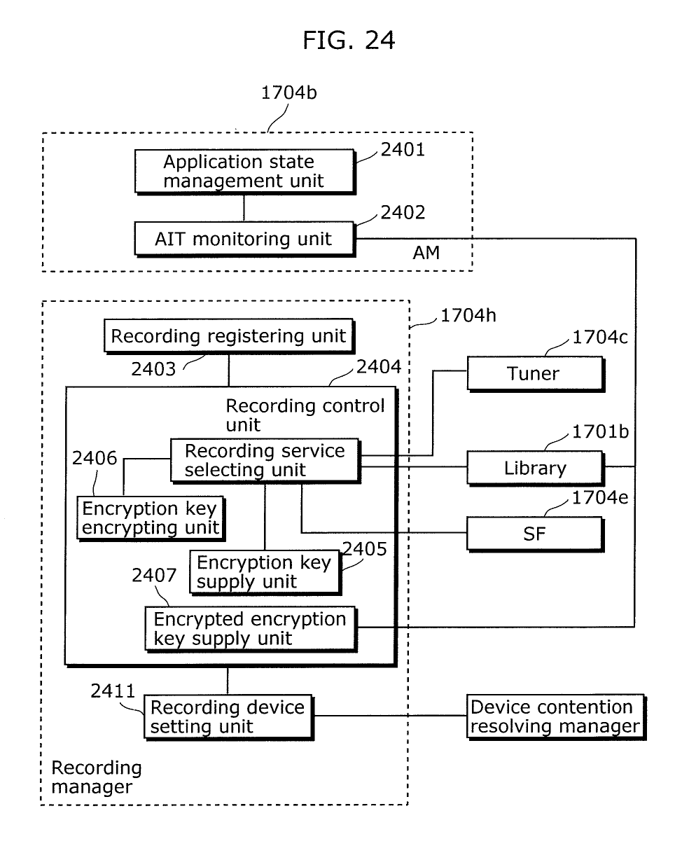

The internal structure of the AM 1704b is shown in FIG. 24. The AM 1704b is structured with an AIT monitoring unit 2402, and an application state management unit 2401.

The AIT monitoring unit 2402 receives an input of a private section and a channel identifier in the MPEG-2 transport stream outputted from the TS decoder at the time when the service is reproduced, and monitors the update state of the AIT. First, the AIT monitoring unit 2402 searches for channel information of the library 1701b by using the specified channel identifier as a key, and obtains the program number of the service. Next, it obtains a PAT from the MPEG-2 transport stream by using the SF 1704e and the like. Further, from the information of a PMT, it obtains PIDs corresponding to the obtained program numbers in the PMT. It obtains an actual PMT by using the SF 1704e again. FIG. 11 shows the format of the obtained PMT which describes PIDs of elementary streams assigned with stream type “data” and “AIT” as supplementary information. Further, when the SF 1704e is given the PID and table_id “0x74” in the justly obtained AIT as filter conditions, it can obtain the entity of the AIT.

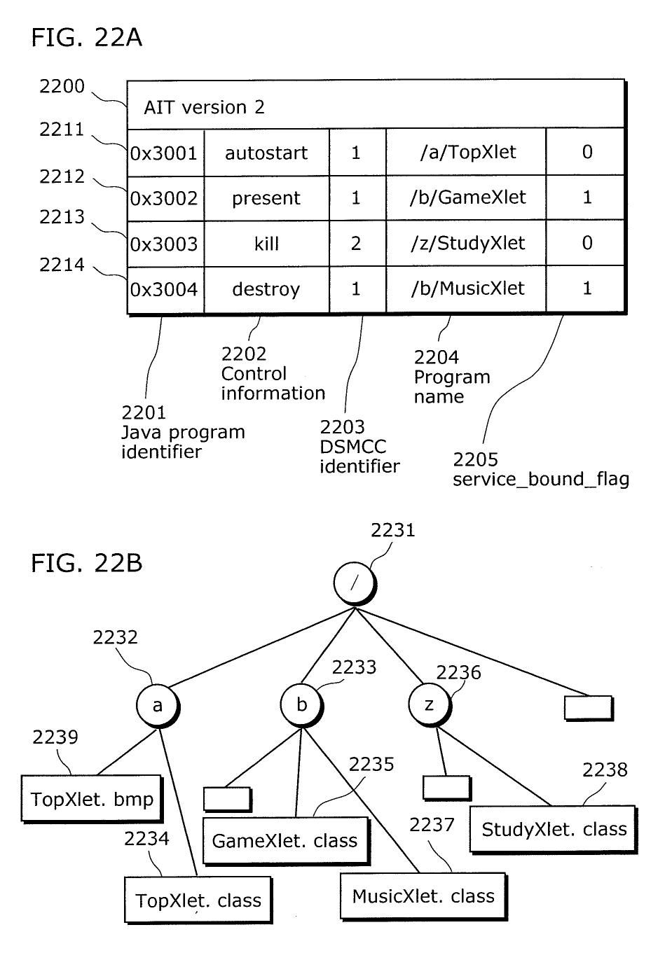

FIG. 22A is a chart which schematically shows an example of information of the AIT. The AIT version number 2200 represents the version of the AIT. The greater the number of the AIT version, the newer the AIT. The AIT monitoring unit 2402 repeatedly receives AITs which have the same AIT version, but does not obtain AITs which have the same AIT version as the AIT version of the already obtained AITs by ignoring them, and obtains only the AITs newer than the already obtained AITs. The AIT monitoring unit 2402 outputs each of newly-obtained AITs to the application state management unit 2401 and the recording management unit 2404. The column 2201 describes the identifiers of Java programs. According to the MHP Standards, these identifiers are defined as Application IDs. The column 2202 describes control information of the Java programs. Control information includes “autostart”, “present”, “kill” and the like; “autostart” means that the Java program is automatically executed by the terminal device 1300 immediately, “present” means not performing automatic execution, and “kill” means stopping the Java program. The column 2203 describes DSM-CC identifiers for extracting PIDs including a Java program according to the DSM-CC scheme. A column 2204 describes the program names of the Java programs. A column 2205 describes service_bound_flag. When the flag is 1, it means that the Java program is surely terminated when another service is selected. When the flag is 0, it means that the Java program is continuously executed without being terminated in the case where another service is selected and the selected service also includes an AIT describing the Java program. However, even in the case of 0, the control information of the Java program is prioritized in the newly-selected service. In addition, in the case of 0, when the newly-selected service is not recorded, the current Java program is being continuously executed.

It is to be noted that the Java program may be terminated in this case. Lines 2211, 2212, 2213, and 2214 are a set of information of the Java program. The Java program defined in the line 2211 is a set of a Java program identifier “0x3221”, control information “autostart,” a DSMCC identifier “1”, and a program name “a/TopXlet”. Similarly, the Java program defined in the line 2212 is a set of a Java program identifier “0x3222,” control information “present,” a DSMCC identifier “1,” and a program name “b/GameXlet”. Here, the three Java programs defined by the line 2211, the line 2212, and the line 2214 have the same DSMCC identifier. This indicates that the three Java programs are included in one file system encoded according to the same DSMCC scheme. Here, only four items of information are prescribed for the respective Java programs, but more items of information are defined in reality. For details, see the DVB-MHP Standards.

The application state management unit 2401 analyzes the updated AIT contents to be outputted from the AIT monitoring unit 2402, and manages the execution state of the Java program, based on the details of the AIT.

First, the application state management unit 2401 finds out a Java program whose control information is “autostart” from among the AITs, and extracts the corresponding DSMCC identifier and Java program name. With reference to FIG. 22A, the AM 1704b extracts the Java program from the line 2211 and obtains the DSMCC identifier of “1” and the Java program name of “a/TopXlet”. Next, the application state management unit 2401 accesses the DSMCC 1704d by using the DSMCC identifier obtained from the AIT so as to obtain a file of the Java program stored in the DSMCC file system. The file is recorded in the first memory unit 1308 or the second memory unit 1307. Fetching data such as the file system from the TS packet in the MPEG-2 transport stream and saving the data into a storage means such as the first memory unit 1308 and the second memory unit 1307 is hereafter referred to as downloading.

FIG. 22B shows an example of a downloaded file system. In the diagram, a circle represents a directory and a square represents a file. 2231 denotes a root directory, 2232 denotes a directory “a”, 2233 denotes a directory “b”, 2234 denotes a file “TopXlet.class”, 2235 denotes a file “GameXlet.class”, 2236 denotes a directory “z”, 2237 denotes a file “MusicXlet.class”, and 2238 denotes a file “StudyXlet.class”.

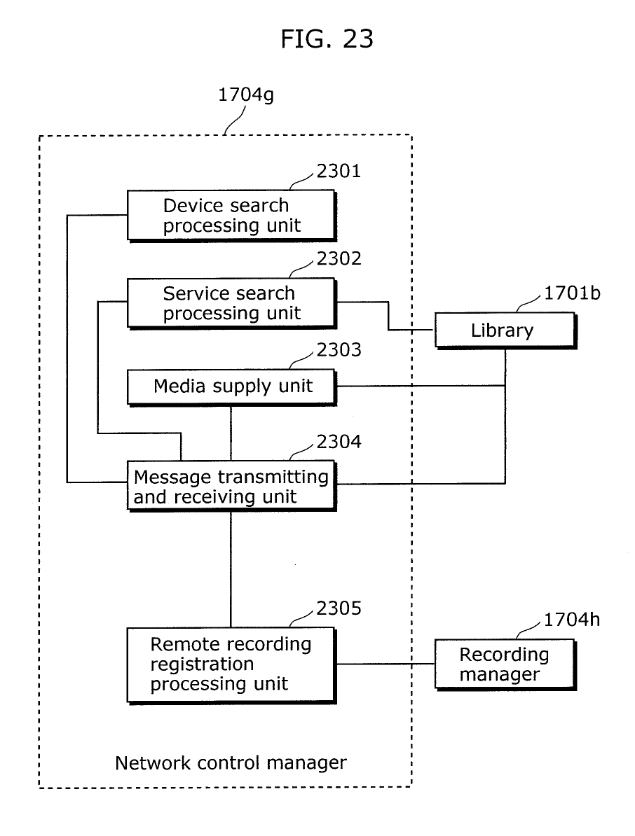

Next, from among the file systems downloaded in the first memory unit 1308, the application state management unit 2401 passes the Java program to be executed to the Java VM 1703. Here, assuming that the name of the Java program to be executed is “a/TopXlet,” and the file “a/TopXlet.class”, assigned with “.class” at the end of the Java program name, is the file to be executed. “/” is a delimiter between directories or between file names, and the file 2304 is the Java program which should be executed with reference to FIG. 23. The file is executed on the Java VM as the Java program.

Every time an AIT which has a new AIT version is outputted from the AIT monitoring unit 2402, the application state management unit 2401 analyzes the AIT and changes the execution state of the Java program.

The JMF 1704a performs reproduction control of video and audio included in the service. More specifically, it causes the AV decoder to input specific video ESs and audio ESs from an MPEG-2 transport stream outputted from the TS decoder at the time when the service is reproduced.

The JMF 1704a receives an input of a channel identifier to be reproduced. First, the JMF 1704a searches for the channel information of the library 1701b by using the specified channel identifier as a key, and obtains a program number. Next, it obtains a PAT from the MPEG-2 transport stream by using the SF 1704e and the like. Further, from the information of a PMT, it obtains PIDs corresponding to the obtained program numbers in the PMT. It obtains an actual PMT by using the SF 1704e again. The obtained PMT has a format of FIG. 11 which describes the PIDs of elementary streams each of which has a stream type of “video” or “audio”. When the JMF 1704a sets these PIDs to the PID filter 1502 of the TS decoder 1302 through the library 1701b, the video ESs and audio ESs multiplexed with the PIDs are decoded by the AV decoder 1303 as shown in FIG. 15 or FIG. 16. The decoded audio and video are reproduced through the speaker 1304 and the display 1305.

In addition, here, descriptions are given of an abstract service defined in the OCAP and OCAP-DVR environments. The abstract service is a service which does not include video and audio, but includes a Java program only. Information of such abstract service is described in a special AIT which is transmitted through the aforementioned OOB. This AIT is called XAIT in the OCAP Specifications. When the power source is turned on, the terminal obtains an XAIT through the OOB by using the SF 1704e, obtains the information about the abstract service, and activates the Java program contained in the abstract service. In the present invention, the Java program which describes information in an XAIT is called “privileged program”. It is to be noted that the privileged program is also called monitor application in the OCAP Specifications. A recording manager 1704h has a function of recording an MPEG-2 transport stream containing a specified service in the second memory unit. FIG. 24 shows the internal structure of the recording manager 1704h. The recording manager 1704h includes a recording and registering unit 2403, a recording control unit 2404, and a recording device setting unit 2411. Specifications made for recording include: a specification by a user who uses a recording device with an input unit 1310; a specification by a Java application program which is executed in a recording device with a Java API; a specification from a program described in non-Java language; and a specification from outside the terminal by using the network control unit 1312.

The recording and registering unit 2403 receives inputs of a channel identifier, a starting time, and an ending time, and records, in the second memory unit 1307, the service contents exactly corresponding to the period from the starting time to the ending time. Here, input information including the channel identifier, the starting time, and the ending time is called recording reservation. The recording and registering unit 2403 has record (int source_id, Time start, Time end) as a Java API for performing recording reservation. Here, source_id specifies a channel identifier, start specifies a recording starting time, and end specifies a recording ending time. In addition, the recording and registering unit 2403 receives a recording and registering request from a non-Java language program. For example, such channel identifier, starting time, and ending time can be specified through the EPG 1702. In addition, the recording and registering unit 2403 receives recording registration from outside the terminal with the network control unit 1312. For example, it is possible to perform a recording reservation by specifying a channel identifier, a starting time, and an ending time from a reproducing device connected to a network via the network. When such recording registration is made, the recording and registering unit 2403 holds recording reservation information and waits until time preceding the recording starting time by a certain time is reached. FIG. AAA shows an example of recording reservation information held by the recording manager. When the time preceding the recording starting time by the certain time is reached, the recording and registering unit 2403 requests the recording device setting unit 2411 to secure devices to be used for the recording. Subsequently, it requests the recording control unit 2404 to record the service by providing the specified channel identifier, recording starting time and recording ending time. Here, the certain time may be an arbitrary time, but it is desirable that the time is enough to complete the later-described pre-recording processing performed by the recording control unit 2404.

The recording device setting unit 2411 secures, for each of recording reservations, devices to be used for the recording for a time from the recording starting time to the recording ending time. Here, the devices to be used for the recording include the tuner 1704c, the second memory unit 1307, the AV decoder 1303, the TS decoder 1302, and the encryption engine 1315. Such devices are secured according to a device secure request to the device contention resolving manager 1706. Detailed descriptions of this are given later on.

The recording control unit 2404 records the service in the second memory unit by using the preset devices, based on the specified channel identifier, recording starting time and recording ending time. The recording control unit 2404 includes a recording service selecting unit 2408, an encryption key supply unit 2405, an encryption key encrypting unit 2406, and an encrypted encryption key supply unit 2407.

First, the recording service selecting unit 2408 secures, in the second memory unit 1307, a memory area 1504 for recording the MPEG-2 transport stream portion corresponding to the specified period from the starting time to the ending time. The secured memory area is assigned with a media identifier. Next, it obtains tuning information corresponding to the channel identifier from the channel information held by the library 1701b by using the channel identifier as a key. Subsequently, when the tuning information is given to the tuner 1704c, the tuner 1704c starts tuning. Here, the tuning information is the information based on which a frequency, a modulation scheme and the like can be identified.

Next, the recording control unit 2404 obtains, by using the SF 1704e, a PAT from the MPEG-2 transport stream obtained through the tuning. Subsequently, it extracts the PIDs in the PMTs from the PAT, and obtains all the PMTs in the MPEG-2 transport stream by using the SF 1704e. In addition, it searches for the library 1701b for the program number corresponding to the specified channel identifier to find out the corresponding PMTs. It is to be noted that the MPEG Standards allow the versions of PATs and PMTs to be updated. Thus, the recording control unit 2404 always monitors PATs through filtering, re-performs the above operations when the versions of the PATs are updated so as to obtain all the PMTs in the MPEG-2 transport stream and the PMTs of the service to be recorded. With reference to the PMTs, the audio, video, all the PIDs of the section ESs, and table_id which structure the service are set in the PID filter 1502 and the section filter 1503 of the TS decoder.

Next, the recording control unit 2404 requests the encryption key supply unit 2405 to transmit the encryption key necessary for encrypting the MPEG-2 transport stream, and obtains the encryption key.

The encryption key supply unit 2405 may be structured to output an encryption key in response to a request from the recording control unit 2404, and thus various implementations are possible. For example, it may be structured to store a constant encryption key in advance by using a secure memory with a high information secrecy, and to output the encryption key in response to a request from the recording control unit 2404. In addition, it may be structured to generate a new encryption key each time an encryption key is requested for. In this embodiment, it is assumed that the encryption key supply unit 2405 generates a new encryption key each time an encryption key is requested for.

The recording control unit 2404 provides the obtained encryption key to the encryption engine 1313 by using the library 1707b. The encryption engine 1313 then encrypts the MPEG-2 transport stream to be inputted to the encryption engine 1313 by using the provided encryption key, and outputs it.

Next, the recording control unit 2404 inputs the encryption key obtained earlier to the encryption key encrypting unit 2406, encrypts the encryption key itself into an unbreakable cipher.

The encryption key encrypting unit 2406 encrypts the inputted encryption key by using another secret key into an unbreakable cipher. The encryption scheme used at this time is arbitrary. For example, an RSA encryption is available. Such secret key may be provided according to an arbitrary method. For example, it is conceivable that a terminal is structured to hold a constant key. The encryption key encrypting unit 2406 outputs the encrypted encryption key to the recording control unit 2404.

The recording control unit 2404 then records this encrypted encryption key in the second memory unit 1307 in association with the encrypted MPEG-2 transport stream.

Subsequently, the recording control unit 2404 sets, by means of the library 1701b, the destinations of outputs by the respective hardware structural elements so that the service included in a broadcast wave as shown in FIG. 15 is recorded in the second memory unit 1307 after passing through the tuner 1301, the adaptor 1311, the TS decoder 1302, the multiplexer 1314, and the encryption engine 1313. Then, according to the flow described in FIG. 15, all the ESs which structure a desired channel are recorded in the memory area 1504 which has been secured earlier.

It is to be noted that the recording control unit 2404 stops recording of the MPEG-2 transport stream when the input of the MPEG-2 transport stream is stopped. Subsequently, each time the MPEG-2 transport stream is inputted again, it re-obtains an encryption key from the encryption key supply unit 2405, provides the new encryption key to the encryption engine 1313, inputs the encryption key to the encryption key encrypting unit 2406, encrypts the encryption key itself, and records the encrypted encryption key in the second memory unit 1307 in association with the encrypted MPEG-2 transport stream whose recording is started just now. The stoppage or restart of input of the MPEG-2 transport stream can be detected by, for example, the stoppage or restart of inputting the MPEG-2 transport stream to the TS decoder. The recording control unit 2404 always monitors, by using the library 1707b, the states of inputs of the MPEG-2 transport stream to the TS decoder.

Subsequently, the specified recording ending time is reached, the recording control unit 2404 stops the tuning operation of the tuner 1704c, and stops writing of the MPEG-2 transport stream into the memory area 1504.

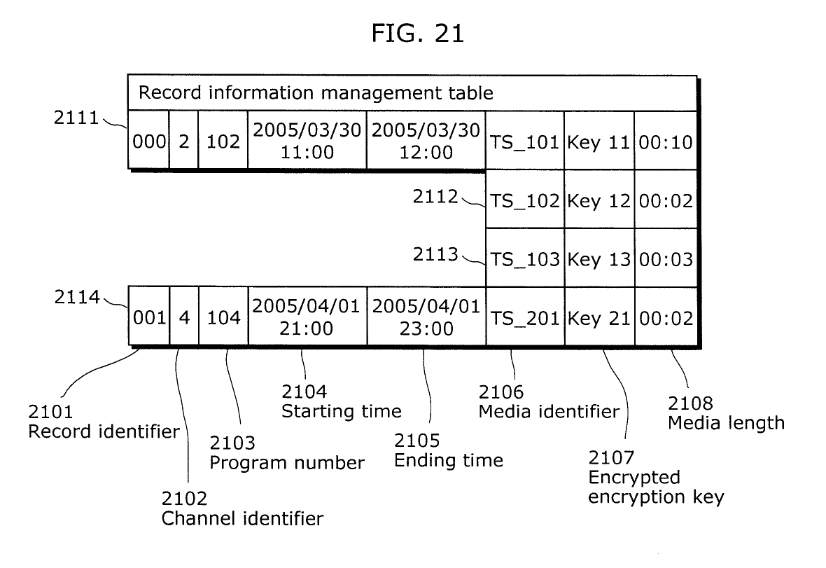

In addition, the recording control unit 2404 generates a record information management table shown in FIG. 21 as management information of the recorded MPEG-2 transport stream. This is described below in detail.

FIG. 21 is an example of a record information management table for managing the record information recorded in the memory area 1504 of the second memory unit 1307 or the like. The record information is recorded in table form. A column 2101 describes record identifiers. A column 2102 describes channel identifiers specified as recording targets. A column 2103 describes the corresponding program numbers. A column 2104 describes the recording starting times of services, and a column 2105 describes the recording ending times of the services. A column 2106 describes media identifiers identifying the MPEG-2 transport stream recorded as a service. A column 2107 is an encrypted encryption key which has been obtained by further encrypting an encryption key used for the encryption of the encrypted MPEG-2 transport stream assigned with media identifier 2106 and then has been outputted by the encryption key encrypting unit 2406. A column 2108 describes media lengths which are time durations corresponding to actual recording time of the media identified by the media identifier 2106.

Each of lines 2111 to 2114 describes a set of a record identifier, a channel identifier, a program number, a starting time, an ending time, and a media identifier. For example, the line 2111 shows that: the record identifier is “000”; the channel identifier is “2”; the program number is “102”; the starting time is “2005/03/30 11:00”; the ending time is “2005/03/30 12:00”; the media identifier is “TS_{—}001”; the encryption key obtained by further encrypting the encryption key used for the encryption of the MPEG-2 transport stream is a key 11; the actual recording time duration of “TS_{—}001” is 00:10 with respect to the reserved recording starting time and ending time.

In the case of the line 2111, the reservation time is an hour from 11:00 to 12:00, but the length of TS_001 is only 00:10. This means that the input of the MPEG-2 transport stream is stopped at the time point when 00:10 elapsed after the recording starting time of the MPEG-2 transport stream. At this time, the recording is stopped once, and the recording of TS_101 is also stopped at the time point. Subsequently, the input of the MPEG-2 transport stream is restarted by the recording ending time of the service, a new encryption key is obtained and the remaining portion of the MPEG-2 transport stream is recorded as another media as described earlier. This is shown in the line 2112. In the case of the line 2112, the MPEG-2 transport stream is recorded as another media “TS_{—}102”, the encryption key obtained by encrypting the encryption key used for the recording is a key 12, and the actual recording time duration of the media is 00:02. In other words, it shows that the recording is restarted once, but the input of the MPEG-2 transport stream is stopped again at the time point when 00:02 elapsed after the restart.

Subsequently, the MPEG-2 transport stream is restarted in the same manner, and “TS_{—}103” is recorded. The encryption key obtained by encrypting the used encryption key is a key 13, and the actual recording time is 00:03.

It is to be noted that all the line 2111, the line 2112, and the line 2113 describe recorded data assigned with an identical channel identifier of 2, and thus the three media TS_101, TS_102, and TS_103 are sequentially reproduced as if they were a single program by specifying the channel identifier 2 at the time of the reproduction. This is described later in detail.

The encrypted encryption key supply unit 2407 provides the Java application with a Java API which supplies an encrypted encryption key recorded in a format shown in FIG. 21 in the second memory unit 1307. For example, it provides a KeySet [ ] getEncryptKey (int source_id) method. Here, what is provided as source_id is a channel identifier of the MPEG-2 transport stream encrypted by using a desired encrypted encryption key. In this method, an array of an instance in a KeySet class is returned as a return value. The KeySet class is a class for representing a set of an encrypted encryption key and a media length. A call of KeySet. getKey ( ) returns the encrypted encryption key. In addition, a call of KeySet. getMediaLength ( ) returns the media length corresponding to the encrypted encryption key. Here, getEncryptionKey (int source_id) returns an array of this KeySet instance. For example, a call of getEncryptKey (2) returns, as a return value, {a KeySet representing a set of a Key 11 and 00:10, a KeySet representing a set of a Key 12 and 00:02, and a KeySet representing a Key 13 and 00:03} with reference to FIG. 21.

The service manager 1704f manages reproduction of services in the MPEG-2 transport stream recorded in the second memory unit 1307, or services in the MPEG-2 transport stream to be inputted from the adaptor 1311.

Descriptions are given below of operations in the case of managing the reproduction of the services in the MPEG-2 transport stream recorded in the second memory unit 1307. This corresponds to the reproduction of recorded services. In this case, the service manager 1704f receives inputs of record identifiers. The recorded services identified based on the record identifiers in the second memory unit 1307 are reproduction targets. The service manager 1704f first secures devices such as the TS decoder 1302 and the display to be used for the reproduction of the recorded services by using the device contention resolving manager 1706.

Subsequently, with reference to a record information management table generated by the recording manager 1704h, the service manager 1704f obtains the channel identifiers to be reproduced based on the specified record identifiers and a sequence of media identifiers generated in the corresponding recording. Then, it directs, through the library 1701b, the TS decoder 1302 to receive outputs of the MPEG-2 transport stream identified by the first media identifier from among the media identifiers obtained just now in the second memory unit 1307. In addition, it sets, through the library 1701b, the destinations of outputs by the respective hardware structural elements so that the outputs flow along paths shown in FIG. 16. Subsequently, it provides the JMF 1704a with the channel identifiers of the data to be reproduced. Then, the JMF 1704a starts the reproduction of the video and audio multiplexed on the MPEG-2 transport stream to be outputted from the second memory unit, by performing the earlier-mentioned operations. Further, it provides the channel identifiers of the data to be reproduced to the AIT monitoring unit 2402 of the AM 1704b. Then, the AM 1704b starts the execution and termination of the Java program multiplexed on the same MPEG-2 transport stream according to the AIT multiplexed in the MPEG-2 transport stream to be outputted from the second memory unit 1307 to the TS decoder 1302. Subsequently, the reproduction of the service is continued to the end of the MPEG-2 transport stream outputted from the second memory unit 1307. When the reproduction of the MPEG-2 transport stream identified by the media identifier is terminated, the reproduction of the MPEG-2 transport stream identified based on the next media identifier is started. Hardware settings and notifications to the JMF 1704a and the AM 1704b have been already completed, and thus it is only necessary to change MPEG-2 transport streams read from the second memory unit 1307. These operations are repeated hereinafter until the reproduction of the MPEG-2 transport stream is terminated for the data identified based on all the media identifiers recorded through the recording of the services of the specified channel identifiers.

On the other hand, the following describes the case of managing the reproduction of services included in the MPEG-2 transport stream to be inputted from the adaptor 1311. This corresponds to reproducing services directly from a broadcast wave. In this case, the service manager 1704f receives inputs of channel identifiers of the services to be reproduced. The service manager 1704f secures devices such as the adaptor 1311, the TS decoder 1302, and the display which are used for the reproduction of broadcast services, by using the device contention resolving manager 1706.

Subsequently, the service manager 1704f directs, through the library 1701b, the TS decoder 1302 to receive outputs of the MPEG-2 transport stream to be outputted from the adaptor 1311 in FIG. 15. In addition, it sets, through the library 1701b, the destinations of outputs by the respective hardware structural elements so that the outputs flow along paths shown in FIG. 16. Subsequently, it provides the JMF 1704a with the channel identifiers of the data to be reproduced. Then, the JMF 1704a starts the reproduction of the video and audio multiplexed on the MPEG-2 transport stream to be outputted from the adaptor 1311, by performing the earlier-mentioned operations. Further, it provides the channel identifiers of the data to be reproduced to the AM 1704b. Then, the AM 1704b starts the execution and termination of the Java program multiplexed on the MPEG-2 transport stream according to the AIT multiplexed in the MPEG-2 transport stream to be outputted from the adaptor 1311.

The network control manager 1704g has a function of responding to messages coming from outside the terminal via the network. FIG. 23 shows the structure of the network control manager 1704g. The network control manager 1704g includes a device search processing unit 2301, a service search processing unit 2302, a media supply unit 2303, and a message transmitting and receiving unit 2304.

The message transmitting and receiving unit 2304 receives a message coming from outside the terminal via the network, and issues a processing request to the device search processing unit 2301, the service search processing unit 2302, the media supply unit 2303, or the remote recording registration processing unit 2305 according to the message. The network control unit 1312 mounted by each of the terminal receives a signal modulated in compliant with the MOCA Specifications, demodulates the signal, and extracts the sequence of IP packets. These IP packets are passed to the network protocols held by the library 1701b. It is to be noted that FIG. 23 does not show the network protocols held by the library 1701b. The network protocols expand the extracted sequence of IP packets in compliant with the TCP/IP protocols, and extract TCP packets. The protocols further expand the TCP packets in compliant with the HTTP protocol Specifications, and extract the HTTP messages. Meanwhile, at the time of transmission, the message transmitting and receiving unit 2304 packetizes the messages into IP packets in compliant with the HTTP/TCP/IP protocols by using the library, and then the network control unit 1312 modulates them in compliant with the MOCA Specifications, and transmits them to the devices as the transmission destinations.

In this embodiment, the DLNA Specifications are used for the inter-terminal communication via the network. The DLNA is an abbreviation of Digital Living Network Alliance, and is common specifications for allowing household appliances connected to each other via a network to control each other. In the DLNA, UPnP Specifications are used for checking the devices on the network and obtaining services. The UPnP is an abbreviation of Universal Plug and Play, and is common specifications for controlling the devices connected to each other via the network. In the DLNA and UPnP, the HTTP protocol is used for exchanging messages via the network. Thus, commands defined in the DLNA and UPnP are packed with the HTTP messages according to the prescriptions of the DLNA and UPnP, and the packages are mutually transmitted and received. For details, see the DLNA Specifications and UPnP Specifications.

The message transmitting and receiving unit 2304 transfers a command to one of the device search processing unit 2301, the service search processing unit 2302, the media supply unit 2303, the remote recording registration processing unit 2305, and the device contention resolving processing unit 4104, according to the command included in a received HTTP message. The device search processing unit 2301, the service search processing unit 2302, the media supply unit 2303, the remote recording registration processing unit 2305, and the device contention resolving processing unit 4104 process the command, and the result is returned to the message transmitting and receiving unit 2304. Then, the message transmitting and receiving unit 2304 packs the result with the HTTP message according to the DLNA Specifications and the UPnP Specifications, and transmits the result to the device to which the result should be returned. Here, in this embodiment, the command included in the HTTP message which is received by the message transmitting and receiving unit 2304 describes all or a part of the following: 1) a processing request type; 2) the ID of the terminal which is a message transmission source; 3) the ID of the Java program which is executed on the terminal as the message transmission source and relates to the message; and 4) the priority level valid within the terminal as the message transmission source. It is to be noted that, in this embodiment, the processing request type and the ID of the terminal as the message transmission source are essential. Such processing request type may have any format as long as it is the information based on which the processing request can be identified.

When the media supply unit 2303, the remote recording registration processing unit 2305, the device contention resolving processing unit 4104 and the like transfer the commands to the programs which execute the processing, they pass these description details together with the commands.

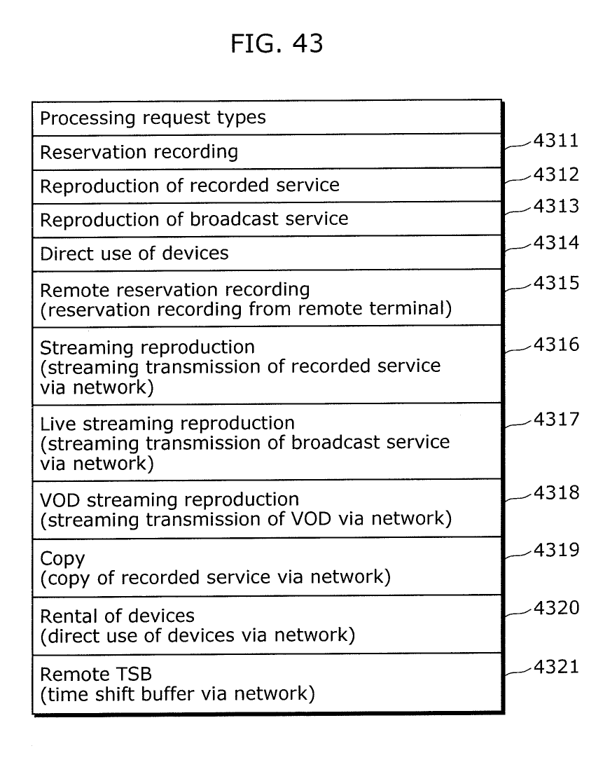

Here, the processing request is the processing request: which is specified by the user directly or by the Java program on the recording device; or which requires devices for reproduction specified from another terminal via the network, for recording, for streaming transmission or the like. FIG. 43 shows an example of the processing request in this embodiment. Detailed descriptions of the processing requests are given in the part where the device contention resolving manager 1706 is described.

Processing requests are roughly classified into processing requests which are specified by the user directly or by the Java program on the recording device, or processing requests which are specified by another terminal via the network. The processing requests handled by the message transmitting and receiving unit 2304 are the processing requests which are specified by another terminal via the network. Further, the requests for processing specified by another terminal via the network are roughly classified into processing implemented by a processing execution program such as the recording manager 1704h and the media supply unit 2303, and a device rental (a direct use of devices via the network).

In the case where the processing request is a device rental, the command included in the HTTP message further includes the name of a specific device desired to be used (such as a tuner, an AV decoder, and a display). In this case, the message transmitting and receiving unit 2304 makes a request for device allocation by transferring the command directly to the device contention resolving processing unit 4104 without passing through the processing execution program. Then, when receiving the result of the device allocation executed by the device contention resolving processing unit 4104, it returns the result to the request-source terminal.

Further, the message transmitting and receiving unit 2304 receives the terminal ID from the state inquiry unit 4201, and is inquired about the state of the terminal with the terminal ID. The definition of the terminal ID is the terminal ID described in the description with reference to FIG. 32. The definitions of the “states” are described in the description of the device contention resolving manager 1706. The message transmitting and receiving unit 2304 packs a “state inquiry request” with the HTTP message, and transmits it to the terminal device with the terminal ID. Here, the format of the “state inquiry request” may be any as long as it can be interpreted by the terminal devices connected via the network. When receiving the HTTP message indicating the response to the state inquiry, the message transmitting and receiving unit 2304 returns the response result to the state inquiry unit 4201.

The device search processing unit 2301 processes a device search command. In the case where a device search command is packed in the received HTTP message, the message transmitting and receiving unit 2304 transfers the command to the device search processing unit 2301. For example, the search command for searching a recording device is transferred to the device search processing unit 2301. Then, the device search processing unit generates a response command indicating that the recording device search processing unit itself is a recording device, and returns it to the message transmitting and receiving unit 2304. The message transmitting and receiving unit 2304 packs the response command with the HTTP message, and returns it to the device which has transmitted the command.

The service search processing unit 2302 processes a recorded service obtainment command for finding out the recording service which is held by the device itself. Thus, in the case where the result obtained by expanding the received HTTP message is a recorded service obtainment command, the message transmitting and receiving unit 2304 transfers the command to the service search processing unit 2302. The service search processing unit 2302 returns, to the message transmitting and receiving unit 2304, a set of the record identifier 2101, the channel identifier 2102, the program number 2103, the starting time 2104, the ending time 2105, and the media length 2108 of the recorded service, by referring to the record information management table in FIG. 21 through the library 1701b. The sets of these items of information are the recorded service information items which are returned to the message transmitting and receiving unit 2304 as a list of the recorded service information items corresponding to the services recorded in the recording device. Specifically, in the case where two services have been recorded, the aforementioned items of information relating to each of the services are returned to the message transmitting and receiving unit 2304. It is to be noted that in the case where a recorded service indicated by a record identifier is divided and recorded in a plurality of media, the sum of the media lengths of all the media corresponding to the record identifier is returned to the message transmitting and receiving unit 2304 as the media length. The message transmitting and receiving unit 2304 packs the information with the HTTP message, and returns it to the device which has transmitted the command.

The media supply unit 2303 has a function of obtaining, from the second memory unit 1307, a part or all of the recorded media which is an encrypted MPEG-2 transport stream which has been requested for by another device, and transmitting it to the request-source device. Thus, the received HTTP message is a command for obtaining a part of the encrypted MPEG-2 transport stream, the message transmitting and receiving unit 2304 transfers the command to the media supply unit 2303. For example, the command is a command for obtaining a portion of the encrypted MPEG-2 transport stream by indicating the record identifier 2101 of a recorded service and the first byte position and the last byte position of the portion desired to be obtained, the message transmitting and receiving unit 2304 transfers the command to the media supply unit 2303. The media supply unit 2303 obtains a media identifier 2106 by using the specified record identifier 2101 as a key, with reference to the record information management table in FIG. 21. The media identifier 2106 is intended for identifying a file in a recorded encrypted MPEG-2 transport stream. The media supply unit 2303 obtains TS packet data corresponding to the range from the first byte position to the last byte position specified by the command in the specified file, by accessing the file through the library 1701b, and returns it to the message transmitting and receiving unit 2304. It is to be noted that in the case where the recorded service identified by a single media identifier 2106 is divided and recorded in a plurality of media, all the files of the encrypted MPEG-2 transport stream identified by the media identifier shown in the media identifier 2106 are combined, and then the first byte position and the last byte position of the combination are identified. Subsequently, the message transmitting and receiving unit 2304 packs, with the HTTP message, a part or all of the byte data of the encrypted MPEG-2 transport stream returned by the media supply unit 2303, and returns it to the device which is the command transmission source. The media supply unit 2303 further has a function for transmitting a broadcast service which is received by the recording device and a VOD service to the request source device according to the request from another device. Thus, in the case where the received HTTP message includes a command for obtaining a broadcast service or a VOD service, the message transmitting and receiving unit 2304 transfers the command to the media supply unit 2303. The media supply unit 2303 obtains, from the broadcast wave, the specified broadcast service or the MPEG-2 transport stream of the VOD service in the same manner as performed by the service manager 1704h. Subsequently, the message transmitting and receiving unit 2304 packs, with the HTTP message, the byte data of the MPEG-2 transport stream returned by the media supply unit 2303, and returns it to the command transmission source device.

The remote recording registration processing unit 2305 has a function for registering, in the recording manager 1704h, recording reservation information including a channel identifier, a recording starting time, and a recording ending time. Thus, in the case where the received HTTP message is a command for directing remote reservation recording, the message transmitting and receiving unit 2304 transfers the command to the remote recording registration processing unit 2305. Then, the remote recording registration processing unit 2305 performs recording reservation by inputting the command in the recording manager 1704h, and obtains the identifier identifying the recording reservation. Then, it returns the identifier identifying the recording reservation to the message transmitting and receiving unit 2304. Subsequently, the message transmitting and receiving unit 2304 packs, with the HTTP message, the identifier identifying the recording reservation returned by the remote recording registration processing unit 2305, and returns it to the command transmission source device.

The EPG 1702 is an abbreviation of Electric Program Guide which is a function for allowing a user to select a program to be recorded or reproduced. Normal reception and reproduction of a broadcast wave are not within the scope of the present invention, and thus descriptions are omitted.

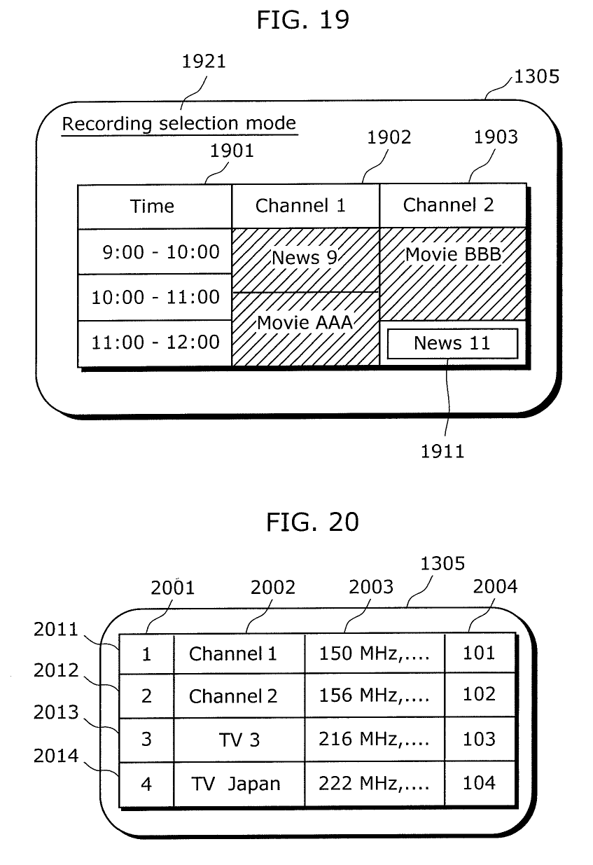

In the case where a program is recorded, the EPG 1702 displays a list of broadcast programs for allowing the user to select a desired program. FIG. 19 is an example of screen display for allowing the selection of the program to be recorded. The list shows a time 1901 and channels 1902 and 1903 displayed in a matrix, and the programs of the respective channels recordable at the time. The user can move a focus 1911 on the display screen by using the up, down, left, and right cursor buttons 1401 to 1404 provided on an input unit 1310 of a terminal device 1300. Further, when an OK button 1405 is pressed, the program which is currently being focused is selected as a recording target. The EPG 1702 has obtained the channel identifier of the program from the library and thus has known it. When the program to be recorded is selected by the user, the EPG 1702 notifies the recording registration unit 2403 of the recording manager 1704h of the channel identifier, the starting time, and the ending time of the program.

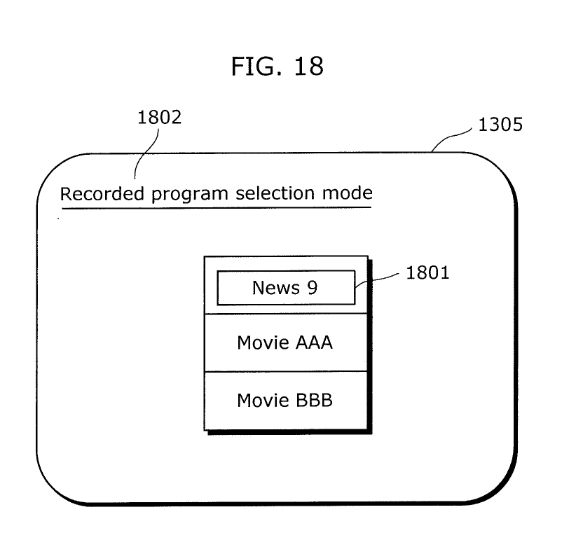

On the other hand, when a recorded program is reproduced, the EPG 1702 displays a list of recorded programs for allowing the user to select a desired program. FIG. 18 is an example of screen display for allowing the selection of the program to be recorded. At this time point, all the programs recorded in the second memory unit 1307 are displayed in the list. The user can move a focus 1801 on the display screen by using the up and down cursor buttons 1401 and 1402 provided on the input unit 1310 of the terminal device 1300. Further, when the OK button 1405 is pressed, the program which is currently being focused is selected as a reproduction target. The EPG 1702 has obtained the record identifier of the program from the recording manager 1704h and thus has known it. When the program to be reproduced is selected by the user, the EPG 1702 notifies the service manager 1704f of the record identifier of the program. The service manager 1704f reads the program from the second memory unit 1307 based on the information and reproduces it.

Next, descriptions are given of device contention before descriptions of functions of the device contention resolving manager 1706. Here, such devices include the tuner 1301, the AV decoder 1303, and the network band controlled by the network control unit 1312.

The following describe device contention and a contention resolving approach taken in the case where such device contention occurs.

For example, in the case where a terminal includes only a single tuner 1301 for receiving In-band, it is impossible to achieve the simultaneous execution of “reproducing processing video and audio included in an MPEG-2 transport stream received from broadcast” executed by the service manager and “recording of a program included in the MPEG-2 transport stream received from broadcast” executed by the recording manager. Thus, it is necessary to determine the processing for which the tuner for receiving In-band 1301 is used. Such “state where a plurality of processing requests cannot be executed in parallel because the absolute number of devices is less than required” is called “device contention”. Further, “from among the plurality of processing requests, determining a processing request to which a device use right is assigned” is called “resolving device contention”.

Detailed descriptions are given of a device contention resolving procedure defined in OCAP hereinafter.

In the OCAP Specifications, the types of a plurality of devices which may content with each other are specified in advance. One of the devices is the tuner for receiving In-band 1301. Further, devices which are not defined in the OCAP Specifications but may content with each other include the AV decoder 1303, the network band controlled by the network control unit 1312, and the second memory area. In the present invention, the devices defined in OCAP and the other devices which may contend with each other are called “exclusive devices”. In addition, a Java library which operates such exclusive devices is called “exclusive device operating library”. As for the tuner 1301 for receiving In-band corresponds to the tuner 1704c.

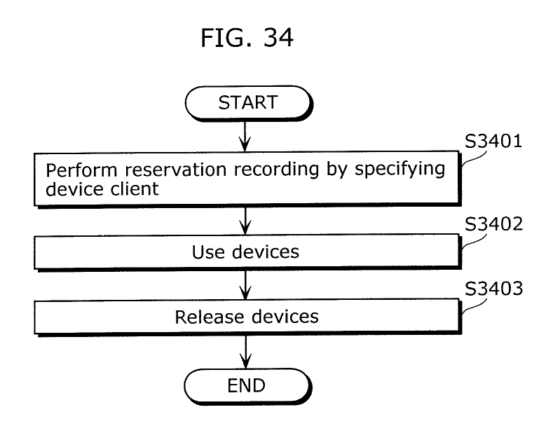

FIG. 34 is a sequence diagram which represents the exclusive device use procedure defined in the OCAP Specifications. All the Java programs which use exclusive devices are required to perform this sequence. First, in S3401, exclusive devices are secured. At this time, Java objects called device clients are registered for the exclusive devices. When the exclusive devices are successfully secured, a desired function is executed by using the exclusive devices in S3402. When the desired processing is completed, a transition to S3403 is made, and the Java program releases the exclusive devices. If an attempt to use the function is made without securing such exclusive devices and without performing the sequence in FIG. 34, an error notification is made to the Java program. As an example, in the tuner 1704c, reserve, tune, and release methods in the NetworkInterfaceController class correspond to secure, use, and release, respectively.

The exclusive device operating library manages a securing state of the exclusive devices by using an exclusive device management table. For example, FIG. 35 is a management table of tuners for receiving In-band which the tuner 1704c manages in the first memory unit 1308 or the second memory unit 1307. A column 3511 describes identifiers identifying tuners for receiving In-band. In this example, descriptions are given of the case where there are three tuners 1, 2 and 3 as the tuners for receiving In-band which are exclusive devices. A column 3512 describes the identifiers of the Java programs which use the tuners 1301 for receiving In-band. A lo column 3513 describes device clients registered at the time when the exclusive devices are secured. In addition, the lines 3501 to 3503 describe information about tuners for receiving In-band. In FIG. 35, the tuner 1 which is one of the tuners for receiving In-band 1301 is secured by a program A, and a client C is registered as a device client. In addition, the tuner 2 is secured by a program B, and a client D is registered as a device client. In addition, the tuner 3 is not secured by any program.

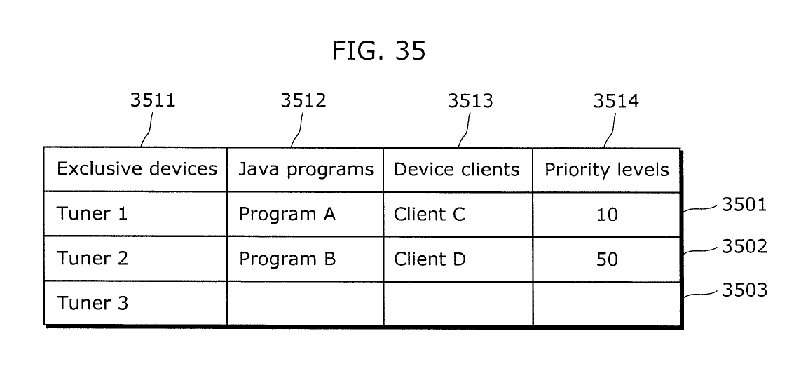

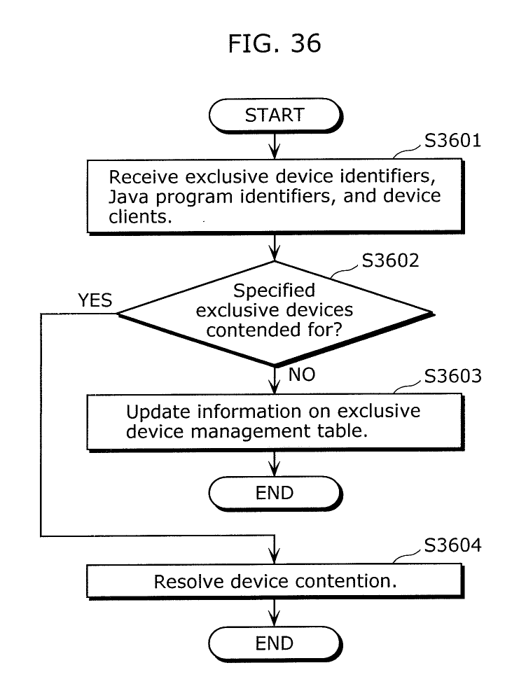

FIG. 36 is a sequence diagram which represents operations of the Java program performed through an API for securing exclusive devices. First, the following are received in S3601: the identifiers of the exclusive devices specified by the Java program, the identifier of the Java program, and the device client. In S3602, it is checked whether the specified exclusive devices have been already secured by another Java program, with reference to the exclusive device management table. In the case where they have not been secured yet, that is No, a transition to S3603 is made, and the Java program identifier and the device client which have been received in S3601 are set in the exclusive device management table. In the case where they have been secured, that is Yes, a transition to S3604 is made, and the device contention is resolved. Resolving such device contention is described later on.

The exclusive device operating library resolves the contention of the exclusive devices in S3604 according to the device contention resolving algorism prescribed by the OCAP Specifications. There are two types of device contention resolving algorisms when roughly classified for distinction, one of them is called a device contention resolving algorism 1, and the other is called a device contention resolving algorism 2.

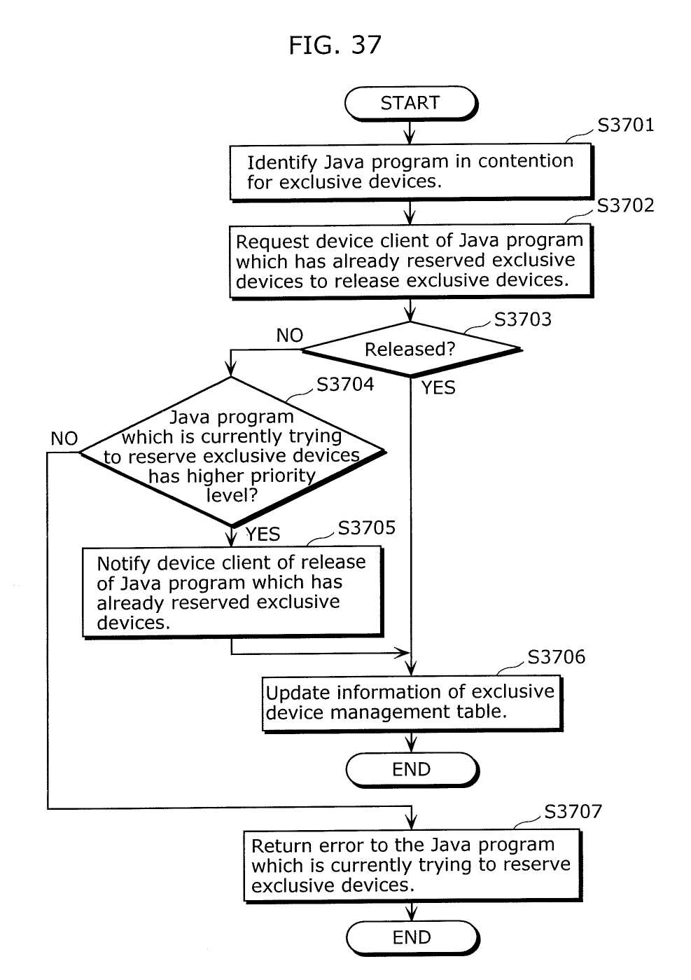

FIG. 37 is a sequence diagram which shows the operation procedure in the device contention algorism 1. In S3701, the Java program which have already secured the exclusive devices and the device client are obtained. Next, in S3702, the device client obtained in S3701 is requested to release the exclusive devices. The device client requested to release the exclusive devices judges whether or not the exclusive devices are released, and returns the result to the exclusive device operating library. In the case where a transition to S3703 is made, the answer from the device client is evaluated and then an agreement is made for the releasing, that is Yes, a transition to S3706 is made, the details of the exclusive device management table is modified by using the identifier of the Java program which is currently trying to secure the exclusive devices and the device client so as to terminate this processing procedure.

In the case where such agreement for the releasing is not made, that is No, a transition to S3704 is made, the priority level of the Java program which has already secured the exclusive devices and the priority level of the Java program which is currently trying to secure the exclusive devices are obtained from the AM 1605b, and then compared with each other. In the case where the priority level of the Java program which is currently trying to secure the exclusive devices is higher, that is Yes, a transition is made to S3705 in which a forced release notification is made to the device client of the Java program which have secured the exclusive devices, and a transition is made to S3706 in which the details of the exclusive device management table are modified by using the identifier of the Java program which is currently trying to secure the exclusive devices and the device client so as to terminate this processing procedure. In a branch S3704, in the case where the priority level of the Java program which has already secured the exclusive devices is equal to or higher than the other one, an error is notified to the Java program which is currently trying to secure the exclusive devices so as to terminate this processing (S3707).

As shown in FIG. 37, the device contention resolving algorism 1 resolves the device contention based on the priority levels of the Java programs described in an AIT or an XAIT. In the case of using the device contention resolving algorism 1, the program with the higher priority level always obtains an advantageous result.

On the other hand, in the device contention resolving algorism 2, the privileged program resolves the device contention. In this case, devices are allocated to each Java program under conditions and in the order which are preferred by the privileged program regardless of the priority levels of the Java programs. In the device contention resolving algorism 2, the privileged program resolves the device contention in a desired manner according to the two types of methods. One of these is a “Java program filter” for selecting a Java program with a right to secure the exclusive devices. For example, the privileged program can prevent an undesirable Java program from securing the tuner 1301 for receiving In-band by using such Java program filter. The other one is a “device contention resolving handler” which determines the priority order of the Java programs which have been allowed, by the Java program filter, to secure the exclusive devices. The device contention resolving handler is intended for determining the prioritized program, for example, in the case where a contention is made to secure the tuner for receiving In-band 1301 between the Java program 1 judged by the Java program filter as having a right to secure the tuner for receiving In-band 1301 and the Java program 2. The device contention resolving algorism 2 is used when one or both of the Java program filter and the device contention resolving handler is/are registered in the exclusive device operating library.

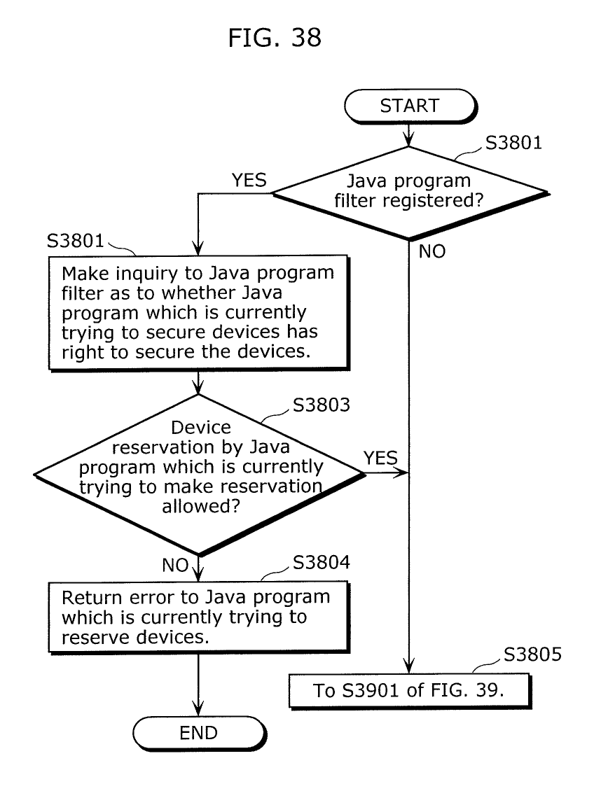

FIG. 38 to FIG. 40 are sequence diagrams each of which represents the operation procedure in the device contention resolving algorism 2.

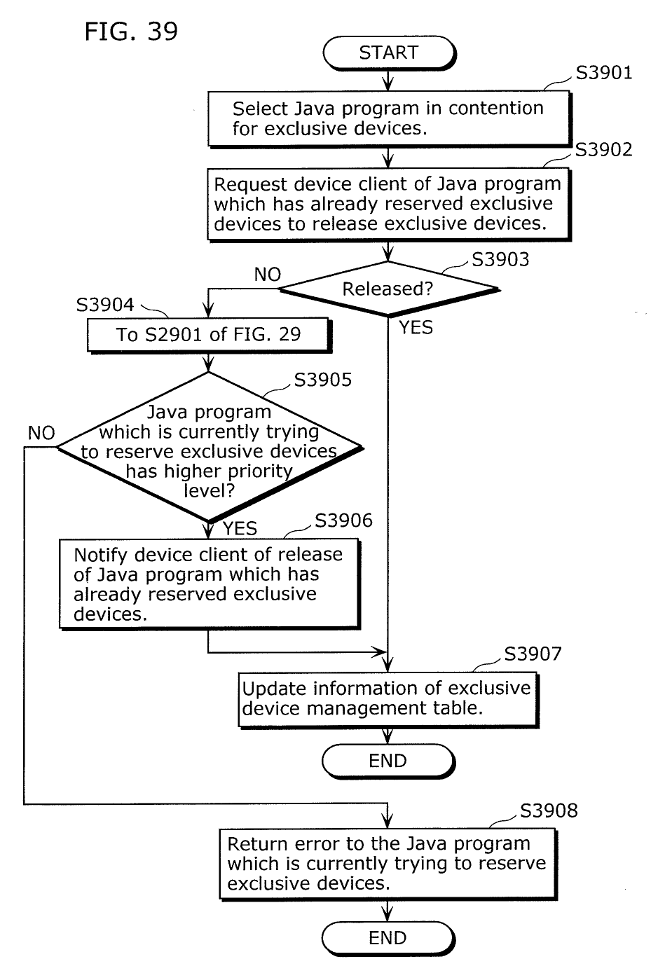

FIG. 38 which is the first diagram representing the device contention resolving algorism 2 is a sequence diagram which represents the operation procedure relating to the Java program filter. In S3801, it is checked whether the Java program filter has already been registered in the exclusive device operating library. When it has not been registered yet, that is No, a transition is made to S3805 at which a connection to the sequence in FIG. 39 starting with S3901 is made. When it has been registered, that is Yes, a transition is made to S3802 in which whether or not the Java program which is currently trying to secure the exclusive devices has the right to secure the exclusive devices is inquired to the Java program filter, and the Java program filter returns the judgment result to the exclusive device operating library. Next, a transition is made to S3803. In the case where the Java program has the right to secure the exclusive devices, that is Yes, a transition is made to S3805 at which a connection to the sequence in FIG. 39 starting with S3901 is made. In the case where the Java program does not have the right, that is No, a transition to S3804 is made. An error is returned to the Java program which is currently trying to reserve the devices so as to terminate the processing procedure.

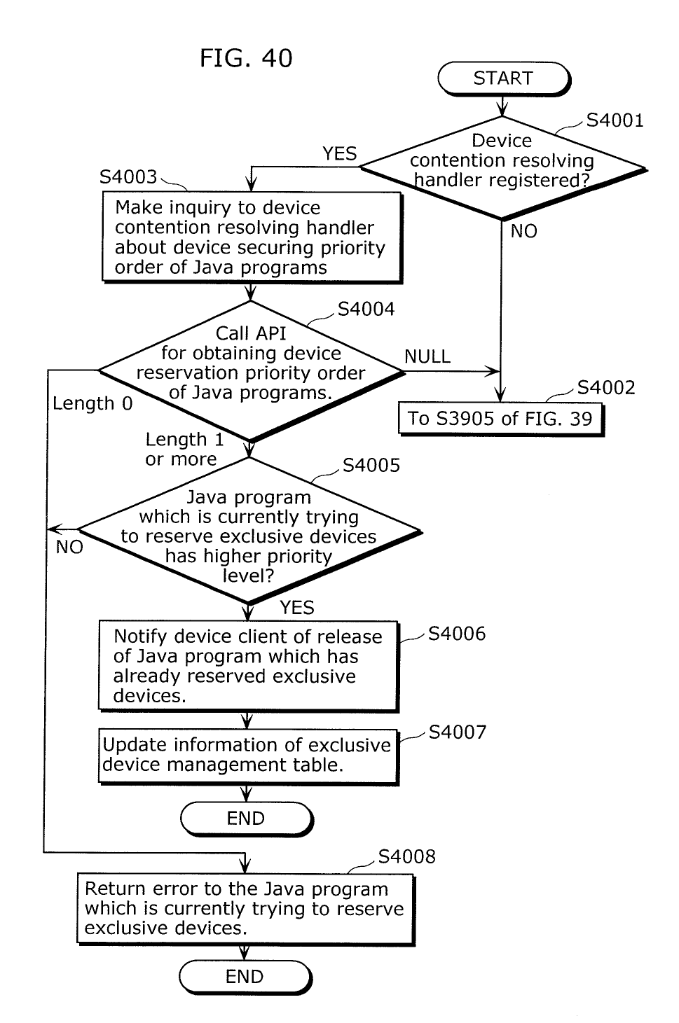

FIG. 39 which is the second diagram representing the device contention resolving algorism 2 is a sequence diagram which represents the operation procedure for judging priority levels based on the intrinsic priority levels of the Java programs. The sequence diagram is the same as FIG. 37 which describes the device contention resolving algorism 1 except for a point, and thus detailed descriptions are omitted. The different point is that a connection to the sequence diagram represented in FIG. 40 is made at S3905 before the device contention is resolved based on the priority levels of the Java programs.

FIG. 40 which is the third diagram representing the device contention resolving algorism 2 represents resolving the device contention by the device contention resolving handler registered by the privileged program. First, in S4001, it is checked whether the device contention resolving handler has been registered, and in the case where it has not been registered yet, that is No, a transition to S4002 is made. S4002 is connected to S3905 in FIG. 39, and a transition is made to the device contention resolving processing performed based on the priority levels of the Java programs. In the case where the device contention resolving handler has been registered, that is Yes at a branch S4001, a transition is made to S4003. In S4003, the device contention resolving handler is inquired about the priority order of the Java programs. The device contention resolving handler returns the array of the Java program identifiers. The terminal analyzes the array returned through the API, and resolves the exclusive device contention by prioritizing the Java programs in the order of the Java program identifiers included in the array. In S4004, the array returned by the device contention resolving handler is checked. In the case where no array is returned, that is “NULL”, a transition is made to S4002 which is connected to S3905 in FIG. 39, and a transition is made to the device contention resolving processing performed based on the priority levels of the Java programs. In the case where the length of the array is 0, that is “length 0” at a branch S4004, a transition is made to S4008 in which an error is returned to the Java program which is currently trying to secure the devices so as to terminate the processing. In the case where the array length is represented as a positive value, that is “length 1 or more” at the branch S4004, a transition is made to S4005.

In S4005, a judgment is made as to which one of the priority level of the Java program which is currently trying to secure the devices and the priority level of the Java program which has already secured the devices is higher, based on the array obtained in S4003. In the case where the priority level of the Java program which is currently trying to secure the devices is lower, that is No, a transition is made to S4008 in which an error is returned to the Java program so as to terminate the device contention resolving processing. At the branch S4005, in the case where the priority level of the Java program which is currently trying to secure the devices is higher, that is Yes, a transition is made to S4006. In S4006, the device client of the Java program which has already reserved the exclusive devices is obtained from the exclusive device management table, and a forced release of the exclusive devices is notified to the device client. In S4007, the details of the exclusive device management table are renewed by using the identifier of the Java program which is currently trying to secure the exclusive devices and the device client so as to terminate the processing.

According to the device contention resolving algorism 2 represented in FIG. 38 to FIG. 40, the privileged program which has a priority level higher than the Java programs assigned with priority levels can resolve device contention based on a judgment standard unique to the privileged program by using the Java program filter and the device contention resolving handler.

In addition, in the case where the service manager 1604 and the recording manager 1606 use the exclusive devices, a rule of using three processes of secure, use and release must be observed. In this case, device contention is resolved assuming that the following Java programs are trying to secure the exclusive devices: the Java program which has requested the service manager 1604 to reproduce a service, by using the service manager management 1605f; and the Java program which has requested the recording manager 1606 to record a service, by using the recording manager management 1605g.

The above-described device contention resolving algorisms describe device contention resolving procedures used in the OCAP Specifications.

However, the device contention resolving procedures used in the OCAP Specifications are intended to resolve resource contention among plural Java programs each of which is to execute, in a terminal, exclusive devices in the terminal or among plural processing requests from one or more programs. In other words, it is impossible to resolve device contention among the plural Java programs each of which executes, in the terminal or another terminal connected to said terminal via a network or among plural processing requests from one or more programs. This is described in detail below.

The device contention resolving unit defined in the aforementioned OCAP Specifications resolves device contention based on the priority levels (described in an AIT or an XAIT) of the Java programs which have made processing requests according to the device contention resolving algorism 1. However, the valid range of this priority levels is within the terminal which is executed by each of the Java programs, and thus it is impossible to compare the priority levels of the Java programs which are operated separately in different terminals. For example, assuming a case where the priority level of a Java program 1 on a terminal A is 150, the priority level of a Java program 2 on the terminal A is 200, and the priority level of a Java program 3 on a different terminal B is 200. In this case, it can be judged that the priority level of the Java program 2 on the terminal A is higher than that of the Java program 1 on the same terminal. However, it is impossible to judge that the priority level of the Java program 3 on the terminal B is higher than that of the Java program 1 on the other terminal A. Let alone, the Java program 2 on the terminal A and the Java program 3 on the terminal B are the same Java program downloaded on the different terminals. Therefore, it is no use to compare the priority levels of the Java programs downloaded on the different terminals from the first.

Accordingly, the use of the method defined in OCAP does not make it possible to compare the priority levels of the Java programs on a plurality of terminals, and thus it is impossible to resolve device contention between the plurality of terminals.

In addition, the device contention resolving handler has been inquired about the priority levels according to the device contention algorism 2, the identifier of the Java program which has made the processing request in this inquiry is passed to the device contention resolving handler. However, the valid range of the Java program identifier is within the corresponding terminal. Therefore, even if the privileged program which mounts the device contention resolving handler is provided with the identifier of the Java program which is executed on another terminal, it cannot use the identifier as information for determining the priority levels.

The device contention resolving manager 1706 according to the present invention allows a broadcast station side or each of downloaded Java programs to set the priority levels of the terminals in an environment where the terminals connected via a network share the devices on the terminals and perform processing, and further resolves device contention between the terminals based on “dynamical” priority levels determined according to the states of the respective terminals and the requested processing types which change dynamically.

The device contention resolving manager 1706 has a function of determining the allocation of the devices necessary to respond to the respective processing requests.

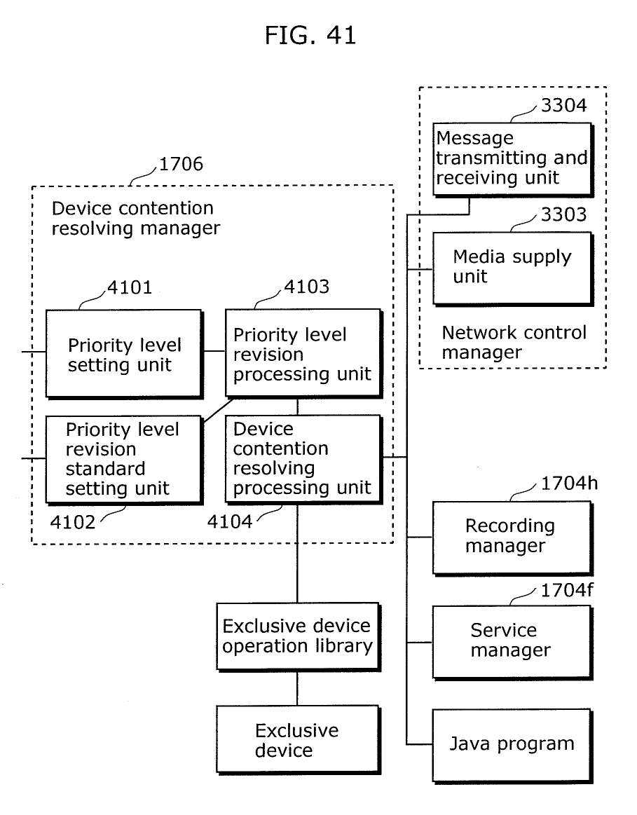

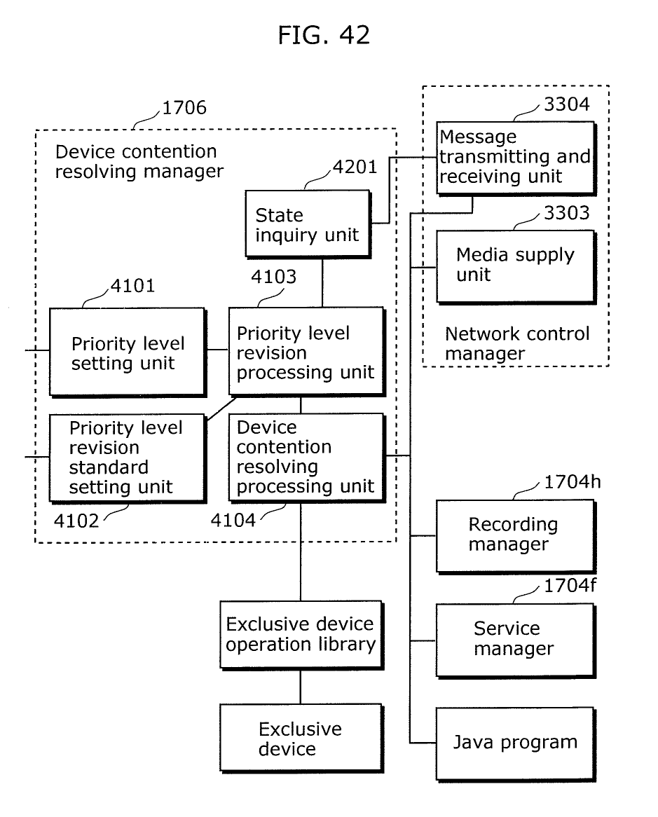

Each of FIG. 41 and FIG. 42 shows an internal structure of the device contention resolving manager 1706. The device contention resolving manager 1706 includes a priority level setting unit 4101, a priority level revision standard setting unit 4102, a priority level revision processing unit 4103, and a device contention resolving processing unit 4104. Further, in the case where the priority level revision processing unit 4103 makes an inquiry, via the network, about the state of the terminal which is the source of the request for device allocation, the device contention resolving manager 1706 includes a state inquiry unit 4201 shown in FIG. 42.

The device allocation is directed by a program which executes the respective processing requests or a program which executes the respective requests on other terminals via the network.

In addition, the priority levels and the priority level revision standards used in the device allocation are set by one of the Java program, the broadcast station via the adaptor 1311, the user through the input unit 1310, and another terminal via the network.

Here, the processing request is the processing request: which is specified by the user directly or by the Java program on the recording device (content recording and transmitting device 3201); and which requires devices for reproduction specified from another terminal via the network, for recording, for streaming transmission, for direct use of the respective devices, or the like. The device allocation to the processing requests is to determine the request source which should be provided with the right to use the devices necessary for the execution of the requested processing.

FIG. 43 shows an example of the processing request in this embodiment. As shown in FIG. 43, specific processing requests include: reservation recording, reproduction of a recorded service, reproduction of a broadcast service, direct use of devices which are the processing requests directed by a user directly or by a Java program on the recording device; and remote reservation recording (reservation recording from a remote terminal such as a content receiving and reproducing device 3202 and a terminal 3203), streaming reproduction (streaming transmission of a recorded service via a network), live streaming reproduction (streaming transmission of a broadcast service via a network), VOD streaming reproduction (streaming transmission of a VOD via a network), copy (copy of a recorded service via a network), rental of devices (direct use of devices via a network) which are the processing requests directed via the network. It is to be noted that processing request types are not limited to the above, and thus that the present invention is applicable even when another processing request is made.

The following describe the respective exemplary processing requests shown in FIG. 43.

Reservation recording 4311 is the processing executed by the recording manager 1704h which receives an input of recording reservation information obtained from the user directly or from the Java program on the recording device.

The reproduction of a recorded service 4312 and the reproduction of a broadcast service 4313 are the processing executed by the service manager 1704f.

Direct use of devices 4314 is the processing in which the device contention resolving processing unit 4104 receives inputs of specific device names (tuner, AV decoder, display and the like) specified by the Java program and executes device allocation as directed.

The remote reservation recording (reservation recording from a remote terminal) 4315 is the processing executed by the recording manager 1704h which receives an input of recording reservation information registered via the remote recording registration processing unit 2305 of the network control manager 1704g.

When a time before the recording starting time by a certain time period is reached based on each of the registered recording reservation information items (including reservation recording and remote reservation recording), the recording manager 1704h requests the device contention resolving processing unit 4104 of the device contention resolving manager 1706 to secure the devices to be used for the recording. Such devices include the tuner 1704c, the second memory unit 1307, the AV decoder 1303, the TS decoder 1302, the encryption engine 1315, and the like. In the case where the devices to be used for the recording can be secured, the recording device setting unit 2411 sets the secured devices for the recording reservation. The recording control unit 2404 starts the recording in the case where such devices are set for the recording reservation.

The streaming reproduction (streaming transmission of a recorded service via a network) 4316 is executed by the media supply unit 2303 which receives an input of a command included in an HTTP message received through the message transmitting and receiving unit 2304 of the network control manager 1704g.

The live streaming reproduction (streaming transmission of a broadcast service via a network) 4317 is processing executed by the media supply unit 2303 which receives an input of a command included in an HTTP message received through the message transmitting and receiving unit 2304 of the network control manager 1704g.

The VOD streaming reproduction (streaming transmission of a VOD via a network) 4318 is processing executed by the media supply unit 2303 which receives an input of a command included in an HTTP message received through the message transmitting and receiving unit 2304 of the network control manager 1704g.

The copy (copy of a recorded service via a network) 4319 is processing executed by the media supply unit 2303 which receives an input of a command included in an HTTP message received through the message transmitting and receiving unit 2304 of the network control manager 1704g.

The rental of devices (direct use of devices via a network) 4320 is processing in which the device contention resolving processing unit 4104 receives an input of a command included in an HTTP message received through the message transmitting and receiving unit 2304 of the network control manager 1704g and executes device allocation as directed. In this case, the command includes the specific names of the device desired to be used (the names include tuner, AV decoder, and display).

Here, the device allocation in the case where direct use of devices or rental of devices (direct use of devices via a network) are requested for is to determine the request-source terminal (another terminal through a Java program or a network) which should be provided with the right to use specific devices such as the tuner, AV decoder, and display.

Specific examples of direct use of devices include an example where a current Java program uses a display device in order to display a UI (User Interface) on a sub-display screen on a terminal with two display screens.

In addition, examples of rental of devices (direct use of devices via a network) include an example where a first terminal allows a second terminal connected via the network to use the tuner of the first terminal in the case where the number of tuner devices of the second terminal is less than required

The remote TSB (time shift buffer via a network) 4321 is time shift buffer processing executed in response to an input of a command included in an HTTP message received through the message transmitting and receiving unit 2304 of the network control manager 1704g. The time shift buffer processing is, for example, time shift buffer processing in compliant with the OCAP-DVR Specification prescription. For details, see the OCAP-DVR Specifications.

The respective processing requests have been described above.

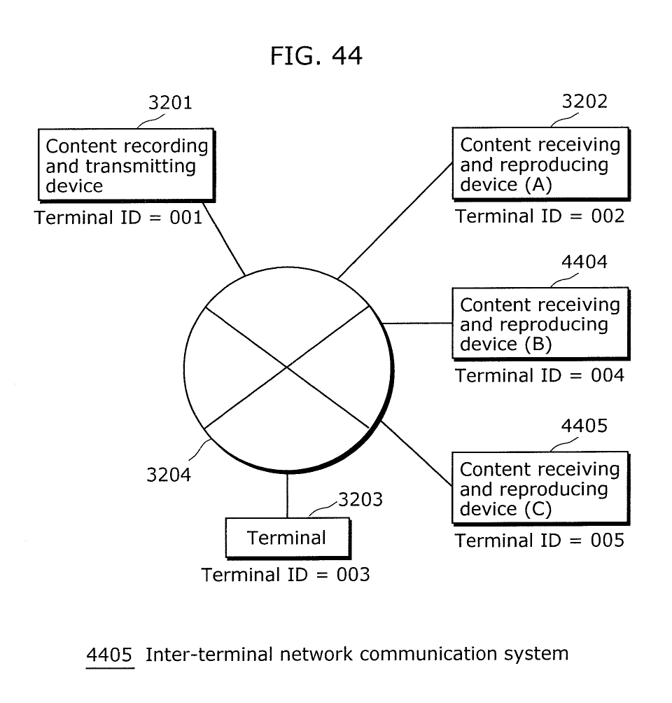

Here, descriptions are given of the internal structure of the device contention resolving manager 1706 shown in FIG. 41 and FIG. 42 taking an example of the inter-terminal network communication system 4405 shown in FIG. 44.

Five terminals connected via a network 3204 are connected in the inter-terminal network communication system 4405, and each of the terminals has a terminal ID. In this embodiment, a recording device corresponds to the content recording and transmitting device (content processing device) 3201, and thus the device contention resolving manager 1706 is mounted on the content recording and transmitting device 3201.

In the descriptions of the device contention resolving manager 1706 given below, it is assumed that the content recording and transmitting device 3201 has two tuners, and the respective tuners are called “tuner A” and “tuner B”. In addition, it is assumed that the network band can simultaneously transmit two streams at the most, and the respective bands are called “network band A” and “network band B”.

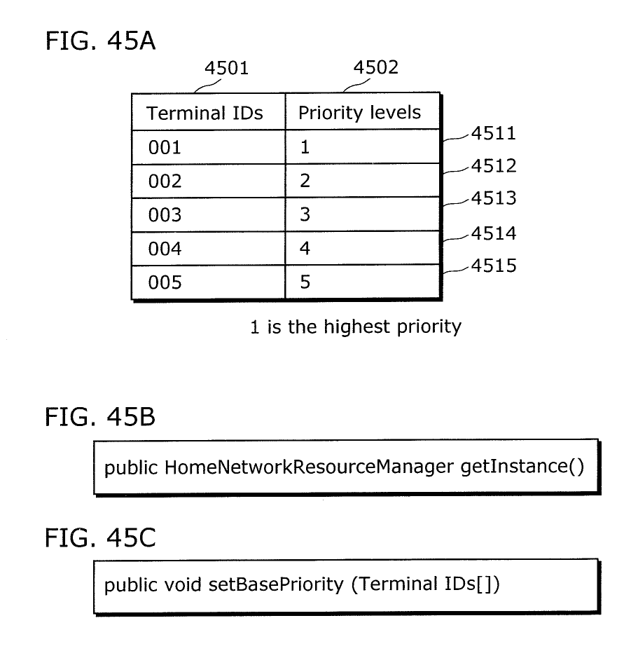

The priority level setting unit 4101 receives priority level settings of the terminals connected via the network 3204. The priority levels are set by the Java program, the input unit 1310, or the broadcast station side system 101 through the adaptor 1311. FIG. 45A shows the priority levels of the respective terminals set by the priority level setting unit 4101.

In this embodiment, the highest priority level value handled by the device contention resolving manager 1706 is “1”, and the priority levels become lower as the values increase.

In other words, the priority level setting unit 4101 in this embodiment includes a priority level holding unit which holds base priority level data (the table shown in FIG. 45A) indicating, as base priority levels, the priority levels in the use of devices of the respective terminals (requesting devices). The priority level setting unit 4101 determines the base priority levels of the respective terminals in advance in order to hold the base priority level data, and stores, in the priority level holding unit, the base priority level data indicating the determined base priority levels. Otherwise, the priority level setting unit 4101 receives the base priority level of each of the terminals in advance from another device or an application program (Java program) in order to hold the base priority level data, and stores, in the priority level holding unit, the base priority level data indicating the received base priority levels.

The priority levels handled by the device contention resolving manager 1706 are different from the priority levels of the Java programs described in an AIT and an XAIT. (For information, it is defined that the priority levels become higher as the priority level values of the Java programs described in the AIT and the XAIT increase.) In this embodiment, it is defined that the highest priority level value handled by the device contention resolving manager 1706 is “1”, and that the priority level values become lower as the values increase. However, it is to be noted that the present invention is applicable even when the priority level values are defined differently as long as their priority levels can be compared with each other.

FIGS. 45B and 45C are examples of an API which the device contention resolving manager 1706 provides to a Java program. “HomeNetworkResourceManager” is an object of the Java which represents the device contention resolving manager. The Java program can use the functions provided by the device contention resolving manager by obtaining “HomeNetworkResourceManager” by “public HomeNetworkResourceManager getInstance( )” shown in FIG. 45B. Some APIs to be described hereinafter are APIs which the device contention resolving manager 1706 provides to a Java program unless otherwise specified. The Java program sets the priority levels of terminals by “public void setBasePriority (terminal IDs[ ])” shown in FIG. 45C. It is assumed that the terminal which has a terminal ID positioned at the top of an array of terminal IDs used as arguments is assigned with the highest priority level, and that the priority levels to be set become lower as the terminal IDs are positioned later.

Here, the priority levels set by the priority level setting unit 4101 are the base priority levels of the respective terminals, and not the values to be directly used at the time when device contention is resolved. At the time when the device contention is resolved, the priority levels revised by a priority level revision processing unit 4104 to be described later are used for resolving the device contention.

The priority level revision standard setting unit 4102 receives settings of priority level revision standards. Such settings of the priority level revision standards are performed by a Java program, through an input unit 1310, or in the broadcast station side system 101 through an adaptor 1311. The priority level revision standard setting unit 4102 receives the settings of the conditions for the revision standards, and the corresponding revision standards.

Here, the conditions for revision standards are the conditions for determining which priority revision standards should be applied when device contention occurs. This embodiment describes two examples where “request types” and “states of request source terminals” are applied as the conditions for revision standards. It is to be noted that the present invention is applicable even when such conditions for revision standards are not limited to the “request types” and “states of request source terminals”.

A priority level revision standard is a standard for specifying how to revise the base priority levels which have been set in the priority level setting unit 4101 at the time when device contention occurs. This embodiment describes an example where “high and low specification revision standards” which include “Highest”, “Lowest”, and “No change” as values is applied as priority level revision standards. It is to be noted that the present invention is applicable even when the priority level revision standards are not limited to such “high and low specification revision standards”.

Here, request types are the types of processing requests described earlier, and the request types which require devices. FIG. 43 shows an example of processing types.

Here, examples of the states of the request source terminals include: the states of the request source terminals at the time when, for example, power off, standby, during viewing of a broadcast service, during VOD streaming viewing; or, in the case where the request-source terminals have already made a processing request with a “device allocation request” via a network, the device allocation state in response to the “device allocation request” (the device allocation state is, for example, that a tuner A is secured in response to a remote reservation recording request, and the recording is being executed by using the tuner A which is currently being secured). It is to be noted that the states of the request-source terminals and the device allocation state are not limited to the aforementioned states.

An example where such “request types” are applied as the condition for revision standards, and such “high and low specification revision standards” are applied as the priority level revision standards is called “revision standards for request types”, hereinafter. On the other hand, an example where such “states of request-source terminal” are applied as the condition for revision standards, and such “high and low specification revision standards” are applied as the priority level revision standards is called “revision standards for the states of request-source terminals”, hereinafter.

In the case of “revision standards for request types”, the priority level revision standard setting unit 4102 receives high and low specification revision standards which include “Highest”, “Lowest”, and “No change” as values for the respective request types.

In the case of “revision standards for the states of request-source terminals”, the priority level revision standard setting unit 4102 receives high and low specification revision standards each of which has “Highest”, “Lowest”, or “No change” as a value for the state of a corresponding request-source terminal.

Descriptions of setting “revision standards for request types” and setting a “revision standards for the states of request-source terminals” are given in sequence below.

First, descriptions are given of the setting of the “revision standards for request types”.

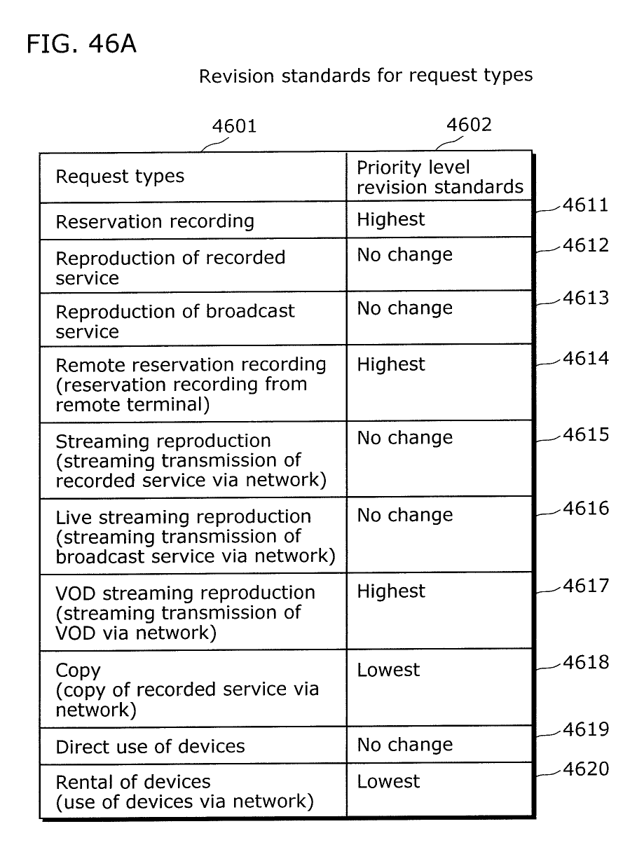

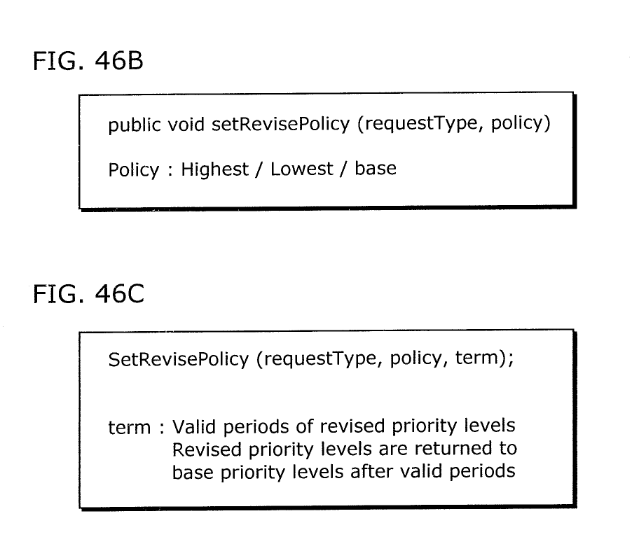

FIG. 46A shows an example of a revision standard for each request type which has been set by the priority level revision standard setting unit 4102. A column 4601 describes “request types”, and a column 4602 describes “high and low specification priority level revision standards”. For example, a line 4617 shows that the priority level revision standard Highest is set for data which has a request type of VOD streaming reproduction.

FIGS. 46B and 46C are examples of an API which the device contention resolving manager 1706 provides to a Java program. The Java program sets priority level revision standards corresponding to the respective request types by “public void setRevisePolicy (requestType, policy)” shown in FIG. 46B. Here, a request type is specified for requestType as an argument, and a priority level revision standard corresponding to the request type is set for policy.

The Java program sets, with a valid period, the priority level revision standards corresponding to the respective request types by “public void setRevisePolicy (requestType, policy, term )” shown in FIG. 46C. Here, a request type is specified for requestType as an argument, and a priority level revision standard corresponding to the request type is set for policy. When priority level revision is made based on the priority level revision standard, a valid period when counted from the revision time point is set to “term”. When the valid period elapses, the revised priority level is returned to the base priority level. Otherwise, as another setting method, a valid period when counted from the time point at which the priority level revision standard was set through this API is set to “term”. In the case of this setting method, the revision standard set through this API is deleted when the valid period elapses.

Next, descriptions are given of the setting of “revision standards for the states of request-source terminals”.

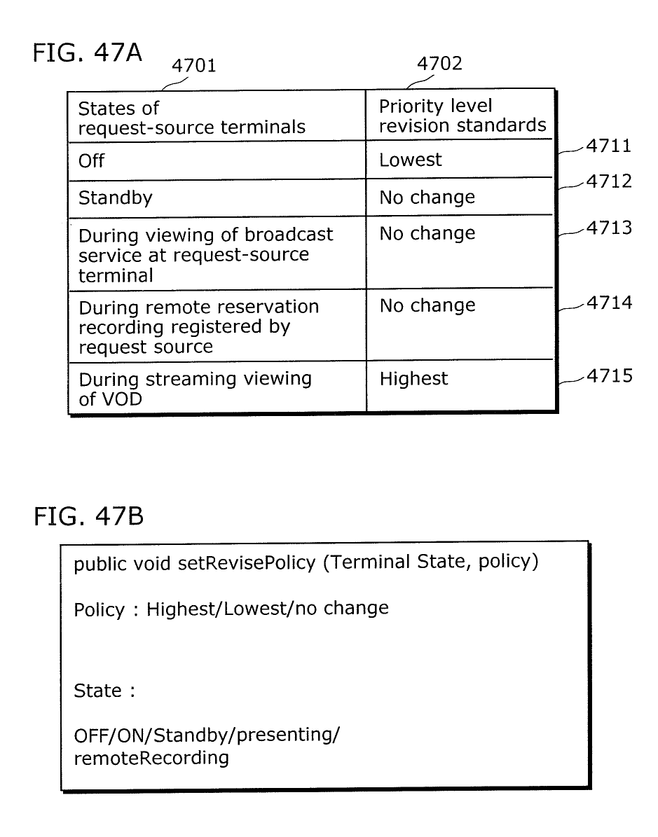

FIG. 47A shows an example of the revision standards for the states of the respective request-source terminals which have been set by the priority level revision standard setting unit 4102.

A column 4701 describes the “states of request-source terminals”, and a column 4702 describes “high and low specification revision standards”. For example, a line 4715 shows that the priority level revision standard Highest is set to a request-source terminal in the status of“VOD streaming viewing”. It is to be noted that the state of a request-source terminal may include contract details related to viewing of a content which has been set for the request-source terminal.

FIG. 47B is an example of an API which the device contention resolving manager 1706 provides to a Java program.

The priority level revision standards corresponding to the “states of request-source terminals” are set by “public void set Revise Policy (terminal State, policy)” shown in FIG. 47B. Here, the “states of request-source terminals” are specified for the “Terminal State” as arguments, and the priority level revision standards corresponding to the request types are set to “Policy”.

Here, in the case where such priority level revision standards are not set, priority levels are set based on a unique judgment made by the priority level revision standard setting unit 4102.

In this way, the priority level revision standard setting unit 4102 includes a standard data holding unit which holds standard data (the table shown in FIG. 46A or FIG. 47A) indicating the priority level standards for each state of a terminal (requesting device) or for each request type. In order to hold the standard data, the priority level revision standard setting unit 4102 receives the priority level standards from another device or an application program in advance or determines the priority level standards by itself, and stores, in the standard data holding unit, the standard data indicating the standards.

The priority level revision processing unit 4103 has a function of setting priority levels in response to a “device allocation request” from a plurality of terminals including the terminal itself which are connected via a network according to the base priority levels to the priority level setting unit 4101 and the revision standards which have been set by the priority level revision standard setting unit 4102 when device contention occurs and the device contention resolving processing unit 4104 makes the inquiry about the priority levels.

In this embodiment, the priority level revision processing unit 4103 sets the priority levels based on the base priority levels and the revised priority levels, and thus the settings of the priority levels performed by the priority level revision processing unit 4103 are called “revision” of the priority levels when this revision should be distinguished in the descriptions.

It is to be noted that the timing of revising the priority levels may be another timing, for example, the timing when the states of terminals connected to a network is changed, the timing when a new processing request is made, or the timing when the priority level setting unit 4101 changes the base priority levels of terminals, as long as the timing is the timing at which revised priority levels are returned according to the newest processing request state or terminal state when an inquiry is received.

The priority level revision processing unit 4103 receives the inquiry about the priority levels by using the “device allocation request” as the arguments. Subsequently, it determines the priority level of the “device allocation request” according to the base priority level held by the priority level setting unit 4101, the revision standards which have been set by the priority level revision standard setting unit 4102, and the information held in the “device allocation request” specified by the device contention resolving processing unit 4104, and returns the priority levels to the inquiry source.

In other words, the priority level revision processing unit 4103 in this embodiment is structured as a priority level deriving unit, and executes deriving processing of deriving the priority levels corresponding to the requests (device allocation requests) from the respective requesting devices, based on: either the states of the respective terminals (requesting devices) or the types of requests made by the respective requesting devices; and the base priority levels, of the respective requesting devices, which are shown by the base priority level data. More specifically, the priority level revision processing unit 4103 determines provisional priority levels corresponding to the requests made by the respective requesting devices, based on the standards shown by the standard data, and executes, as the deriving processing, the processes up to the process of revising the determined priority levels according to the base priority levels of the respective requesting devices which are shown by the base priority level data.

The “device allocation request” includes: all or a part of 1) the processing request type; 2) the ID of the terminal which is a message transmission source; 3) the ID of the Java program which is executed by the terminal as the message transmission source and relates to the message; and 4) the priority level valid within the range of the terminal as the message transmission source. It is to be noted that, in this embodiment, the processing request type and the ID of the terminal as the message transmission source are essential. Detailed descriptions of the “device allocation request” are given in the descriptions of the device contention resolving processing unit 4104.

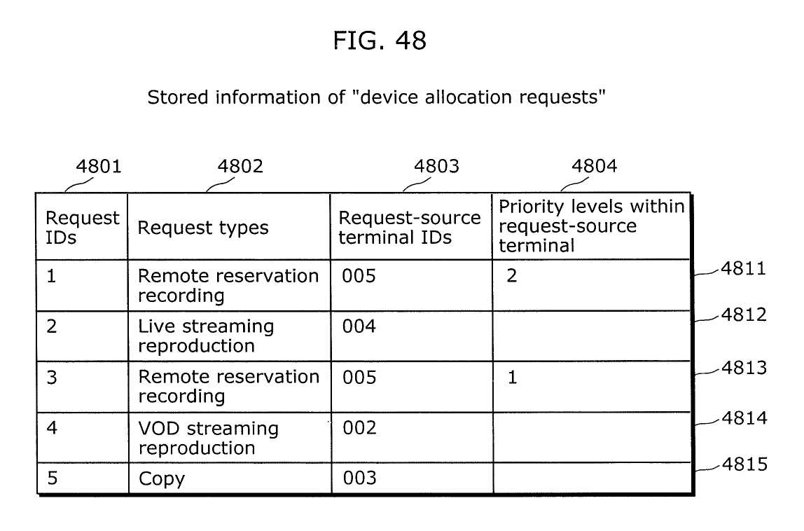

FIG. 48 shows examples of the “device allocation requests” specified by the device contention resolving processing unit 4104. A column 4801 describes the IDs for uniquely identifying the device allocation requests. A column 4802 describes request types, column 4803 describes the IDs of the request-source terminals, and a column 4804 describes the priority levels which are valid within the request-source terminal. Both a line 4811 and a line 4813 describe remote reservation recording requests from the same terminal identified as Terminal ID=005, but the priority levels of the respective requests within the respective terminals are different.

The following are described in sequence below: the priority level revision according to the “revision standards for request types” and the priority level revision according to the “revision standards for the states of request-source terminals”.

First, descriptions are given of the priority revision according to the “revision standards for request types”.

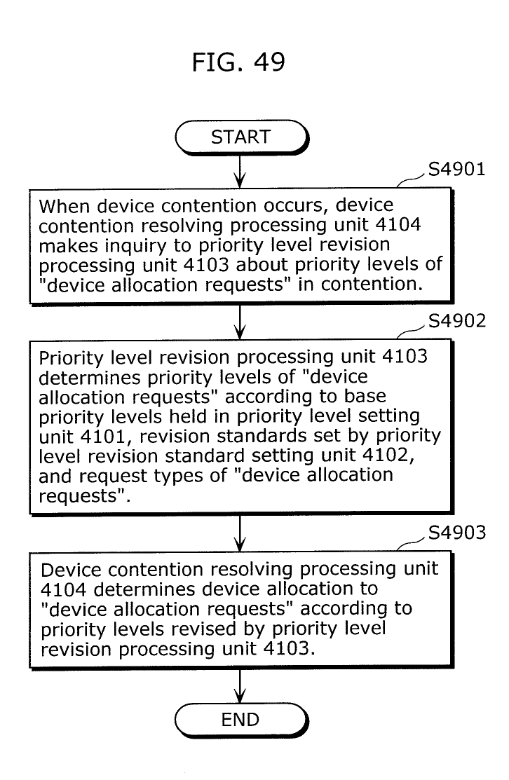

FIG. 49 is a simple flow of the processing for achieving priority level revision according to the “revision standards for request types”.

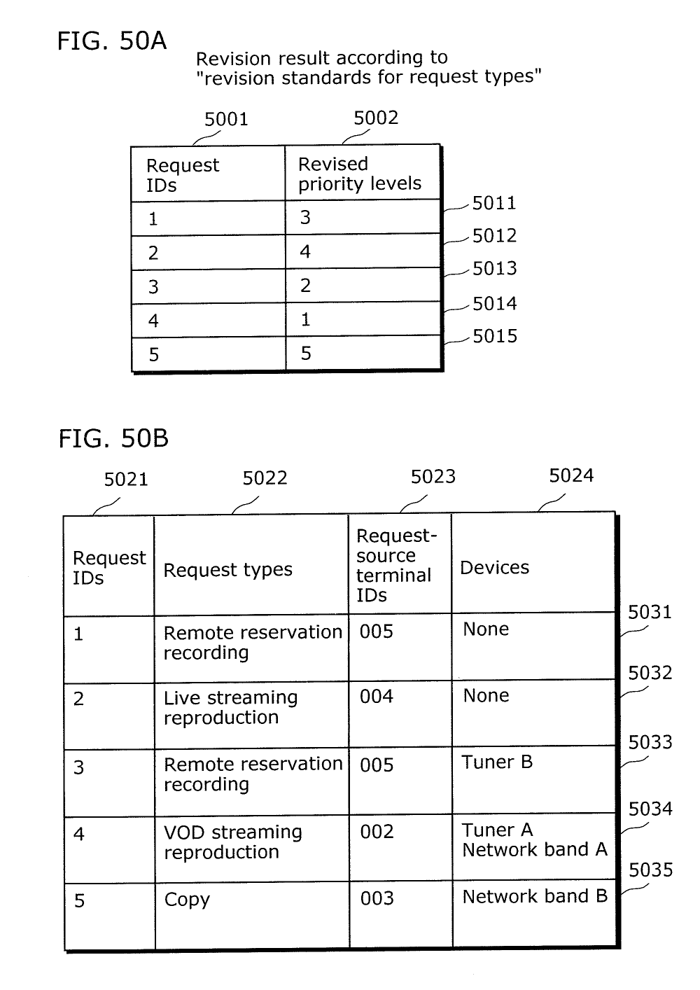

FIG. 50A describes priority levels which the priority level revision processing unit 4103 has revised based on: the base priority levels shown in FIG. 45A; the “revision standards for request types” shown in FIG. 46A; the information included in the “device allocation request” shown in FIG. 48 specified by the device contention resolving processing unit 4104.

The priority level revision processing unit 4103 determines the priority levels of the received “device allocation requests”, according to the following procedure.

First, with reference to the request types described in the column 4802 in FIG. 48, it extracts the “device allocation requests” which are associated with the request types assigned with the priority level revision standard “Highest” shown in FIG. 46A. In the case where a single “device allocation request” is extracted, it sets a priority level of “1” to the “device allocation request”. In the case where two “device allocation requests” are extracted, it obtains the base priority levels shown in FIG. 45A by using, as keys, the IDs of the request-source terminals which have made the “device allocation requests”, and sets the priority levels of the “device allocation requests” in the order according to the base priority levels. In the case where no “device allocation request” is extracted, it does nothing.

More specifically, it has allocated priority levels 1 to 3 to the “device allocation requests” assigned with Request ID 1, Request ID 3, and Request ID 4 for requesting remote reservation recording or VOD streaming reproduction as shown in FIG. 50A.

Secondly, with reference to the request types described in the column 4802 in FIG. 48, it extracts the “device allocation requests” which are associated with the request types assigned with the priority level revision standard “No change” shown in FIG. 46A. In the case where a single “device allocation request” is extracted, it sets, to this extracted “device allocation request”, the priority level next to the priority level which has been set by the priority level revision processing unit 4103 to the “device allocation request” extracted in the case of the priority level revision standard “Highest”. In the case where two “device allocation requests” are extracted, it obtains the base priority levels shown in FIG. 45A by using, as keys, the IDs of the terminals which are the request sources of the “device allocation requests”, and sets the priority levels of the “device allocation requests” in the order according to the base priority levels. Here, it sets the priority level next to the priority level which the priority level revision processing unit 4103 has set to the “device allocation request” extracted in the case of the priority level revision standard “Highest”. In the case where no “device allocation request” is extracted, it does nothing.

More specifically, it has allocated priority level 4 to the “device allocation request” assigned with Request ID 2 for requesting live streaming reproduction as shown in FIG. 50A, according to the second procedure.

Thirdly, with reference to the request types described in the column 4802 in FIG. 48, it extracts the “device allocation requests” which are associated with the request types assigned with the priority level revision standard “Lowest” shown in FIG. 46A. In the case where a single “device allocation request” is extracted, it sets, to this extracted device allocation request, the priority level next to the priority level which has been set by the priority level revision processing unit 4103 to the “device allocation request” extracted in the case of the priority level revision standard “No change”. In the case where two “device allocation requests” are extracted, it obtains the base priority levels shown in FIG. 45A by using, as keys, the IDs of the request-source terminals which have made the “device allocation requests”, and sets the priority levels of the “device allocation requests” in the order according to the base priority levels. Here, it sets the priority level next to the priority level which the priority level revision processing unit 4103 has set to the “device allocation request” extracted in the case of the priority level revision standard “No change”. In the case where no “device allocation request” is extracted, it does nothing.

More specifically, it has allocated priority level 5 to the “device allocation request” assigned with Request ID 5 for requesting copy as shown in FIG. 50A, according to the third procedure.

Here, in the case where the “device allocation requests” holds the same request-source terminal ID, and thus it is impossible to determine the order of priority levels according to the aforementioned first to third procedures, it sets priority levels by using the priority levels within the request-source terminals described in the column 4804 in FIG. 48. It is to be noted that in the case where no priority levels within a request-source terminal is specified, the priority level revision processing unit 4103 sets priority levels based on its unique judgment.

Next, descriptions are given of priority level revision according to “revision standards for the states of request-source terminals”.

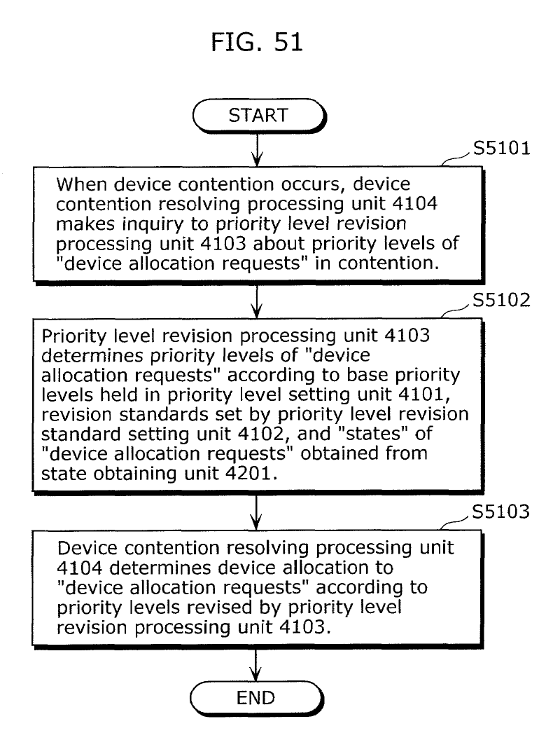

FIG. 51 is a simple flow of the processing for achieving priority level revision according to the “revision standards for the states of request-source terminals”.

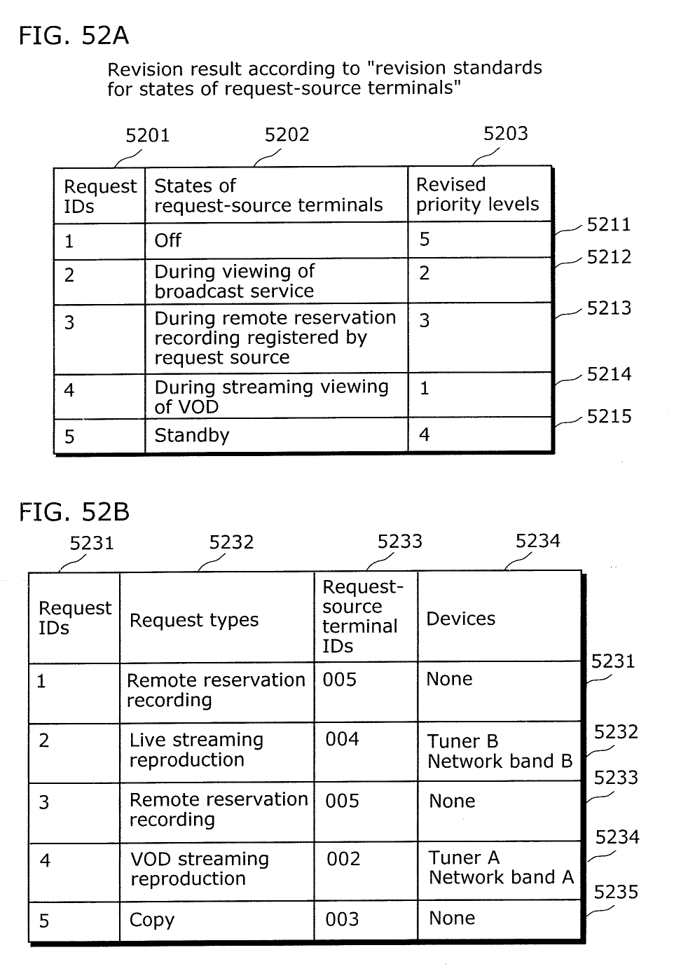

A column 5203 in FIG. 52A describes priority levels which the priority level revision processing unit 4103 has revised based on: the base priority levels shown in FIG. 45A; the “revision standards for request types” shown in FIG. 47A; the information included in the “device allocation request” shown in FIG. 48 specified by the device contention resolving processing unit 4104.

In the case where the revision standards are the revision standards for the states of the respective request-source terminals, the priority level revision processing unit 4103 determines the priority levels of the received “device allocation requests” according to the following procedure.

First, it refers to the IDs of the request-source terminals shown in the column 4803 in FIG. 48 as to the respective “device allocation requests”. Subsequently, it extracts the “device allocation request” including the request-source terminal ID different from the terminal ID of the terminal which mounts the device contention resolving manager. Subsequently, as for each of the extracted “device allocation requests”, it passes the request-source ID to the state inquiry unit 4201, and obtains the state of the request-source terminal via the network.

Here, examples of the states include: “the states of request-source terminals” at the time when, for example, power off, standby, during viewing of a broadcast service, during VOD streaming viewing; or, in the case where the request-source terminals have already made a processing request with a “device allocation request” via the network, the device allocation state in response to the “device allocation request” (the device allocation state is, for example, that a tuner A is secured in response to a remote reservation recording request, and the recording is being executed by using the tuner A which is currently being secured). Here, it obtains the “states of request-source terminals” from the state inquiry unit 4201. On the other hand, it does not obtain the “device allocation state” from the state inquiry unit 4201, but judges the “device allocation state” (the state specifies whether a device use right, for “device allocation request” from the request-source terminal, is given or not) based on: the device allocation state achieved by the device contention resolving processing unit in response to the respective “device allocation requests” (the devices are provided with a use right); and the execution states of the processing execution programs (the state specifies whether or not to process the processing execution program according to the “device allocation request” from the request-source terminal) such as the media supply unit 2303, the recording manager 1704h, and the service manager 1704f.

Here, in the case where a “request source terminal” is in the two or more states from among the “states of request-source terminals” or from among the “device allocation states”, the state requiring the higher revision standard is employed.

A column 5202 in FIG. 52A describes examples of the obtained states. Secondly, the priority level revision processing unit 4103 extracts the “device allocation request” having the state which has been obtained according to the first procedure and is assigned with the priority level revision standard “Highest” shown in FIG. 47A. In the case where a single “device allocation request” is extracted, it sets a priority level of “1” to the “device allocation request”. In the case where two “device allocation requests” are extracted, it obtains the base priority levels shown in FIG. 45A by using, as keys, the IDs of the request-source terminals which have made the “device allocation requests”, and sets the priority levels of the “device allocation requests” in the order according to the base priority levels. In the case where no “device allocation request” is extracted, it does nothing.

More specifically, it has allocated priority level 1 to the “device allocation request” assigned with Request ID 4 associated with the request-source terminal which is in a state of VOD streaming viewing as shown in FIG. 52A, according to the first and second procedures.

Thirdly, the priority level revision processing unit 4103 extracts the “device allocation request” which is associated with the request type assigned with the priority level revision standard “No change” shown in FIG. 47A and the “device allocation request” in response to which no state is or can be obtained according to the first procedure. In the case where a single “device allocation request” is extracted, it sets, to this extracted device allocation request, the priority level next to the priority level which has been set by the priority level revision processing unit 4103 to the “device allocation request” extracted in the case of the priority level revision standard “Highest”. In the case where two “device allocation requests” are extracted, it obtains the base priority levels shown in FIG. 45A by using, as keys, the IDs of the request-source terminals which have made the “device allocation requests”, and sets the priority levels of the “device allocation requests” in the order according to the base priority levels. Here, it sets the priority level next to the priority level which the priority level revision processing unit 4103 has set for the “device allocation request” extracted in the case of the priority level revision standard “Highest”. In the case where no “device allocation request” is extracted, it does nothing.

More specifically, as shown in FIG. 52A, it has allocated the priority levels 2 to 4 to the “device allocation requests” assigned with Request ID 2, Request ID 3, and Request ID 5 according to the third procedure.

Fourthly, the priority level revision processing unit 4103 extracts the “device allocation request” having the state which has been obtained according to the first procedure and is associated with the priority level revision standard “Lowest” shown in FIG. 47A. In the case where a single “device allocation request” is extracted, it sets, to this extracted device allocation request, the priority level next to the priority level which has been set by the priority level revision processing unit 4103 to the “device allocation request” extracted in the case of the priority level revision standard “No change”. In the case where two “device allocation requests” are extracted, it obtains the base priority levels shown in FIG. 45A by using, as keys, the IDs of the request-source terminals which have made the “device allocation requests”, and sets the priority levels of the “device allocation requests” in the order according to the base priority levels. Here, it sets the priority level next to the priority level which the priority level revision processing unit 4103 has set to the “device allocation request” extracted in the case of the priority level revision standard “No change”. In the case where no “device allocation request” is extracted, it does nothing.

More specifically, it has allocated the priority level 5 to the “device allocation request” assigned with Request ID 1 corresponding to an Off state as shown in FIG. 52A, according to the fourth procedure.

Here, in the case where the “device allocation requests” include the same request-source terminal ID, and thus it is impossible to determine the order of priority levels according to the aforementioned first to fourth procedures, it sets priority levels by using the priority levels within the request-source terminals described in the column 4804 in FIG. 48. It is to be noted that in the case where no priority level within a request-source terminal is specified, the priority level revision processing unit 4103 sets priority levels based on its unique judgment.

In addition, here, in the case where a “request source terminal” is in the two or more states from among the states described as the revision standards for the respective states, the state requiring the higher revision standard is employed in the first to fourth procedures. The revision standards include “Highest”, “No change”, and “Lowest” with priority levels which become lower in the listed order. In third procedure, the “device allocation request” which has the same request-source terminal ID as the ID of the terminal which mounts the device contention resolving manager is handled as having a revision standard equivalent to “No change”. However, it is to be noted that the “device allocation request” may be handled as having a revision standard equivalent to “Highest” in the first to third procedures.

Descriptions have been given of priority level revision according to the revision standards for request types and priority level revisions according to the revision standards for the states of the respective request-source terminals. However, the present invention is applicable even when the revision standards are based on other conditions.

The state inquiry unit 4201 is used for obtainment of the states of the respective request-source terminals when the priority level revision processing unit 4103 performs priority level revision according to the “revision standards for the states of request-source terminals”. The definition of the “state” is as described in the descriptions of the priority level revision processing unit 4103. When the state inquiry unit 4201 is requested to make an inquiry about the obtainment of the states of the terminals connected via the network by receiving an input of the terminal ID, it passes the terminal ID to the message transmitting and receiving unit 2304 and obtains the state of the terminal. Subsequently, it returns the result to the inquiry source. Here, in the case where the terminal ID is the terminal ID of the device itself, it returns the result to the message transmitting and receiving unit 2304 instead of making an inquiry.

The device contention resolving processing unit 4104 has a function of: receiving instructions from process execution programs such as the media supply unit 2303, the recording manager 1704h, and the service manager 1704f, or instructions from programs such as the message transmitting and receiving unit 2303 and the Java program which solely use specific devices; and perform device allocation in response to the processing requests.

The device contention resolving processing unit 4104 performs device allocation in response to the respective processing requests by using all or a part of the following as argument(s): 1) processing request types, 2) the IDs of the terminals which are the message transmitting sources, 3) the IDs of the Java programs which are executed on the message transmission source terminals and which relate to the messages, and 4) the priority levels valid within the ranges of the respective message transmission source terminals. It is to be noted that, in this embodiment, the processing request types and the IDs of the respective terminals as the message transmission sources are essential. Such processing request type may have any format as long as it is the information based on which the processing request can be identified. The priority levels valid within the range of the message transmission source terminal correspond, for example, to the priority level of the Java program.

The device contention resolving processing unit 4104 holds the input information (some of or all of the above information items 1 to 4) as “device allocation request”. The “device allocation request” is held during the period from when the device allocation is requested for to when the request maker releases the devices or deprives the devices. FIG. 48 shows examples of the “device allocation requests” held by the device contention resolving processing unit 4104.

The column 4801 describes the IDs for uniquely identifying the device allocation requests. The column 4802 describes the IDs of the request-source terminals, and the column 4804 describes the priority levels which are valid within the request-source terminal. Both the line 4811 and the line 4813 describe remote reservation recording requests from the same terminal identified as Terminal ID=005, but the priority levels of the respective requests within the terminal are different.

In the case where a plurality of processing execution programs and Java programs make requests for device allocation and thus the devices contend with each other (the number of devices is less than required), the device contention resolving processing unit 4104 passes the “device allocation requests” requesting the use of the devices in the contention to the priority level revision processing unit 4103, and makes the inquiry about the priority levels of all the “device allocation requests”. Subsequently, the device contention resolving processing unit 4104 allocates the devices in the order of precedence in the priority levels of the processing requests.

FIG. 50A shows the result of inquiry to the priority level revision processing unit 4103, and FIG. 50B shows the respective devices allocated to the “device allocation requests”, based on the result of the inquiry.

FIG. 50A shows the priority levels which the priority level revision processing unit 4103 has revised based on: the base priority levels shown in FIG. 45A; the revision standards for the respective request types shown in FIG. 46A; and the information included in the “device allocation requests” shown in FIG. 48.

FIG. 50B shows the devices which the device contention resolving processing unit 4104 has allocated based on: the base priority levels shown in FIG. 45A; the revision standards for the respective request types shown in FIG. 46A; and the information included in the “device allocation requests” shown in FIG. 48. A line 5034 shows that the rights to use the tuner A and a network band are given in response to the VOD streaming reproduction request from the terminal identified as Terminal ID=002. A line 5033 shows that a right to use the tuner B is given for the remote reservation recording request from the terminal identified as Terminal ID=005.

A line 5032 shows that no device has allocated in response to the live streaming reproduction request from the terminal identified as Terminal ID=004 because the number of tuners is less than required, in other words, the priority level of the “device allocation request” which is the live streaming reproduction request from the terminal identified as Terminal ID=004 is low among the “device allocation requests” which require the tuners. Without the tuner, it is impossible to perform the live streaming reproduction even if a network band B is allocated in response to the live streaming request, and thus the network band B is not allocated at this time.

The line 5035 also shows that the right to use the network band B is given to the copy request from the terminal identified as Terminal ID=003 and the priority level lower than that of the live streaming reproduction request from the terminal identified as Terminal ID=004 because the network band B is available.

FIG. 52A shows the result of inquiry to the priority level revision processing unit 4103, and FIG. 52B shows the respective devices allocated to the “device allocation requests”, based on the result of the inquiry.

FIG. 52A shows the priority levels which the priority level revision processing unit 4103 has revised based on: the base priority levels shown in FIG. 45A; the revision standards for the states of the respective request sources shown in FIG. 47A; the information included in the “device allocation requests” shown in FIG. 48; and the newest states of the respective request-source terminals.

FIG. 52B shows the devices which the device contention resolving processing unit 4104 has allocated according to the priority levels which the priority level revision processing unit 4103 has revised based on: the base priority levels shown in FIG. 45A; the revision standards for the states of the respective request sources shown in FIG. 47A; the information included in the “device allocation requests” shown in FIG. 48; and the newest states of the respective request-source terminals.

Descriptions have been given of the software structure and the functions of the recording device in this embodiment.

Next, detailed descriptions are given of the structure and functions of the reproducing device (content receiving and reproducing device) in this embodiment.

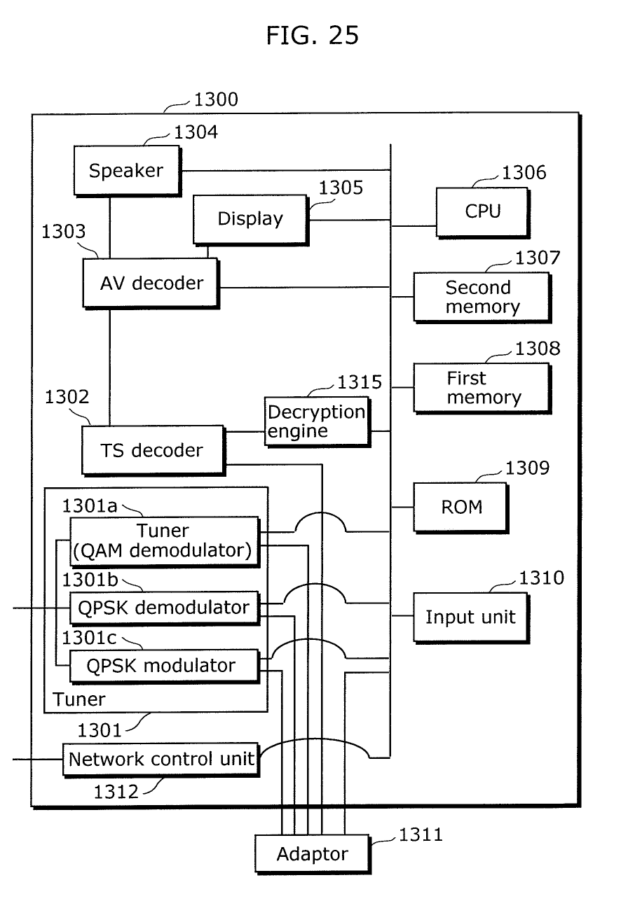

FIG. 25 is a block diagram showing a general hardware configuration of the reproducing device in this embodiment, in other words, a specific internal structure of each of the content receiving and reproducing devices 3202, 4404, and 4405 in FIG. 44. 2500 denotes a reproducing device, and the reproducing device is structured with a tuner 1301, a TS decoder 1302, an AV decoder 1303, a speaker 1304, a display 1305, a CPU 1306, a second memory unit 1307, a first memory unit 1308, a ROM 1309, an input unit 1310, an adaptor 1311, a network control unit 1312, and a decryption engine 1315. It is to be noted that the reproducing device required when an OCAP Home Network is used is assumed to be a base in this embodiment.

The structural elements in FIG. 25 assigned with the same reference numerals as those in FIG. 13 have the same functions as the structural elements of the recording device, and thus descriptions are not repeated. More specifically, the tuner 1301, the TS decoder 1302, the AV decoder 1303, the speaker 1304, the display 1305, the CPU 1306, the second memory unit 1307, the first memory unit 1308, the ROM 1309, the input unit 1310, the adaptor 1311, the network control unit 1312, and the decryption engine 1315 have the same functions as the structural elements having the same names in the recording device. However, the reproducing device has unique restrictions, and thus the restrictions are described additionally.

The reproducing device does not have a function for recording broadcast services, and thus any encrypted MPEG-2 transport streams are not recorded in the second memory unit 1307.

The encryption scheme used by the decryption engine 1315 of the reproducing device is assumed to be the same as the encryption scheme used by the encryption engine 1313 of the recording device.

The recording device does not have a multiplexer 1314, and thus the outputs from the TS decoder 1302 are always inputted to the AV decoder 1303.

Descriptions are given of how the aforementioned respective units of the recording device are operated.

First, descriptions are given of the operations performed in the case where a service included in a received broadcast wave is reproduced.

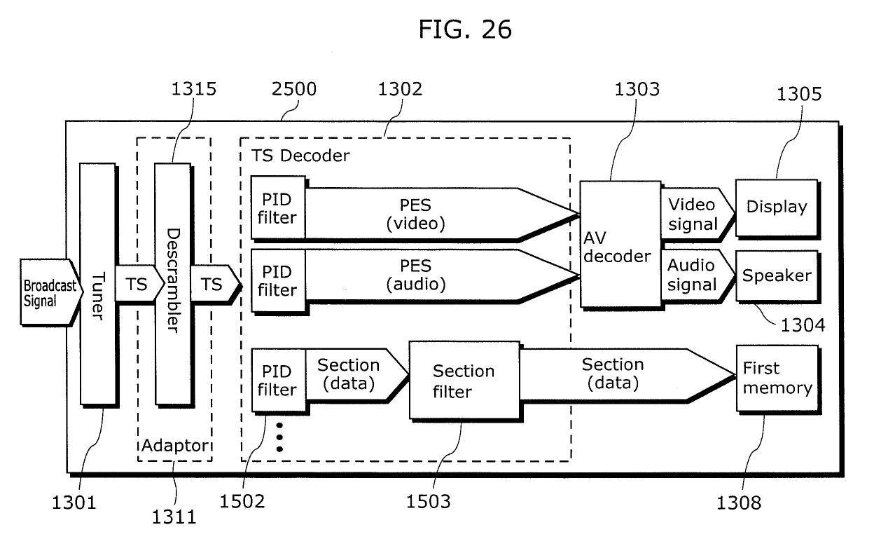

FIG. 26 is a conceptual diagram representing the order of physical connections between the respective devices, the processing details of the devices, and the input and output data formats at the time when a service included in a received broadcast wave is reproduced. 2500 denotes a reproducing device, and the reproducing device is structured with a tuner 1301, an adaptor 1311, a TS decoder 1302, a PID filter 1502, a section filter 1503, an AV decoder 1303, a speaker 1304, a display 1305, and a first memory unit 1308. Among the structural elements in FIG. 26, the structural elements assigned with the same reference numerals as those assigned to the structural elements in FIG. 13 have equivalent functions, and thus descriptions of these are omitted.

First, the tuner 1301 tunes a broadcast wave according to a tuning instruction made by the CPU 1306. The tuner 1301 demodulates the broadcast wave, and inputs an MPEG-2 transport stream to the adaptor 1311.

The descrambler 1501 present in the adaptor 1311 descrambles a viewing-limiting encryption on the received MPEG-2 transport stream based on the limit-descrambling information for each viewer. The MPEG-2 transport stream on which the viewing-limiting encryption has been descrambled is inputted to the TS decoder.

The TS decoder 1302 includes two types of devices of a PID filter 1502 and a section filter 1503 which performs processing on MPEG-2 transport streams.

The PID filter 1502 extracts TS packets assigned with PIDs specified by the CPU 1306 from the inputted MPEG-2 transport stream, and further extracts the PES packets and the MPEG-2 sections which are present in the payloads. For example, in the case where the MPEG-2 transport stream in FIG. 6 is inputted when the CPU 1306 directs PID filtering for extracting the TS packet assigned with PID 100, packets 601 and 603 are extracted and then connected to each other so as to reconstruct a PES packet of the video 1. Otherwise, in the case where the MPEG-2 transport stream in FIG. 6 is inputted when the CPU 1306 directs PID filtering for extracting the TS packet assigned with PID 200, packets 602 and 605 are extracted and then connected to each other so as to reconstruct the MPEG-2 sections of the data 1.

The section filter 1503 extracts the MPEG-2 sections which meet the section filter conditions specified by the CPU 1306 from among the inputted MPEG-2 sections, and DMA-transfers them to the first memory unit 1308. As such section filter conditions, PID values, and table_id values as supplemental conditions can be specified. For example, it is assumed that the CPU 1306 directs the section filter 1503 to execute PID filtering for extracting the TS packet assigned with PID 200 and section filtering for extracting sections which has a table_id of 64. As described earlier, after the MPEG-2 sections of the data 1 are reconstructed, the section filter 1503 extracts only the sections which has the table_id 64 from among the MPEG-2 sections, and DMA-transfers them to the first memory unit 1308 which is a buffer.

The video PESs and audio PESs inputted to the AV decoder 1303 are decoded into an audio signal and a video signal to be outputted. Subsequently, the audio signal and video signal are inputted to the display 1305 and the speaker 1304 so that video and audio are reproduced.

The MPEG-2 sections inputted to the first memory 1308 are inputted to the CPU 1306 as needed, and used by software.

Next, descriptions are given of the operations in the case where a reproduction device reproduces an encrypted MPEG-2 transport stream received from another recording device via the network.

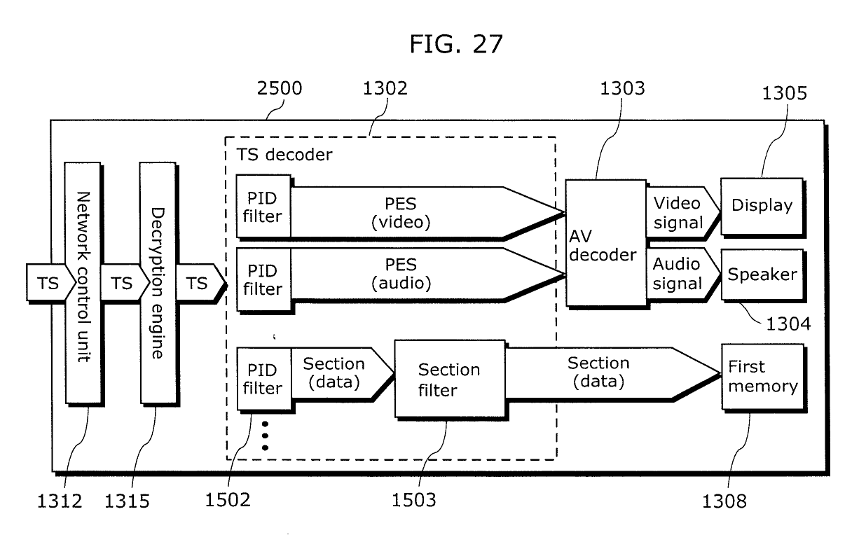

FIG. 27 is a conceptual diagram representing the order of physical connections between the respective devices, the processing details of the devices, and the input and output data formats in this case. The reproduction device 2500 includes a reproducing device, and the reproducing device is structured with a network control unit 1312, a decryption engine 1315, a TS decoder 1302, a PID filter 1502, a section filter 1503, an AV decoder 1303, a speaker 1304, a display 1305, and a first memory unit 1308. Among the structural elements in FIG. 26, the structural elements assigned with the same reference numerals as those assigned to the structural elements in FIG. 13 have equivalent functions, and thus descriptions of these are omitted.

The network control unit 1312 receives the MPEG-2 transport stream converted into packet form, based on the MoCA definitions via the network. The packets are unpacketized based on the definitions of the HTTP/TCP/IP protocols, and the encrypted MPEG-2 transport stream is extracted. The extracted encrypted MPEG-2 transport stream is inputted to the decryption engine 1315

The decryption engine decrypts the encrypted MPEG-2 transport stream by using the encryption scheme used by the encryption engine 1313 of the recording device 1300 (content recording and transmitting device 3201). A decryption key is given by the CPU 1306.

The decrypted MPEG-2 transport stream is inputted to the TS decoder 1302.

Next, the video PESs and audio PESs specified by the CPU 1306 are extracted by the PID filter 1502 in the TS decoder 1302. The extracted PES packets are inputted to the AV decoder 1303. Otherwise, the MPEG-2 sections assigned with PIDs and table_id specified by the CPU 1306 are extracted by the PID filter 1502 and the section filter 1503 in the TS decoder 1302. The extracted MPEG-2 sections are DMA-transferred to the first memory unit 1308.

The video PESs and audio PESs inputted to the AV decoder 1303 are decoded into an audio signal and a video signal to be outputted. Subsequently, the audio signal and video signal are inputted to the display 1305 and the speaker 1304 so that the video and audio are reproduced.

The MPEG-2 sections inputted to the first memory 1308 are inputted to the CPU 1306 as needed, and used by software.

Descriptions have been given of examples of hardware structures related to the reproducing device according to the present invention up to this point. The following describe principal functions of the reproducing device according to the present invention which are: reproduction control of services by a Java program; and reproduction control of services inputted via the network.

To reproduce a service in the reproducing device according to the present invention is to receive the service multiplexed on a broadcast wave, and reproduce or execute the video, audio, Java program which make up the service. To reproduce a service inputted via a network is to reproduce or execute the video, audio, and Java program which make up a service received as an input via a network, based on the synchronization information of the Java program, instead of reproducing the service in a received broadcast wave. It is required that approximately the same service reproduction result is obtained both in the case of receiving a broadcast wave and reproducing the service and in the case of receiving an input of the same service via a network and reproducing it.

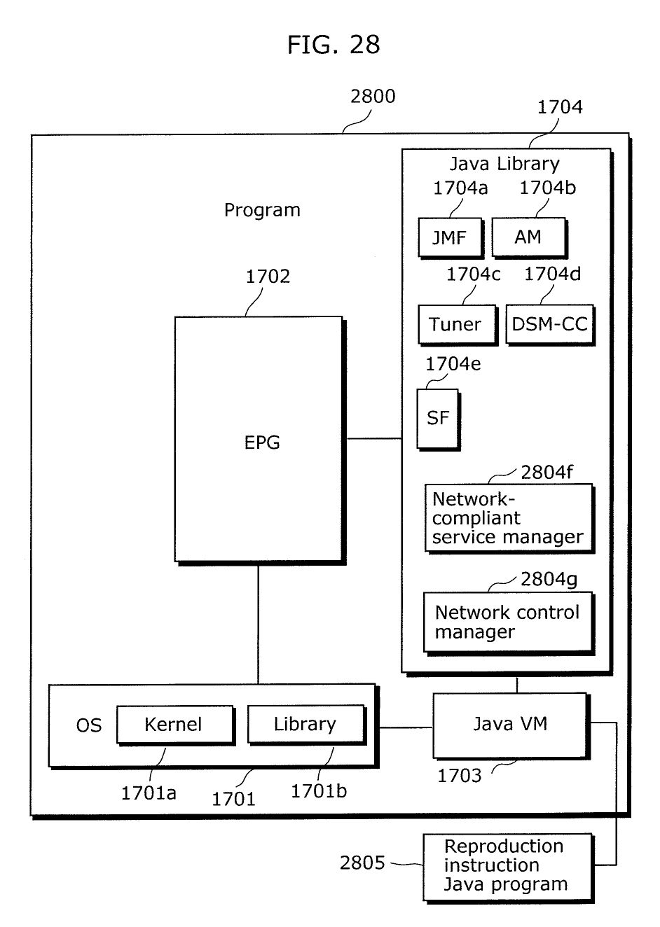

FIG. 28 is a program necessary for reproduction control of a service by the Java program and reproduction control of a service inputted via the network, and is a structural diagram of software recorded in the ROM 1309.

The program 2800 is structured with an OS 1701, an EPG 1702, a Java VM 1703, and a Java library 1704 which are sub-programs.

Among these, the Java VM 1703 has the same functions as those of the structural element having the same name included in the recording device in this embodiment, and thus the descriptions are not repeated.

The EPG 1702 has a function for selecting a broadcast service and reproducing it, in addition to the same functions as those of the structural element having the same name included in the recording device in this embodiment. This function is generally known and has almost no influence on the scope of the present invention, and thus only brief descriptions are given. The EPG 1702 obtains a list of broadcast services by using the function of the service listing unit 2905 to be described later on. Subsequently, it displays the list of broadcast services on the display and allows the user to select one of these as in the case of the EPG of the recording device. It reproduces the selected broadcast service by using the function of the service switching unit 2906.

The OS 1701 is the same as the structural element having the same name included in the recording device in this embodiment. As for the internal structural elements of the OS 1701, the kernel 1701a is the same as the structural element having the same name included in the recording device in this embodiment. The library 1701b which is one of the internal structural elements of the OS 1701 is the same as the structural element having the same name included in the recording device in this embodiment. However, since it is a structural element of reproducing device, it does not read and write any encrypted MPEG-2 transport streams from and on the second memory unit 1307 for recording.

The Java library 1704 has approximately the same functions as those of the structural element having the same name in the recording device according to the present invention. The Java library 1704 is structured with a JMF 1704a, an AM 1704b, a tuner 1704c, a DSM-CC 1704d, an SF 1704e, a network-compliant service manager 2804f, and a network control manager 2804g.

Among these, the JMF 1704a, an AM 1704b, a tuner 1704c, a DSM-CC 1704d, and an SF 1704e have the same functions as those of the structural elements having the same names in the recording device according to the present invention, and thus the descriptions are not repeated.

The network control manager 2804g has a function of transmitting a message to a terminal other than the reproducing device itself via the network, and receiving the response. The main application in this embodiment is to transmit such message to the recording device and receive necessary data and MPEG-2 transport streams.

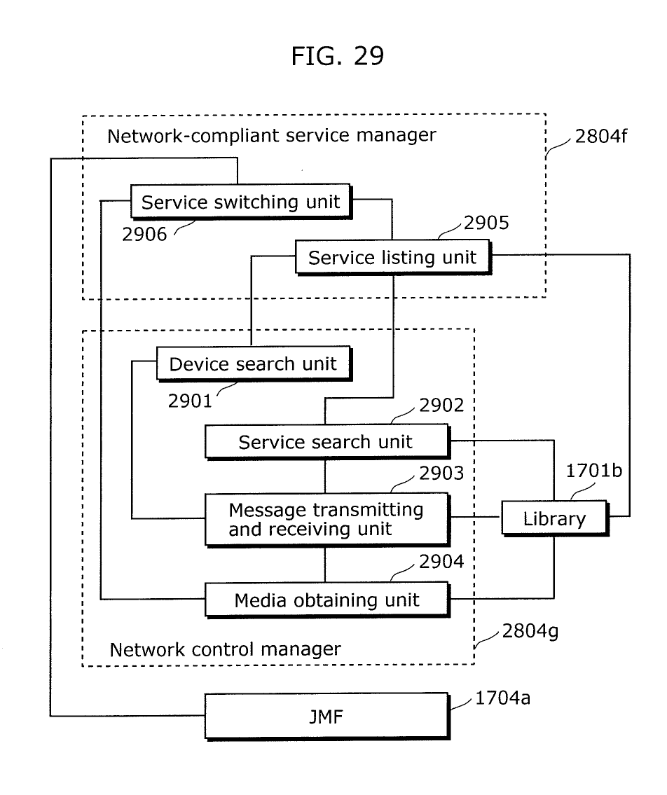

FIG. 29 shows the structure of the network control manager 2804g. The network control manager 2804g is structured with a device search unit 2901, a service search unit 2902, a media obtaining unit 2904, and a message transmitting and receiving unit 2903.

The message transmitting and receiving unit 2903 receives the message generated by the device search unit 2901, the service search unit 2902, and the media obtaining unit 2904, and transmits the message to an outside terminal. In this embodiment, the message is transmitted and received by using the HTTP protocol, and thus the message transmitting and receiving unit 2903 packetizes the message into IP packets in compliant with the HTTP/TCP/IP protocols by using the library 1701b. Subsequently, it performs MOCA modulation on the IP packets by using the hardware of the network control unit 1312 of the reproducing device, and transmits it to the corresponding device. On the other hand, in the case where the network control unit 1312 receives IP-packetized message, the library 1701b unpacketizes the IP packets in compliant with the HTTP/TCP/IP protocols, and passes the included command to the message transmitting and receiving unit 2903. Subsequently, the message transmitting and receiving unit 2903 passes the message to one of the device search unit 2901, the service search unit 2902, the media obtaining unit 2904 according to the details of the message. Detailed descriptions are given later as to a relationship between messages and structural elements as the destinations of the respective messages.

Further, in the case where the message transmitting and receiving unit 2903 receives a message of a “state inquiry request”, it judges the state of the terminal itself by using the library 1701b, packs the result of the judgment into an HTTP message, and returns it to the message transmission source.

In this embodiment, it is to be noted that the reproducing device uses the DLNA Specifications for inter-terminal communication via a network like the recording device. Descriptions of DLNA have already been given in the descriptions of the recording device, and they are not repeated.

When the device search unit 2901 receives, as an input, a request for device search from the service listing unit 2905 to be described later, it passes a device search command to the message transmitting and receiving unit 2903 so as to request for message transmission to the destination devices. In general, the destinations are all the devices on the network. Each of recording devices among the devices which have received, via the network, the message in which the device search command is packed returns a response message indicating that the device itself is a recording device to the reproducing device which has issued the command. The message transmitting and receiving unit 2903 of the reproducing device expands the messages and extracts the command. In the case of a command indicating that the device itself is a recording device, it passes the response command to the command device search unit 2901. With reference to this response message, the device search unit 2901 can find out the recording devices present on the network. The device search unit 2901 returns, as the IDs identifying the recording devices, the IP addresses of all the recording devices to the service listing unit 2905. It is to be noted that the IP addresses of the recording devices can be obtained, from the library 1701b, as the transmission sources of the response messages.

When the service search unit 2902 receives, as an input, the ID (the IP address, here) identifying a recording device from the service listing unit 2905 to be described later, it generates a recorded service obtainment command and passes it with the IP address to the message transmitting and receiving unit 2903. Subsequently, the message transmitting and receiving unit 2903 transmits the message in which the recorded service obtainment command is packed to the recording device. The recording device which has received the message performs the aforementioned processing, and returns, to the reproducing device, the response message regarding, as the recorded service information, a set of: the record identifier 2101 of the recorded service, the channel identifier 2102, the program number 2103, the starting time 2104, the ending time 2105, and the media length 2108. The set has been described as a response in the record information management table in FIG. 21. The network control unit 1312 of the reproducing device which has received this message passes the message to the library 1701b. The library 1701b expands the message according to the HTTP/TCP/IP protocols, and passes the recorded service information set to the message transmitting and receiving unit 2903. In the case where the received information is a recorded service information set, the message transmitting and receiving unit 2903 returns it to the service search unit 2902. The service search unit 2902 returns, to the service listing unit 2905, this information as a set of services recorded on the recording device specified by the service listing unit 2905.

The media obtaining unit 2904 receives, as inputs from the service switching unit 2906 to be described later, the ID or IP address of the recording device, the record identifier 2101, the first byte position and the last byte position of the desired data which are necessary for identifying the recorded service desired to be reproduced on the reproducing device. The media obtaining unit 2904 maps these information items on the HTTP message by using the library 1701b, packetizes them into IP packets in compliant with the HTTP/TCP/IP protocols, and transmits them to the recording device by using the network control unit 1312. The recording device which has received the message performs the aforementioned processing, and returns, as a response according to the HTTP/TCP/IP protocols, the binary data within the range specified by the first byte position and the last byte position in the encrypted MPEG-2 transport stream identified by the record identifier. The network control unit 1312 of the reproducing device which has received this message passes the message to the library 1701b. The library 1701b expands the message according to the HTTP/TCP/IP protocols, and returns the binary data of the encrypted MPEG-2 transport stream to the message transmitting and receiving unit 2903. In the case where the received information is binary data of the MPEG-2 transport stream, the message transmitting and receiving unit returns it to the media obtaining unit 2904. The media obtaining unit 2904 inputs, to the decryption engine 1315, this binary data as the encrypted MPEG-2 transport stream to be reproduced.

The network-compliant service manager 2804f manages reproduction of a service included in an MPEG-2 transport stream which is inputted from the adaptor 1311 and reproduction of a service included in an MPEG-2 transport stream which is inputted from the network control unit 1312 via a network. FIG. 29 shows the internal structure of the network-compliant service manager 2804f. The network-compliant service manager is structured with the service listing unit 2905 and the service switching unit 2906. The respective service listing unit 2905 and service switching unit 2906 execute operations which are switched for the following different cases: the case of reproducing a service included in an on-air MPEG-2 transport stream; and the case of reproducing a service included in an MPEG-2 transport stream which is inputted via a network, and thus the operations for the respective cases are described in detail below.

First, descriptions are given of the case of reproducing a service included in an on-air MPEG-2 transport stream which is inputted from the tuner 1301. This corresponds to reproducing a broadcast service.

The service listing unit 2905 includes an API which provides a list of reproducible services to the Java application. A broadcast service is represented as a Service class in Java language. It is assumed that the earlier-described channel identifier is used as the ID identifying a broadcast service. The service listing unit 2905 provides a Java API called filterServices (ServiceFilterfilter). This API returns, as a return value, the array of the broadcast services which satisfies a condition indicated by a filter parameter. For example, in the case where no condition is set to the filter, it returns the array of instances of the Service classes representing all the viewable broadcast services. For each service class, a method called getLocator ( ) is prepared, and thus the value of the channel identifier of the service can be extracted in form of URL format. In the case of OCAP, the URL format is the format called “ocap://channel identifier”. Thus, the URL of the service having Channel identifier 2 is ocap://2”. When the filterServices (ServiceFilterfilter) method is called, the service listing unit 2905 checks the channel identifier of the broadcast service viewable by using the library 1701b, creates the instances of the service classes representing these, sets the respectively corresponding channel identifiers, and returns an array of service instances.

The service switching unit 2906 switches to the specified broadcast service to start the reproduction of the service. The broadcast service is specified by the Service instance which can be found by the filterServices (ServiceFilterfilter) method of the service listing unit 2905. The service switching unit 2906 provides the API which specifies the service to be reproduced to the Java program. The API is, for example, a select (Service selection) method. The Java program specifies the Service instance of the broadcast service desired to be reproduced as the selection parameter. The service switching unit 2906 can find out the channel identifier of the service by obtaining the URL of the Service instance specified with a call of the getLocator ( ) method. Subsequently, the service switching unit 2906 directs, through the library 1701b, the TS decoder 1302 to output the MPEG-2 transport stream outputted from the adaptor 1311 in FIG. 25. In addition, it sets, through the library 1701b, the destinations of outputs by the respective hardware structural elements according to paths shown in FIG. 26. Subsequently, it provides the JMF 1704a with the channel identifiers of the data to be reproduced. Then, the JMF 1704a starts the reproduction of the video and audio multiplexed on the MPEG-2 transport stream to be outputted from the adaptor 1311, by the operations to be described later. Further, it provides the channel identifiers of the data to be reproduced to the AM 1704b. Then, the AM 1704b starts the execution and termination of the Java program multiplexed on the MPEG-2 transport stream according to the AIT multiplexed in the MPEG-2 transport stream to be outputted from the adaptor 1311.

On the other hand, the following describe the operations performed in the case of managing the reproduction of the services included in the encrypted MPEG-2 transport stream inputted by the network control unit 1312 via the network.

The service listing unit 2905 includes an API which provides a list of reproducible services recorded in the recording device present on the network to the Java application. A recorded service is represented as a RemoteService class in Java language. The RemoteService class is a subclass of the Service class. It is assumed that the earlier-described record identifier is used as the ID identifying a broadcast service. Thus, in the case of a recorded service, the URL format returned by the getLocator ( ) of the RemoteService method is a format called “ocap://record identifier”. In other words, the URL of the recorded service having Record identifier 2 is ocap://2”.

As described earlier, the service listing unit 2905 includes the API which returns an array of broadcast services which satisfy the condition indicated by the filter parameter called filterService (ServiceFilterfilter). Here, it is possible to set a filter called RemoteFilter for extracting and returning only the recorded service. When the filterServices (ServiceFilterfilter) method is called with a specification of the RemoteFilter, the service listing unit 2905 requests the device search unit 2901 to perform device search firstly. In response to this, the device search unit 2901 returns the IP addresses of all the recording devices present on the network as described earlier. Subsequently, the service listing unit 2905 inputs the returned IP addresses of the recording devices into the service search unit 2902. Then, the service search unit 2902 returns, to the service listing unit 2905, the recorded service information regarding, as a set, the record identifier 2101, the channel identifier 2102, the program number 2103, the starting time 2104, the ending time 2105, and the media length 2108. The service listing unit 2905 repeats the above operations for all the recording devices to obtain the recorded service information on all the recording devices to the end. Next, the service listing unit 2905 generates a RemoteService instance for each of the record identifiers of the obtained recorded services. Subsequently, it sets the following to the RemoteService instance: the record identifier 2101, the channel identifier 2102, the program number 2103, the starting time 2104, the ending time 2105, and the media length 2108. The RemoteService includes the methods for obtaining these values. The respective values correspond to getRecordId ( ), getChannelNumber ( ), getProgramNumber ( ), getStartTime ( ), getEndTime ( ), getMediaLength ( ), and getIPAddress ( ) methods. The array of the RemoteService instances generated in this way is returned as return values of the filterServices (ServiceFilterfilter) methods.

The service switching unit 2906 reproduces the specified recorded services on the reproducing device. The broadcast services are specified by the RemoteService instances which can be found by the filterServices (ServiceFilterfilter) methods of the service listing unit 2905. As described earlier, the service switching unit 2906 provides the select (Service selection) methods to the Java program. The Java program specifies the RemoteService instance of the recorded service desired to be reproduced as the selection parameter. The service switching unit 2906 can find the record identifiers of the service by obtaining the URL of the RemoteService instances specified with a call of the getLocator ( ) method. With the call of getIPAddress ( ) method, it can also find the IP address of the recording device in which this recorded service is recorded.

On the other hand, the service switching unit 2906 provides the Java program with the Java API for setting a key to decode the encryption of the encrypted MPEG-2 transport stream which is the substance of the recorded service. This key is an encrypted encryption key 2107 described in FIG. 21. The format of the method is setKey (KeySet [ ] keyset). The KeySet is a set of the encrypted encryption key 2107 and the media length 2108 of the portion encrypted thereby which have been described in the descriptions of the recording device. For example, in the case of lo the recorded service assigned with Record identifier 000 which has been encrypted as shown in FIG. 21, the KeySet array is {KeySet representing the set of Key 11 and 00:10, KeySet representing the set of Key 12 and 00:02, and KeySet representing the set of Key 13 and 00:03}.

The service switching unit 2906 reproduces the encrypted MPEG-2 transport stream inputted via the network by using the record identifiers of the recorded services, the IP address of the recording device, and the KeySet array. A detailed flow of this is described below.

First, the service switching unit 2906 determines the first byte position and the last byte position at which reproduction of an encrypted MPEG-2 transport stream is desired to be started and ended. The encrypted MPEG-2 transport stream is identified by the record identifier of the recorded service to be reproduced. In general, the byte position at which such reproduction is started is 0 because a recorded service is reproduced from the top. The last byte position at which the reproduction is desired to be ended is determined depending on the size of a temporary buffer included in the reproducing device. Reproduction of a media via a network is performed by repeating: obtaining the media data via the network, temporarily recording the media data in a temporary buffer, inputting it into a decoder, and when available space is secured in the buffer, obtaining and recording the next media data in the temporary buffer. Thus, it determines the last byte position at which the reproduction is desired to be ended according to the size of the temporary buffer.

Next, the service switching unit 2906 identifies the encrypted encryption key necessary for descrambling the encryption of the determined reproduction segment of the encrypted transport stream, based on the information obtained with the call of the setKey (KeySet [ ] keySet) method. Then, it extracts the key for decrypting the MPEG-2 transport stream from the encrypted encryption key by using the library. In other words, it applies, for the encrypted encryption key, the encryption decrypting scheme corresponding to a public key associated with the secret key used by the recording device. In this way, it is possible to extract the key for decrypting the encrypted MPEG-2 transport stream. Next, the service switching unit 2906 sets the extracted key for the decryption engine.

Next, the service switching unit 2906 sets, through the library 1701b, the destinations of outputs by the respective hardware structural elements according to paths shown in FIG. 27. Subsequently, it provides the JMF 1704a with the channel identifiers of the data to be reproduced. The channel identifier can be obtained by RemoteService getChannelNumber ( ). This allows the JMF 1704a to start reproduction of video and audio multiplexed on the MPEG-2 transport stream outputted from the TS decoder by performing the earlier-described operations. Further, it provides the channel identifiers of the data to be reproduced to the AIT monitoring unit 2402 of the AM 1704b. This allows the AM 1704b to execute and terminate the Java program multiplexed on the MPEG-2 transport stream outputted via the TS decoder 1302 according to the AIT multiplexed on the same MPEG-2 transport stream.

Next, the service switching unit 2906 gives, to the media obtaining unit 2904, three values of the record identifier, and the first byte position and the last byte position at which reproduction is desired to be started and ended which have been determined just before. Then, the media obtaining unit 2904 inputs, to the decryption engine 1315, the binary data corresponding to the byte position segment specified on the encrypted MPEG-2 transport stream identified by the record identifier as described earlier. The decryption engine decrypts the encrypted MPEG-2 transport stream by using the key inputted just before, and inputs it to the TS decoder. Since the settings for the JMF 1704a and the AM 1704b have been completed as described earlier, the video, audio and Java program of the recorded service are reproduced in sequence.

Subsequently, the service switching unit 2906 requests the media obtaining unit 2904 to obtain the next encrypted MPEG-2 transport stream so that the media obtaining unit 2904 can input encrypted MPEG-2 transport streams into the decryption engine without discontinuity. More specifically, it determines the last byte position at which the reproduction is desired to be ended according to the size of the temporary buffer regarding, as the first byte position at which the next reproduction is desired to be started, the next value of the last byte position at which the reproduction requested immediately before is ended. Subsequently, it gives, to the media obtaining unit 2904, three values of the record identifier, and the first byte position and the last byte position at which reproduction is desired to be started and ended. Together with this, it extracts the key for decrypting the portion, of the encrypted MPEG-2 transport stream, corresponding to the new reproduction segment according to the same method as described above, and sets it to the decryption engine. It is to be noted that there is no need to set the settings again as long as the decryption key is the same as the decryption key which has been set immediately before. By repeating this, it becomes possible to complete the reproduction of the encrypted MPEG-2 transport stream.

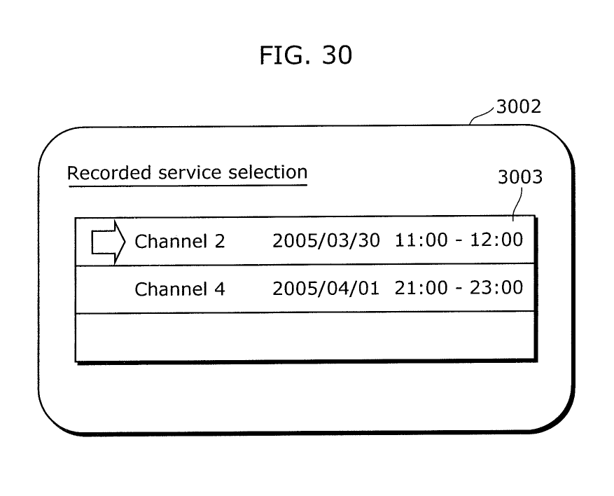

The reproduction specification Java program 2805 is software described in Java language to be downloaded by the AM 1704b onto the first memory unit 1308. It is, for example, a program of program name/a/TopXlet which is set in autostart in FIG. 22A. The reproduction specification Java program 1705 obtains a list of services recorded on the recording device in this embodiment, and directs reproduction of these services. First, the reproduction specification Java program calls fiterServices (ServiceFilterfilter) of the service listing unit 2905 by specifying RemoteFilter as the filter parameter to obtain all the currently present RemoteServices. For example, the reproduction specification Java program displays a list of recorded services represented by RemoteServices on the display screen 3002 shown in FIG. 30 so as to allow the user to make a selection. The user selects one of the recorded services by using an input device as shown in FIG. 14. The reproduction specification Java program obtains the record identifier of the selected recorded service RemoteService with a call of the getRecordID ( ) method. Subsequently, the reproduction specification Java program 2805 makes the call by specifying the RemoteService selected by the user just before as the select (Service selection) method of the service switching unit 2906. Then, the service switching unit 2906 starts reproduction of the recorded service specified via the network by performing the earlier-described operations.

The software structure and functions of the reproducing device in this embodiment have been described above.

As described above, this embodiment allows the broadcast station side system and the download application to set the priority levels and the priority level revision standards of the respective terminals connected via the network according to the contract information and the like.

Further, this allows, in the case where resource contention occurs between applications on a plurality of terminals, resource (device) allocation according to the priority levels which have been dynamically revised based on the states of the respective terminals and the purposes for using the resources.

### Embodiment 2

Embodiment 1 has described a method where the device contention resolving manager 1706 causes the priority level revision processing unit 4103 to revise priority levels with reference to revision standards which have already been set by the priority level revision standard setting unit 4102 when device contention occurs.

This embodiment describes a method where the device contention resolving manager 1706 causes the priority level revision processing unit 4103 to make an inquiry to a handler which has been set by a download application and revise priority levels when device contention occurs. In other words, the priority level revision processing unit 4103 corresponding to the priority level deriving unit passes, to a handler of a downloaded application program, the arguments indicating the base priority levels of the respective terminals (requesting devices) shown by the base priority level data, and either the arguments of the states of the respective requesting devices or the arguments of the types of requests from the respective requesting devices, and executes, as the deriving processing, the processes up to the process of obtaining the priority levels of the respective requesting devices derived by the handler.

An inter-terminal network communication system, a hardware structure, a software structure, various data formats, and the like which relate to this embodiment are the same as those in Embodiment 1 except for FIG. 42 and FIG. 41. Thus, the drawings used for Embodiment 1 are used. Among the structural elements in the drawings, the structural elements which have the same functions as those in the aforementioned embodiment are not described here again.

In this embodiment, the device contention resolving manager 1706 revises priority levels by making an inquiry to the handler which has been set by the Java program. In other words, the functions provided by the priority level revision standard setting unit 4102 and the priority level revision processing unit 4103 in Embodiment 1 are provided by the priority level revision handler registering unit 5302 and the priority level revision processing unit 4103 in this embodiment. The base priority level setting to the priority level setting unit 4101 and device allocation by the device contention resolving processing unit 4104 are the same in those in Embodiment 1.

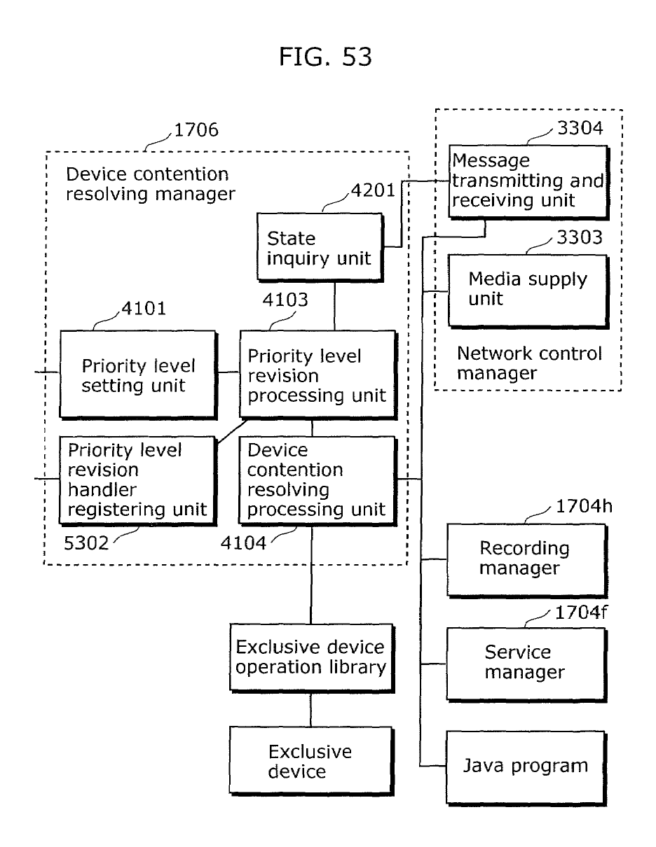

FIG. 53 shows the internal structure of the device contention resolving manager 1706 in this embodiment. The device contention resolving manager 1706 includes a priority level setting unit 4101, a priority level revision handler registering unit 5302, a priority level revision processing unit 4103, and a device contention resolving processing unit 4104. Further, when the priority level revision processing unit 4103 makes an inquiry about the state of a request-source terminal for device allocation via a network, it includes a state inquiry unit 4201.

In FIG. 53, the structural elements other than the priority level revision handler registering unit 5302 and the priority level revision processing unit 4103 have the same functions as those of the structural elements having the same names and reference numerals in Embodiment 1, and thus the descriptions are not repeated.

In this embodiment, as in Embodiment 1, descriptions are given of the internal structure of the device contention resolving manager 1706 shown in FIG. 53, taking an example of the inter-terminal network communication system 4405 shown in FIG. 44.

In addition, as in the descriptions of the device contention resolving manager 1706 in Embodiment 1, it is assumed that the content recording and transmitting device 3201 includes two tuners called “tuner A” and “tuner B” in this embodiment. In addition, it is assumed that the network band can simultaneously transmit two streams at the most, and the respective bands are called “network band A” and “network band B”.

The device contention resolving manager 1706 in this embodiment achieves the functions equivalent to those of the priority level revision standard setting unit 4102 and the priority level revision processing unit 4103 in the case of applying the priority level revision according to the “revision standards for request types” and the priority level revision according to the “revision standards for the states of request-source terminals” in Embodiment 1.

Descriptions are given of the functions of the priority level revision handler registering unit 5302.

The priority level revision handler registering unit 5302 provides an API which registers a priority level revision handler to the Java program.

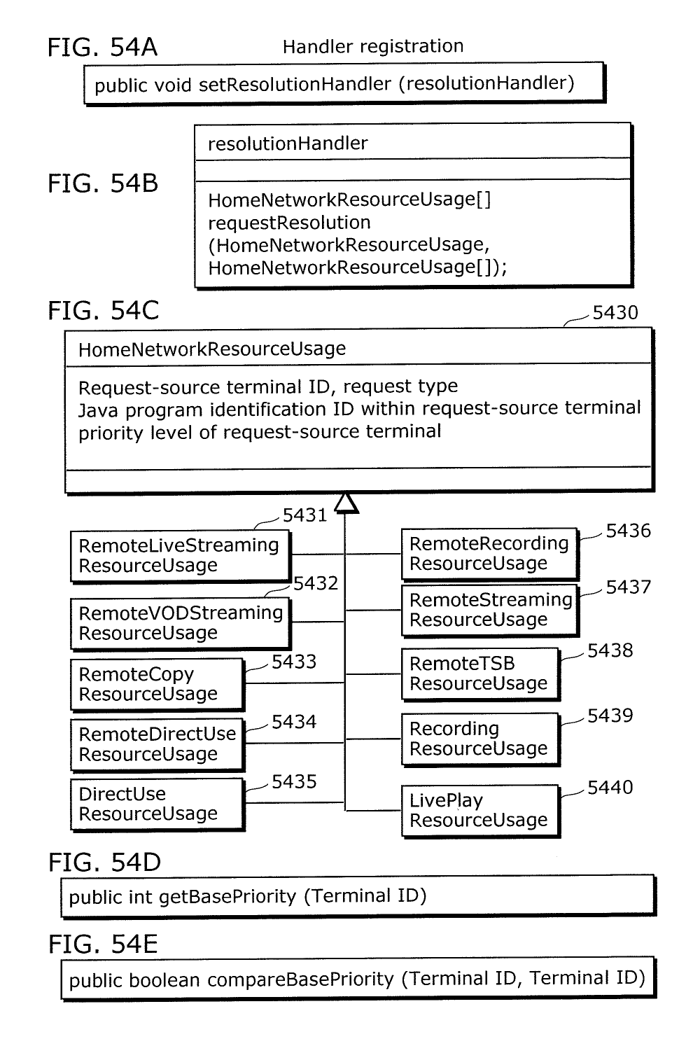

FIGS. 54A to 54E are examples of an API which the device contention resolving manager 1706 provides to the Java program.

The Java program registers a handler called by the device contention resolving manager when device contention occurs by “public void setResolutionHandler (resolutionHandler)” shown in FIG. 54A. An argument “resolutionHandler” is the interface definition of the handler. The Java program implements this “resolutionHandler”, and registers the implemented handler. In other words, the Java program (privileged program) which mounts a handler registers the handler in the device contention resolving manger 1706 by using the API shown in FIG. 54A. By doing so, the device contention resolving manger 1706 can use the handler.

The definition of the “resolutionHandler” is shown in FIG. 54B. The “resolutionHandler” shown in FIG. 54B is called by the device contention resolving manager at the time when the device contention occurs. More specifically, the “HomeNetworkResourceUsage[ ]requestResolution (HomeNetworkResourceUsage, HomeNetworkResourceUsage[ ]);” implemented by the “resolutionHandler” is called.

The first argument HomeNetworkResourceUsage is a Java object indicating the “device allocation request” which requests for the new use of devices at the time when device contention occurs, and the second argument HomeNetworkResourceUsage[ ] is a Java object indicating the “device allocation request” which already uses the devices. Here, the present invention is applicable to a method where “device allocation requests” are passed irrespective of a time sequence order, for example, a method where it is assumed that the argument of requestResolution is only HomeNetworkResourceUsage[ ] to which all the “device allocation requests” including the new request is given.

Next, a definition of HomeNetworkResourceUsage is shown. FIG. 54C shows examples of a class of HomeNetworkResourceUsage 5430 and the classes which succeed the HomeNetworkResourceUsage. The HomeNetworkResourceUsage shown in 54C and the succeeding subclasses are arguments to be passed to the “resolutionHandler”. The HomeNetworkResourceUsage and the succeeding subclasses hold a “request source terminal ID”, a “request type”, and a “request-source Java program ID” (the ID of the Java program in the request-source terminal). Here, values held by the “device allocation requests” are set as the “request-source terminal ID” and the “request type”. Here, the HomeNetworkResourceUsage is generated by the priority level revision processing unit 4103 which has received a plurality of “device allocation requests” from the device contention resolving processing 4104 and has been requested to set the priority levels. Here, it is assumed that the request types are shown in the handler in form of the types of classes which succeed the HomeNetworkResourceUsage.

Descriptions are given of the subclasses which succeed the HomeNetworkResourceUsage 5430 illustrated in FIG. 54C.

RemoteLiveStreamingResourceUsage 5431 is a subclass showing that the request type is Live streaming reproduction (streaming transmission via a network of a broadcast service) 4317.

RemoteVODStreamingResourceUsage 5432 is a subclass showing that the request type is VOD streaming reproduction (VOD streaming transmission via a network) 4318.

RemoteCopyResourceUsage 5433 is a subclass showing that the request type is copy (copy of a recorded service via a network) 4319.

RemoteDirectUseResourceUsage 5434 is a subclass showing that the request type is device rental (direct use of devices via a network) 4320.

DirectUseResoourceUsage 5435 is a subclass showing that the request type is device direct use 4314.

RemoteRecordingResourceUsage 5436 is a subclass showing that the request type is remote reservation recording (reservation recording from a remote terminal) 4315.

RemoteStreamingResourceUsage 5437 is a subclass showing that the request type is streaming reproduction (streaming transmission of a recorded service via a network) 4316.

RemoteTSBResourceUsage 5438 is a subclass showing that the request type is a remote TSB (time shift buffer via a network) 4321.

RecordingResourceUsage 5439 is a subclass showing that the request type is reservation recording 4311.

LivePlayResourceUsage 5440 is a subclass showing that the request type is broadcast service reproduction 4313.

The Java program which has registered the handler can judge the request types based on the types of HomeNetworkResourceUsage classes passed as arguments. It is to be noted that the present invention is applicable even when an API which obtains the request types are provided, for example, when “getRequestType( )” is provided for the respective classes succeeding the HomeNetworkResourceUsage.

The Java program which has registered the handler can obtain the terminal IDs of the request-source terminals from the HomeNetworkResourceUsage, and can further obtain the base priority levels of the respective terminals which have been set by the priority level setting unit 4101 by using “public int getBasePriority (terminal ID)” shown in FIG. 54D. More specifically, the Java program can obtain the priority levels of the terminals corresponding to the terminal IDs passed as arguments in FIG. 45A. Otherwise, the Java program can compare the base priority levels of the respective HomeNetworkResourceUsage by obtaining the terminal IDs of the request-source terminals from the HomeNetworkResourceUsage, and by using the “public boolean compareBasePriority” (terminal ID, terminal ID) shown in FIG. 54E.

Next, descriptions are given of the functions of the priority level revision processing unit 4103 in this embodiment.

The “revision for request types” and the “revision for the states of request-source terminals” are described below in this sequence.

First, descriptions are given of the functions of the priority level revision processing unit 4103 which implements the “revision for request types”.

When the priority level revision processing unit 4103 receives a plurality of “device allocation requests” from the device contention resolving processing unit 4104 at the time of occurrence of device contention, and receives a request for setting the priority levels, it generates HomeNetworkResourceUsage corresponding to the received “device allocation requests”, calls “HomeNetworkResourceUsage[ ] requestResolution (HomeNetworkResourceUsage, HomeNetworkResourceUsage[ ]);” and passes it to the Java program which has registered the handler.

The Java program which has registered the handler obtains, for the HomeNetworkResourceUsage corresponding to each “device allocation request” passed as an argument, the base priority levels which have been set by the priority level setting unit 4101 and the request types which have been set by the device contention resolving processing unit 4104, by using the API shown in the above FIG. 54C to 54E.

Subsequently, the Java program handler prioritizes the priority levels of the HomeNetworkResourceUsage corresponding to the “device allocation requests”, by using the obtained base priority levels and request types as judgment standards.

The priority level revision processing unit 4103 determines the priority levels of the “device allocation requests” according to the priority order determined by the handler.

The operations of the priority level setting unit 4101 and the device contention resolving processing unit 4104 are the same as those in the above-described Embodiment 1.

With the API shown in FIGS. 54A to 54E, the device contention resolving manager 1706 in this embodiment achieves the functions equivalent to those of the priority level revision standard setting unit 4102 and the priority level revision processing unit 4103 in the case of applying the “revision standards for request types” in Embodiment 1.

In other words, the device contention resolving manger 1706 can set (revise) the priority levels of the “device allocation requests” to the respective request types by the API shown in FIGS. 54A to 54E. In other words, the priority level revision processing unit 4103 in this embodiment passes “device allocation requests” to the handler of the Java program and causes the handler to prioritize these priority levels so that these priority levels are determined based on the priority order of the priority levels.

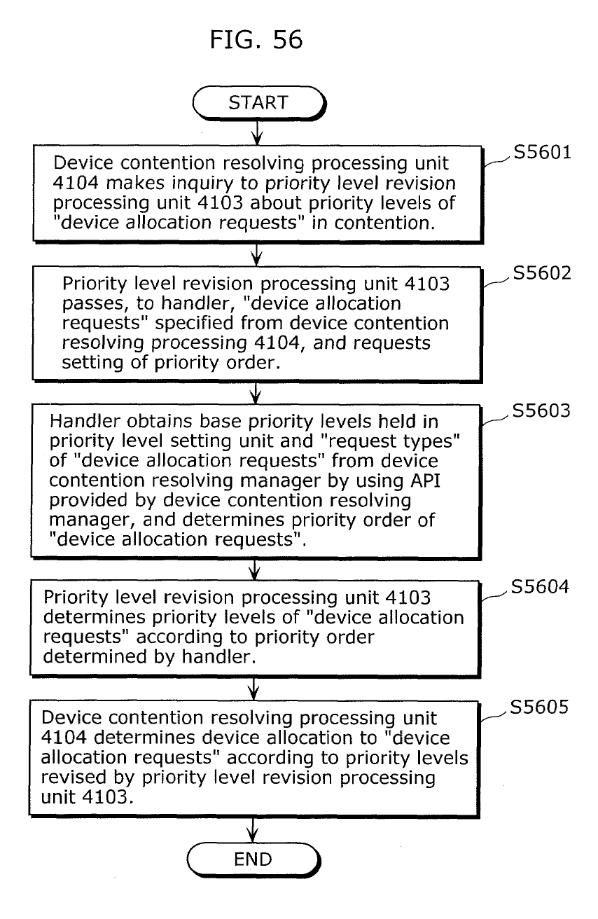

FIG. 56 shows a simple flow of the processing for achieving the “revision for request types” by an inquiry to the handler.

Next, descriptions are given of the functions of the priority level revision processing unit 4103 which implements the “revision for the states of request-source terminals”.

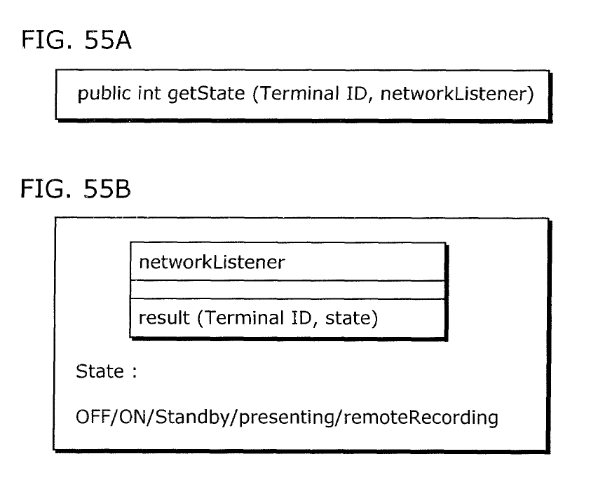

FIGS. 55A to 55B are examples of an API which the device contention resolving manager 1706 provides to the Java program.

The priority level revision processing unit 4103 provides the API shown in FIGS. 55A to 55B, in addition to the API, described in FIGS. 55A to 55E, which the priority revision handler registering unit 5302 provides to the Java program.

The Java program which has registered the handler can obtain the terminal ID of the request-source terminal from the HomeNetworkResourceUsage, and can further obtain the “state” of each terminal by using the “public int getState (terminal ID, networkListener)” shown in FIG. 55A. When the “public int getState (terminal ID, networkListener)” is called, the priority level revision processing unit 4103 passes the terminal IDs passed as arguments to the state inquiry unit 4201 and obtains the states of the request-source terminals via the network as in Embodiment 1. Subsequently, it calls the “networkListener” received as the argument and notifies the state of each Java program terminal which has registered the handler. FIG. 55B shows an example of a definition of networkListener.

When the priority level revision processing unit 4103 receives a plurality of “device allocation requests” from the device contention resolving processing unit 4104 at the time of occurrence of device contention, and receives a request for setting the priority levels, it generates HomeNetworkResourceUsage corresponding to the received “device allocation requests”, calls “HomeNetworkResourceUsage[ ] requestResolution (HomeNetworkResourceUsage, HomeNetworkResourceUsage[ ]);” and passes it to the Java program which has registered the handler.

The Java program which has registered the handler can obtain the base priority levels which have been set by the priority level setting unit 4101, to the HomeNetworkResourceUsage corresponding to the “device allocation request” passed as the argument, by using the API shown in the above FIG. 54C to 54E.

Further, the Java program obtains the terminal ID of the request-source terminal from the HomeNetworkResourceUsage, and obtains the “state” of the HomeNetworkResourceUsage corresponding to the each “device allocation request”, by using the API shown in FIGS. 55A and 55B.

Subsequently, the handler of the Java program prioritizes the priority levels of the HomeNetworkResourceUsage corresponding to the “device allocation requests”, by using the obtained base priority levels and the states of the request-source terminals as judgment standards.

The priority level revision processing unit 4103 determines the priority levels of the “device allocation requests” according to the priority order determined by the handler.

The operations of the priority level setting unit 4101 and the device contention resolving processing unit 4104 are the same as those in the above-described Embodiment 1.

With the API shown in FIGS. 54A to 54E and the API shown in FIGS. 55A and 55B, the device contention resolving manager 1706 in this embodiment achieves the functions equivalent to those of the priority level revision standard setting unit 4102 and the priority level revision processing unit 4103 in the case of applying the “revision standards for request types” in Embodiment 1.

In other words, the device contention resolving manger 1706 can set (revise) the priority levels of the “device allocation requests” to the states of the respective request-source terminals by the API shown in FIGS. 54A to 54E and the API shown in FIGS. 55A and 55B.

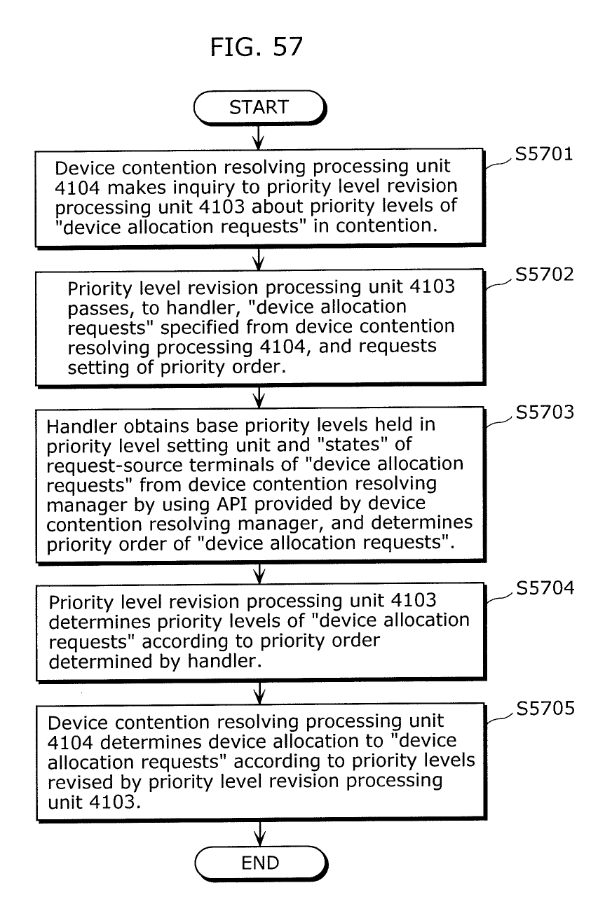

FIG. 57 shows a simple flow of the processing for achieving the “revision for the states of request-source terminals” by an inquiry to a handler.

As described above, this embodiment allows the broadcast station side system and the download application to set the priority levels and the priority level revision standards of the respective terminals connected via the network according to the contract information and the like.

Further, this allows, in the case where resource contention occurs between applications on a plurality of terminals, resource allocation according to the priority levels which have been dynamically revised based on the states of the respective terminals and the purposes for using the resources (devices) by making an inquiry to the download applications (Java programs) which register the handler.

### Embodiment 3

The priority level revision processing unit 4103 sets the priority levels of the “device allocation requests” in the above-described Embodiments 1 and 2. In this embodiment, the priority level revision processing unit 4103 sets the priority levels of the request-source terminals connected via a network.

An inter-terminal network communication system, a hardware structure, a software structure, various data formats, and the like which relate to this embodiment are the same as those in Embodiment 1. Thus, the drawings used for Embodiment 1 are used. Among the structural elements in the drawings, the structural elements which have the same functions as those in the aforementioned embodiment are not described here again. Only the differences from the above-described embodiments are described below.

In this embodiment, the device contention resolving unit 4104 passes, as the terminal IDs to the revision processing unit 4103, the “request-source terminal IDs” (terminal IDs) held by the plurality of “device allocation requests” in contention, and makes an inquiry about the priority levels of the “request-source terminals”.

The priority level revision processing unit 4103 in this embodiment sets, to the terminals identified by the received plurality of terminal IDs, the priority levels of the “request-source terminals” with the received terminal IDs with reference to the base priority levels which have been set by the priority level setting unit 4101 and the revision standards which have been set by the priority level revision standard setting unit 4102.

The priority level revision according to the “revision standards for request types” and the priority level revision according to the “revision standards for the states of request-source terminals” in this embodiment are described below in this sequence.

First, descriptions are given of the priority level revision according to the “revision standards for request types” in this embodiment.

The priority level revision processing unit 4103 in this embodiment determines the priority levels of the received plurality of “request-source terminal IDs”, according to the following procedure.

First, the priority level revision processing unit 4103 obtains the request types by passing the respective “request-source terminal IDs” to the device contention resolving processing unit 4104. Subsequently, it obtains the priority level revision standards (Highest/No change/Lowest) corresponding to the request types of the respective “request-source terminals” with reference to FIG. 46A.

Here, in the case where a “request-source terminal” makes a plurality of processing requests, it is assumed that the type of the processing request requiring the higher revision standard is employed.

Secondly, the priority level revision processing unit 4103 extracts the “request-source terminal ID” which is associated with a request type assigned with the priority level revision standard “Highest” shown in FIG. 46A and which has been obtained by using the first procedure. In the case where only one “request-source terminal ID” is extracted, the “request-source terminal” identified by the request-source terminal ID is assigned with Priority level “1”. In the case where two or more “request-source terminal IDs” are extracted, it obtains the base priority levels shown in FIG. 45A by using, as keys, the IDs of the request-source terminals which have made the “device allocation requests”, and sets the priority levels of the plurality of “request-source terminals” identified by the request-source terminal IDs in the order according to the base priority levels. In the case where no “request-source terminal ID” is extracted, it does nothing.

Thirdly, the priority level revision processing unit 4103 extracts the “request-source terminal ID” which is associated with a request type assigned with the priority level revision standard “No change” shown in FIG. 46A and which has been obtained by using the first procedure. In the case where only one “request-source terminal ID” is extracted, it sets, to the extracted “request-source terminal” identified by the request-source terminal ID, the priority level next to the priority level which the priority level revision processing unit 4103 has set to the “request-source terminal” identified by the request-source terminal ID extracted in the case of the priority level revision standard “Highest”. In the case where two or more “request-source terminal IDs” are extracted, it obtains the base priority levels shown in FIG. 45A by using, as keys, the IDs of the request-source terminals which have made the “device allocation requests” identified by the request-source terminal IDs, and sets the priority levels of the “request-source terminals” identified by the terminal IDs in the order according to the base priority levels. Here, it sets the priority level next to the priority level which the priority level revision processing unit 4103 has set to the “request-source terminal” identified by the terminal ID extracted in the case of the priority level revision standard “Highest”. In the case where no “request-source terminal ID” is extracted, it does nothing.

Fourthly, the priority level revision processing unit 4103 extracts the “request-source terminal ID” which is associated with a request type assigned with the priority level revision standard “Lowest” shown in FIG. 46A and which has been obtained by using the first procedure. In the case where only one “request source terminal ID” is extracted, it sets, to this extracted request-source terminal, the priority level next to the priority level which the priority level revision processing unit 4103 has set to the “request-source terminal” identified by the request-source terminal ID extracted in the case of the priority level revision standard “No change”. In the case where two or more “request-source terminal IDs” are extracted, it obtains the base priority levels shown in FIG. 45A by using, as keys, the IDs of the request-source terminals which have made the extracted plurality of “request-source terminals”, and sets the priority levels of the “request-source terminals” identified by the request-source terminal IDs in the order according to the base priority levels. Here, it sets the priority level next to the priority level which the priority level revision processing unit 4103 has set to the “request-source terminal” extracted in the case of the priority level revision standard “No change”. In the case where no “request-source terminal ID” is extracted, it does nothing.

Next, descriptions are given of the priority level revision according to the “revision standards for the states of request-source terminals” in this embodiment.

In the case where the revision standards are the revision standards for the states of request-source terminals, the priority level revision processing unit 4103 in this embodiment determines the priority levels of the “request-source terminals” with the received terminal IDs (request-source terminal IDs) according to the procedure indicated below.

First, from among the plurality of request-source terminals, the priority level revision processing unit 4103 extracts the “request-source terminals” with the request-source terminal IDs different from the terminal ID of the terminal which mounts the device contention resolving manager 1706. Subsequently, it obtains the state of each of the extracted “request-source terminal IDs” of the respective request-source terminals in the same manner as the method described in Embodiment 1. As in Embodiment 1, it is assumed here that, in the case where a “request-source terminal” is in the two or more states from among the earlier-described “states of the request-source terminals” or from among the “device allocation states”, the state requiring the higher revision standard is employed.

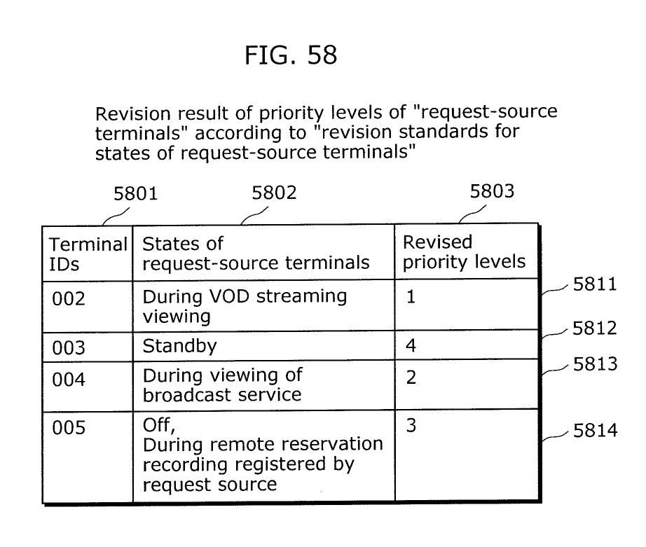

A column 5802 in FIG. 58 describes examples of obtained states. Secondly, the priority level revision processing unit 4103 extracts the “request-source terminal ID” which has the state obtained according to the first procedure and is assigned with the priority level revision standard “Highest” shown in FIG. 47A. In the case where only one “request-source terminal ID” is extracted, the “request-source terminal” identified by the request-source terminal ID is assigned with a priority level of “1”. In the case where two or more “request-source terminal IDs” are extracted, it obtains the base priority levels shown in FIG. 45A by using, as keys, the IDs of the plurality of “request-source terminals”, and sets the priority levels of the “request-source terminals” identified by the request-source terminal IDs in the order according to the base priority levels. In the case where no “request-source terminal ID” is extracted, it does nothing.

More specifically, as shown in a column 5803 in FIG. 58, the “request-source terminal” identified as Terminal ID=002 and is in a state of“VOD streaming viewing” is assigned with the priority level 1 according to the above-described first and second procedures.

Thirdly, the priority level revision processing unit 4103 extracts the “request-source terminal ID” which is associated with the request type assigned with the priority level revision standard “No change” shown in FIG. 47A and the “request-source terminal” in response to which no state is or can be obtained according to the first procedure. In the case where only one “request-source terminal ID” is extracted, it sets, to the extracted “request-source terminal” identified by the request-source terminal ID, the priority level next to the priority level which has been set by the priority level revision processing unit 4103 to the “request-source terminal” identified by the request-source terminal ID extracted in the case of the priority level revision standard “Highest”. In the case where two or more “request-source terminal IDs” are extracted, it obtains the base priority levels shown in FIG. 45A by using, as keys, the IDs of the plurality of request-source terminals, and sets the priority levels of the “request-source terminals” identified by the request-source terminal IDs in the order according to the base priority levels. Here, it sets the priority level next to the priority level which the priority level revision processing unit 4103 has set to the “request-source terminal” identified by the request-source terminal ID extracted in the case of the priority level revision standard “Highest”. In the case where no “request-source terminal ID” is extracted, it does nothing.

More specifically, as shown in FIG. 58, the “request-source terminals” identified as Terminal ID=002, Terminal ID=004, and Terminal ID=005 are assigned with the priority levels 1 to 3 according to the third procedure. Here, the revision standard of “No change” is applied to the “request-source terminal” identified as Terminal ID=005. This is because remote reservation recording registered from the “request-source terminal” identified as Terminal ID=005 is being executed although the “request-source terminal” is in an Off state.

Fourthly, the priority level revision processing unit 4103 extracts the “request-source terminal ID” corresponding to the state which has been obtained according to the first procedure and is shown as the priority level revision standard “Lowest” in FIG. 47(1). In the case where only one “request-source terminal ID” is extracted, it sets, to this extracted “request-source terminal” identified as the request-source terminal ID, the priority level next to the priority level which the priority level revision processing unit 4103 has set to the “request-source terminal” identified as the request-source terminal ID extracted in the case of the priority level revision standard “No change”. In the case where two or more “request-source terminal IDs” are extracted, it obtains the base priority levels shown in FIG. 45A by using, as keys, the IDs of the plurality of request-source terminals which have made the “device allocation requests”, and sets the priority levels of the plurality of “request-source terminals” identified as the request-source terminal IDs in the order according to the base priority levels. Here, it sets the priority level next to the priority level which the priority level revision processing unit 4103 has set to the “request-source terminal” identified as the request-source terminal ID extracted in the case of the priority level revision standard “No change”. In the case where no “request-source terminal ID” is extracted, it does nothing.

More specifically, there remain no such states through the fourth procedure, it does nothing. Here, as described above, the revision standard of “No change” is applied to the “request-source terminal” identified as Terminal ID=005. This is because remote reservation recording registered from the “request-source terminal” identified as Terminal ID=005 is being executed although the “request-source terminal” is in an Off state.

The device contention resolving processing unit 4104 lo performs device allocation to the “device allocation request”, according to the priority level of the “request-source terminal” which has been set by the priority level revision processing unit 4103.

Here, in the case where the plurality of “device allocation requests” have the same request-source terminal ID and priority level, it allocates devices preferentially to the “device allocation request” with the highest priority level within the request-source terminal with reference to the priority levels within the request-source terminal shown in the column 4804 in FIG. 48. It is to be noted that, in the case where the priority level within the request-source terminal is not specified, the device contention resolving processing unit 4104 determines the device allocation based on its unique judgment.

Here, in this embodiment, the priority level revision processing unit 4103 sets the priority levels to the “request-source terminals” when device contention occurs. However, the present invention is applicable when another timing is selected as long as the timing allows the priority level revision processing unit 4103 to set the priority levels to the “request-source terminals” based on the current base priority levels, the current revision standards, the current request types or states of the request-source terminals when the device contention occurs. More specifically, in the case of the priority level revision according to the “revision standards for the states of request-source terminals”, the present invention is applicable even in the case of employing a method where the priority level revision processing unit 4103 sets the priority levels of the “request-source terminals” each time of changing the timing of changing the state of a terminal device on the inter-terminal network communication system or the timing of changing a revision standard. In the case of employing a method where the priority level revision processing unit 4103 sets the priority levels of the “request-source terminals” at each timing of changing a revision standard which is set by the priority level revision standard setting unit 4102, a valid period of the revision standard is received.

### Embodiment 4

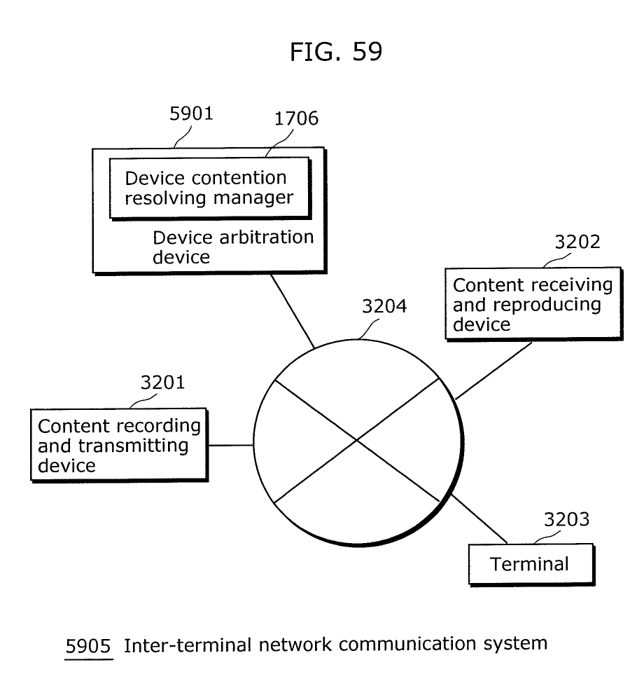

In the above-described Embodiments 1 to 3, the device contention resolving manager 1706 is mounted on the recording device (content recording and transmitting device 3201). However, as shown in FIG. 59, the present invention can be carried out also in the case where such device contention manager is mounted on a terminal other than the recording device (content recording and transmitting device 3201).

In this embodiment, a device arbitration device 5901 shown in FIG. 59 mounts the device contention resolving manager 1706.

In this embodiment, the recording device 3201 requests the device contention resolving manager 1706 on another terminal connected to the network 3204 to allocate devices. More specifically, in the case where each of the request processing programs mounted on the recording device 3201 receives a processing request such as a remote reservation recording request, a reproduction request, streaming reproduction (streaming reproduction via a network), VOD streaming reproduction, and device rental, the recording device 3201 requests the device contention resolving manager 1706 mounted on a device arbitration device 5901 to allocate devices via the network control unit 1312.

The device contention resolving manager 1706 receives the settings of the base priority levels of the respective terminals on an inter-terminal network communication system 5905 and the settings of the revision standards according to the method described in the aforementioned Embodiments 1 to 3. Subsequently, at the time when a device allocation request is made, it determines allocation of the devices such as the tuner mounted on the request-source terminal and network bands according to the priority levels revised by the priority level revision processing unit 4103.

Subsequently, the device contention resolving manager 1706 returns, via the network 3204, the result of the device allocation to the terminal which made the device allocation request.

Here, the present invention is applicable even in the case of taking a method for determining allocation of the devices mounted on the respective terminals on the network communication system 5905, in addition to the devices mounted on the request-source terminal.

### Embodiment 5

In the above-described Embodiments 1 to 4, in the case where devices mounted on a recording device is contended for, device allocation is executed within the range of the number of the devices mounted on the terminal. Therefore, it is impossible to allocate devices in number exceeding the absolute number of the devices mounted on the terminal.

This embodiment employs a mechanism for borrowing devices mounted on other terminals connected to the network in the case where the number of the devices mounted on the recording device is less than required.

An inter-terminal network communication system, a hardware structure, a software structure, various data formats, and the like which relate to this embodiment are basically the same as those in the above-described Embodiments 1 to 4. Thus, the drawings used for those embodiments are used.

This embodiment is described taking, as examples, the two terminals X and Y which belong to the same inter-terminal network communication system. In this embodiment, it is assumed that each of the terminal X and the terminal Y includes the same hardware structure and software structure as those of the recording device in the above-described Embodiments 1 to 4 except for the following details described in this embodiment hereinafter. Among the structural elements of the terminal X and the terminal Y, the structural elements which have the same functions as those in the above-described Embodiments 1 to 4 are not described here again. Only the differences from the above-described Embodiments 1 to 4 are described below.

In this embodiment, in the case where a plurality of device allocation requests are made by processing execution programs such as the recording manager 1704h, the media supply unit 2303, and the service manager 1704f, and Java programs, and thereby the absolute number of the devices is less than required, the device contention resolving manager 1706 included in the terminal X requests for a device use right mounted on another terminal Y connected via the network.

The device contention resolving manager 1706 of the terminal Y allocates devices to the “device allocation request” associated with a request type of device rental (direct use of devices via a network) and a request-source ID identifying the terminal X, according to the method described in Embodiment 1. Subsequently, the device contention resolving manager 1706 of the terminal Y returns, to the request-source terminal X, the result showing whether or not the device use right is given to the terminal X.

Subsequently, in the case where the response from the terminal Y indicates a successful obtainment of the device use right, the recording device X gives the use right of the devices on the terminal Y to the processing execution program or the Java program whichever has made the processing request for the terminal X. The processing execution program or the Java program whichever has been assigned with the device use right executes the processing by using the devices.

As described in Embodiment 4, it is to be noted that the present invention is applicable even in the case where the device contention resolving manager 1706 is mounted on a terminal independent from the terminal X and the terminal Y.

As described above, it is possible to allocate devices including devices of other terminals connected to the network to increase the rate of successful device allocation.

### (Variation)

The above-described Embodiments 1 to 5 are mere implementations of the present invention, and therefore, other implementations can be carried out as long as the scope of the present invention is achieved. In addition, main operations in the respective embodiments may be selected and combined to form another implementation.

Those Embodiments 1 to 5 describe an example where a terminal has a public encryption key for further encrypting an encryption key for an MPEG-2 transport stream, but an arbitrary method for obtaining such key may be employed. For example, such key may be obtained via a network.

A key implemented as hardware such as an encryption engine and a decryption engine may be implemented as software.

In addition, those Embodiments 1 to 5 show the structures for cable systems, but the present invention is not dependent on the types of broadcasting systems. For example, the present invention can be easily applied to a satellite system, a terrestrial wave system, or a broadcast distribution system by using an IP network. Further, the present invention does not have any direct relationship with the differences between the respective broadcasting systems, and thus is applicable by using an arbitrary communication medium irrespective of broadcasting systems. The present invention does not depend on which one of the wired communication and wireless communication is used.

An AV decoder is not always required to decode video and audio simultaneously. The present invention is applicable even in the case of employing a configuration where a video decoder and an audio decoder are separate. In addition, there is no problem when the AV decoder has a function to decode data such as closed caption. The audio signal and video signal decoded by the AV decoder may be encrypted at any stage before they are accumulated in a memory area 1504.

In addition, those Embodiments 1 to 5 describe examples where an adaptor for controlling limited viewing is introduced, but such adaptor is not always necessary for achieving the present invention. Such adaptor may have any format, and it is also possible to employ a configuration without such adaptor. In this case, in FIG. 15, an MPEG-2 transport stream through a tuner is inputted directly to the TS decoder. The present invention is applicable also in this case. In addition, there is no need to descramble viewing-limiting encryption by the adaptor before the processing by the TS decoder. It is easy to employ a configuration where viewing-limiting encryption is descrambled at any stage by using such adaptor, and the present invention is applicable in such case.

The AV encoder may employ any coding formats of an audio signal and a video signal. The present invention is applicable irrespective of encoding formats.

A multiplexer may employ an arbitrary multiplexing format. The present invention is applicable irrespective of multiplexing formats.

The display and the speaker may be included in a broadcast recording and reproducing device, and an external display and an external speaker may be connected to the broadcast recording and reproducing device. The present invention is applicable irrespective of the locations and the number of displays and speakers.

The present invention is applicable in the case of employing a system where a CPU itself executes all or some of the processing of TS decoding, AV decoding, AV encoding, and multiplexing.

As for service recording schemes, it is also good to directly record, in the memory area, MPEG-2 transport stream through the tuner without using a TS decoder, and it is also good to cause a translator for translating the format of MPEG-2 transport stream through the tuner and to record them in the memory area. The present invention is applicable irrespective of service recording schemes.

Some of Java virtual machines translate byte codes into execution formats which can be interpreted by a CPU, passes the formatted data to be executed to the CPU. The present invention is applicable also in this case.

The above-described Embodiments 1 to 5 describe a method for implementing an AIT assuming that transport streams are obtainable from In-band, but approaches for referring to Java programs which should be executed by AMs are not limited to this approach by using such AIT. The OCAP intended for use in the United States cable system uses an XAIT which transfers synchronized data similar to those transferred by an AIT in OOB. Other conceivable methods include activating a program which has been recorded in an ROM and activating a program which has been downloaded and recorded in the second memory.

The DSMCC file system and AIT files may have arbitrary recording schemes.

The present invention is applicable also in the case of combining a scheme for obtaining, through filtering, AIT sections from an MPEG-2 transport stream and a scheme for recording DSMCC sections in files according to a unique format. In addition, the present invention is applicable also in the case of combining a scheme for obtaining, through filtering, DSMCC sections from an MPEG-2 transport stream and a scheme for recording AIT sections in files according to a unique format.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The content processing device and the content processing method according to the present invention are applicable in the consumer device industry according to the devices for recording and reproducing broadcast. For example, the present invention can be implemented as a recording and reproducing device, a cable STB, a digital TV and the like. Further, for example, the present invention is applicable to mobile phones which have devices with a function for receiving broadcast.

What is claimed is:

1. A content processing device which executes processing on a content in response to a request from one of requesting devices, said content processing device comprising:
a reproducing unit configured to reproduce a content;
a transfer unit configured to transfer a content to at least one of the requesting devices; and
a device contention resolving unit configured to resolve a contention between the requesting devices for use of a resource device required for reproduction by said reproducing unit and transferring by said transfer unit, the contention occurring in the case where each of the requesting devices requests said reproducing unit to reproduce the content or requests said transfer unit to transfer the content,
wherein said device contention resolving unit includes:
a priority level holding unit configured to hold base priority level data indicating, as base priority levels, priority levels in the use of the resource device, the priority levels being assigned to the respective requesting devices;
a priority level deriving unit configured to execute deriving processing of deriving priority levels of the requests made by the respective requesting devices, based on: either states of the respective requesting devices or request types of the requests made by the respective requesting devices; and the base priority levels of the respective requesting devices indicated by the base priority level data; and
a resolving processing unit configured to determine one of the requests to be a request for which the use of the resource device is allowed, according to a priority order of the requests assigned with the priority levels derived in the deriving processing executed by said priority level deriving unit, and
wherein, depending on the request determined by said resolving processing unit,
said reproducing unit reproduces the content by using the resource device, or
said transfer unit transfers the content by using the resource device.

2. The content processing device according to claim 1,
wherein said device contention resolving unit further includes
a priority level setting unit configured to determine the base priority levels of the respective requesting devices, and hold, in said priority level holding unit, the base priority level data indicating the determined base priority levels.

3. The content processing device according to claim 1,
wherein said device contention resolving unit further includes
a priority level setting unit configured to receive the base priority levels of the respective requesting devices from a device or an application program, and hold, in said priority level holding unit, the base priority level data indicating the received base priority levels.

4. The content processing device according to claim 1,
wherein said device contention resolving unit further includes
a standard data holding unit configured to hold standard data indicating priority level standards for each of the states of the respective requesting devices or for each of the request types of the requests, and
said priority level deriving unit executes, as the deriving processing, a process of identifying provisional priority levels of the requests made by the respective requesting devices, based on the priority level standards indicated by the standard data, and a process of revising the provisional priority levels according to the base priority levels of the respective requesting devices indicated by the base priority level data.

5. The content processing device according to claim 1,
wherein said priority level deriving unit executes, as the deriving processing, a process of passing, to a handler of a downloaded application program, arguments indicating the base priority levels of the respective requesting devices indicated by the base priority level data, and either arguments indicating the states of the respective requesting devices, or arguments indicating the request types of the requests made by the respective requesting devices, and a process of obtaining the priority levels of the respective requesting devices derived by the handler.

6. The content processing device according to claim 5,
wherein said device contention resolving unit further includes
a handler registering unit configured to provide the application program with an interface through which the application program can register the handler in said priority level deriving unit, and
said priority level deriving unit obtains priority levels of the requests made by the respective requesting devices by making an inquiry to the handler registered by the application program.

7. The content processing device according to claim 1, further comprising
a recording unit configured to record the received content by using the resource device,
wherein said device contention resolving unit resolves the contention between the requesting devices for the use of the resource device, the contention occurring in the case where each of the requesting devices requests said reproducing unit to reproduce the content, requests said transfer unit to transfer the content, or requests said recording unit to record the content, and
wherein, depending on the request determined by said resolving processing unit,
said reproducing unit reproduces the content by using the resource device,
said transfer unit transfers the content by using the resource device, or
said recording unit records the content by using the resource device.

8. The content processing device according to claim 1, further comprising
a buffer processing unit configured to executes, as time shift processing, a process of recording, in a buffer, segments of a content by using the resource device, when the segments are received sequentially on a segment-by-segment basis, and a process of transferring each of the recorded segments to at least one of the requesting devices after a predetermined period elapses from a time point of recording of the segment,
wherein said device contention resolving unit resolves the contention between the requesting devices for the use of the resource device, the contention occurring in the case where each of the requesting devices requests said reproducing unit to reproduce the content, requests said transfer unit to transfer the content, or requests said buffer processing unit to execute time shift processing, and
wherein, depending on the request determined by said resolving processing unit,
said reproducing unit reproduces the content by using the resource device,
said transfer unit transfers the content by using the resource device, or
said buffer processing unit executes the time shift processing by using the resource device.

9. The content processing device according to claim 1,
wherein said priority level deriving unit derives, as the priority levels of the respective requesting devices, the priority levels of the requests made by the respective requesting devices,
said resolving processing unit determine one of the request devices to be a request for which the use of the resource device is allowed, according to a priority order of the request devices assigned with the priority levels derived in the deriving processing executed by said priority level deriving unit, and
wherein, depending on the request determined by said resolving processing unit,
said reproducing unit reproduces the content by using the resource device, or
said transfer unit transfers the content by using the resource device.

10. The content processing device according to claim 1,
wherein said reproducing unit and said transfer unit are included in a first terminal,
said device contention resolving unit is included in a second terminal, and
said first terminal and said second terminal are connected via a network.

11. The content processing device according to claim 1,
wherein said resource device is included in said content processing device or a terminal device connected to said content processing device via a network.

12. The content processing device according to claim 1,
wherein said respective requesting devices are included in said content processing device or are connected to said content processing device via a network.

13. The content processing device according to claim 1, further comprising
the resource device as a first device,
wherein said resolving processing unit requests a terminal lo device connected to said content processing device via a network to lend a second device included in the terminal device in order for a rejected request for which use of said first device has not been allowed from among the requests made by the respective requesting devices, and
wherein, according to the rejected request,
said reproducing unit reproduces the content by using the second device lent by said terminal device according to the firstly rejected request, or
said transfer unit transfers the content by using the second device lent by said terminal device according to the firstly rejected request.

14. The content processing device according to claim 13,
wherein said reproducing unit reproduces the content by using the second device configured as a tuner.

15. The content processing device according to claim 13,
wherein said recording unit records the content by using the second device configured as a tuner.

16. The content processing device according to claim 13, further comprising
a buffer processing unit configured to executes, as time shift processing, a process of recording, in a buffer, segments of a content by using the resource device, when the segments are received sequentially on a segment-by-segment basis, and a process of transferring each of the recorded segments to at least one of the requesting devices after a predetermined period elapses from a time point of recording of the segment,
wherein said device contention resolving unit resolves the contention between the requesting devices for the use of the resource device, the contention occurring in the case where each of the requesting devices requests said reproducing unit to reproduce the content, requests said transfer unit to transfer the content, or requests said buffer processing unit to execute time shift processing, and
said buffer processing unit executes the time shift processing by using the second device configured as the tuner according to the firstly rejected request.

17. The content processing device according to claim 1, further comprising
the resource device,
wherein said device contention resolving unit resolves a contention between the requesting devices for the use of the resource device, the contention occurring in the case where each of the requesting devices requests said reproducing unit to reproduce the content, requests said transfer unit to transfer the content, or makes a device rental request for the device, and
in the case where said resolving processing unit determines the device rental request to be a request for which use of said resource device has been allowed, the resource device executes a process based on an instruction from the requesting device which has made the device rental request.

18. The content processing device according to claim 1,
wherein said resource device is a tuner, a hard disk, a buffer, or a network band.

19. The content processing device according to claim 1,
wherein each of the request types of the requests indicates reservation recording, reproduction, content transfer, buffering, device rental, or buffer data transfer.

20. The content processing device according to claim 1,
wherein each of the states of the requesting devices indicates: a state where the transferred content is being reproduced; a state where the content received by said requesting device is being reproduced; or contract details for viewing the content, the contract details being set for said requesting device.

21. A content processing method for executing processing on a content in response to a request from one of requesting devices, said content processing device comprising:
reproducing a content;
transferring a content to at least one of the requesting devices; and
resolving a contention between the requesting devices for use of a resource device required for said reproducing of the content and said transferring of the content, the contention occurring in the case where each of the requesting devices requests for said reproducing of the content or for said transferring of the content,
wherein, when the contention between the requesting devices is resolved,
base priority level data indicating priority levels in the use of the resource device is used as base priority levels assigned to the respective requesting devices;
deriving processing of deriving priority levels of the requests made by the respective requesting devices is executed, based on: either states of the respective requesting devices or request types of the requests made by the respective requesting devices; and the base priority levels of the respective requesting devices indicated by the base priority level data; and
one of the requests is determined to be a request for which the use of the resource device is allowed, according to a priority order of the requests assigned with the priority levels derived in the deriving processing executed by said priority level deriving unit, and
wherein, depending on the request determined by said resolving processing unit,
the content is reproduced by using the resource device, or
the content is transferred by using the resource device.

22. A program causing a computer to execute processing on a content in response to a request from one of requesting devices,
wherein the processing includes:
reproducing a content;
transferring a content to at least one of the requesting devices; and
resolving a contention between the requesting devices for use of a resource device required for said reproducing of the content and said transferring of the content, the contention occurring in the case where each of the requesting devices requests for said reproducing of the content or for said transferring of the content,
wherein, when the contention between the requesting devices is resolved,
base priority level data indicating priority levels in the use of the resource device is used as base priority levels assigned to the respective requesting devices;
deriving processing of deriving priority levels of the requests made by the respective requesting devices is executed, based on: either states of the respective requesting devices or request types of the requests made by the respective requesting devices; and the base priority levels of the respective requesting devices indicated by the base priority level data; and
one of the requests is determined to be a request for which the use of the resource device is allowed, according to a priority order of the requests assigned with the priority levels derived in the deriving processing executed by said priority level deriving unit, and
wherein, depending on the request determined by said resolving processing unit,
the content is reproduced by using the resource device, or
the content is transferred by using the resource device.
